(19) United States
(12) Patent Application Publication
(10) Pub. No.: US 2026/0087477 A1
(43) Pub. Date: Mar. 26, 2026

(54) Artificially Intelligent System and Method for Automatic Generation and Transmission of Digital Receipts

(71) Applicant: KBI Investment & Management AG, Rotkreuz (CH)

(72) Inventor: Richard Kellerer, Forest Row (GB)

(21) Appl. No.: 19/316,483

(22) Filed: Sep. 2, 2025

Related U.S. Application Data
(60) Provisional application No. 63/697,986, filed on Sep. 23, 2024.

(51) Int. Cl. G06Q 20/20; G06N 3/0464; G06N 3/088; G06Q 20/40

(52) U.S. Cl. CPC G06Q 20/209; G06N 3/0464; G06N 3/088; G06Q 20/4016; G06Q 2220/00

(57) ABSTRACT

Systems and methods leverage a multi-stage artificial-intelligence pipeline to convert raw point-of-sale data into bank-grade digital receipts. A convolutional-OCR front end extracts line-item text, which a bidirectional-LSTM classifier normalises and categorises in real time, learning continuously from user feedback. A graph-based anomaly detector flags suspicious spend patterns, while a recommender sub-engine delivers personalised rewards and sustainability insights by fusing purchase context with external carbon-intensity data. The enriched receipt is cryptographically hashed, streamed through an encrypted gateway, and auto-matched to the corresponding payment entry inside the banking core. By driving extraction, classification, enrichment and integrity checks entirely through AI, the system eliminates manual mapping and enables immediate, tamper-evident reconciliation across heterogeneous merchants and payment rails.

### CROSS-REFERENCE TO RELATED APPLICATIONS

The present application claims the priority benefit of, U.S. Provisional Patent Application 63/697,986, filed on Sep. 23, 2024, titled “System and Method for Automatic Generation and Transmission of Digital Receipts to Banking Systems”, which is hereby incorporated by reference in its entirety, including all appendices.

### FIELD OF INVENTION

The present technology pertains, not by limitation, to systems and methods for generating, categorizing, and transmitting digital receipts from point-of-sale (POS) systems to customers'bank accounts, as well as for crypto-transactions, direct debit transactions and mobile payment platforms.

### SUMMARY OF EXEMPLARY EMBODIMENTS

Exemplary embodiments of the present disclosure include a method for transaction data security, the method being executable by at least one processor communicatively coupled to at least one memory, the at least one memory storing one or more instructions for executing the method by the at least one processor, the method comprising: receiving raw transaction data from a transaction terminal; extracting line-item text using optical character recognition and natural language processing to extract and structure the authenticated data into normalized data; executing anomaly detection and fraud analysis against the normalized data by an artificial intelligence detection engine. In general, the artificial intelligence detection engine comprises: an unsupervised learning component comprising one or more machine learning models trained on user transaction history, the unsupervised learning component employing a clustering algorithm to group a plurality of transactions with similar characteristics, and further employing isolation forests which isolate anomalous transactions by distinguishing the anomalous transactions from normal data distributions; and a supervised learning component comprising one or more machine learning models trained on historical fraud data and further trained on regulatory compliance data to identify fraud patterns, the supervised learning component employing at least one random forest algorithm to the normalized data. In this exemplary method, the executing of the anomaly detection and fraud analysis further comprises: generating and dynamically updating an adaptive threshold for high risk of fraud, the adaptive threshold being determined by the supervised learning component; calculating a risk score for any of the plurality of transactions by the unsupervised learning component; blocking any of the plurality of transactions upon determination that the risk score exceeds the adaptive threshold; and enabling a multi-factor authentication requirement upon determination that the risk score exceeds the adaptive threshold.

In some embodiments, the method further comprises: applying an initial security verification, including client credentials and Transport Layer Security 1.3 encryption to the raw transaction data to produce authenticated data; categorizing any of the plurality of transactions linked to the normalized data, the categorization using bidirectional long short-term memory networks and word embeddings; generating a digital receipt, the digital receipt including a receipt hash; transmitting the receipt hash for recordation on a blockchain ledger; and transmitting the digital receipt to a banking application of an account holder.

The training of the neural network generally comprises: collecting a set of reconciliation data from a database; applying one or more transformations to each reconciliation data including iteratively multiplying by a fixed number with each iteration to create a modified set of reconciliation data; creating a first training set comprising the collected set of reconciliation data, the modified set of reconciliation data, and a set of reconciliation data; first training a neural network in a first stage using the first training set; creating a second training set for a second stage of training comprising the first training set and reconciliation data that are incorrectly detected as reconciliation data after the first stage of training; and second training the neural network in a second stage using the second training set.

The set of reconciliation data may include transaction metadata such as transaction identifiers, timestamps, and point-of-sale (POS) system logs and/or financial details such as bank transaction records, payment authorization codes, and Transaction-Unique Metadata Identifier (TUMI) or Unique Identifier Number UIN information. The transaction-linking identifiers may include a Transaction-Unique Metadata Identifier (TUMI)—a combination of non-sensitive transaction metadata including the Bank Identification Number (BIN), last four digits of the card, expiry date, transaction amount, currency and timestamp. Or a pre-provisioned Unique Identifier Number (UIN) embedded by the issuer at card personalisation or token creation, said identifier being non-payment-enable and persistent across subsequent transactions.

The set of reconciliation data may also include including merchant-related data including merchant identification, location information, and POS system metadata; digital receipt images and associated OCR-extracted textual data; sales data and inventory records associated with each transaction; data including customer account information, loyalty program identifiers, and behavioral data.

Regarding the training on the datasets, the first set in some embodiments includes categorizing the set of reconciliation data; classifying the set of reconciliation data; and augmenting the reconciliation data with synthetic variations derived from statistical transformation functions, the transformation functions including iterative multiplication, scaling based on standard deviation, and controlled perturbations of numerical values. In some embodiments, the first training also includes reconciling the reconciliation data with corresponding accounting data; linking the reconciliation data with incoming sales data; linking the reconciliation data with bank transaction data; and linking the reconciliation data with anti-money laundering (AML) watchlist data.

In some embodiments, the overall method further comprises continuously monitoring performance metrics, the performance metrics including accuracy, precision, and false positive rates, during training, and dynamically adjusting transformation parameters and data augmentation methods until predetermined thresholds are met. Further embodiments also include automatically storing misclassified or borderline reconciliation data instances and incorporating flagged instances into subsequent training sets for iterative retraining, the flagged instances comprising at least one of the misclassified or borderline reconciliation data instances.

The one or more transformations described above may comprise at least one mathematical transformation function selected from the group consisting of iterative multiplication by a fixed number, scaling based on standard deviation, and statistical perturbation operations.

Further disclosed herein are various systems, topologies, and non-transitory computer-readable media for executing these methods.

### BRIEF DESCRIPTION OF THE DRAWINGS

In the description, for purposes of explanation and not limitation, specific details are set forth, such as particular embodiments, procedures, techniques, etc. to provide a thorough understanding of the present technology. However, it will be apparent to one skilled in the art that the present technology may be practiced in other embodiments that depart from these specific details.

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The systems and methods disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIGS. 1A-1B illustrate a comprehensive system architecture for automatic generation and transmission of digital receipts.

FIG. 2 illustrates the data flow architecture between payment capture systems and banking endpoints through the system's core processing components.

FIGS. 3A-3B illustrate the detailed data processing workflow within the Data Warehouse, showing the journey of transaction data from initial capture through final distribution.

FIGS. 4A-4B illustrate the detailed architecture of the Transaction Data Extraction Module, which interfaces with various POS systems to securely extract and process transaction data through multiple specialized layers.

FIGS. 5A-5B illustrate the architecture of the Digital Receipt Generation Module, which processes transaction data through multiple layers to generate secure and standardized digital receipts in various formats.

FIGS. 6A-6B illustrate the architecture of the Receipt Categorization Module, which employs sophisticated machine learning algorithms to automatically classify receipts into appropriate categories.

FIGS. 7A-7D illustrate the Bank Integration Module's architecture, which is designed to facilitate the secure and efficient matching of digital receipts with banking transactions.

FIGS. 8A-8C illustrate the architecture of the Bookkeeping Integration Module, which automates the categorization and reconciliation of financial transactions with third-party accounting software systems.

FIG. 9A-9C illustrate the detailed architecture of the Rewards Management Module, which employs an AI-driven system for generating and distributing personalized rewards based on customer transaction data, as described in Section 2.8 of the patent document.

FIG. 10A-10D illustrate the Fraud Detection and AML Compliance Module's architecture, designed to identify and mitigate fraudulent activities while ensuring adherence to regulatory standards.

FIGS. 11A-11B illustrate further exemplary embodiments of the technology disclosed herein.

FIG. 12A-12B illustrate further exemplary embodiments of the technology disclosed herein.

FIG. 13A-13B illustrate further exemplary embodiments of the technology disclosed herein.

### DETAILED DESCRIPTION

Exemplary embodiments relate to a system and method for generating, categorizing, and transmitting digital receipts from point-of-sale (POS) systems to customers'bank accounts, as well as for crypto-transactions, direct debit transactions and mobile payment platforms such as Apple Pay, Alipay, and WeChat Pay. Current systems rely heavily on email, QR codes, or app-based solutions for receipts.

However, no system currently automates the transmission of receipts directly to the customer's bank for easy access within their mobile banking app alongside transaction details. This streamlined integration offers significant convenience for both consumers and businesses, eliminating the need for physical receipts.

The exemplary embodiments also address the environmental impact of paper receipts. Globally, paper receipts lead to deforestation, consuming approximately 10 million trees annually, along with 1 billion gallons of water and 250 million gallons of oil. Paper receipts generate 1.5 billion pounds of waste each year, contributing to deforestation and carbon emissions. Most receipts are coated with chemicals such as Bisphenol-A (BPA) and Bisphenol-S (BPS), which are harmful to human health and the environment.

By eliminating paper receipts, these exemplary embodiments provide an eco-friendly alternative that reduces resource consumption, minimizes environmental damage, and lowers exposure to harmful chemicals. Additionally, the system integrates sustainability metrics that provide real-time carbon savings calculations and environmental impact feedback.

Existing solutions such as Receipt Bank (now Dext) and finAPI offer automated receipt management and integration with accounting software like QuickBooks and Xero. These platforms primarily focus on extracting data from physical or digital receipts and streamlining the process of categorization and reconciliation with bookkeeping systems. For instance, Receipt Bank enables businesses to scan and process receipts, which are then categorized based on expense type and linked to corresponding accounting entries for reconciliation. Similarly, finAPI emphasizes the integration of financial data from various sources into accounting platforms, facilitating transaction oversight and reporting.

Despite their utility, these systems exhibit key limitations that restrict their scope and applicability. Specifically, they lack the functionality to directly integrate receipt data with business bank accounts, thereby missing the critical step of automatically associating digital receipts with corresponding bank transactions in real-time. This limitation results in fragmented workflows, requiring users to manually reconcile bank records with receipt data in separate platforms, which increases operational inefficiencies and the likelihood of errors.

In contrast, the system described in these exemplary embodiments introduces significant advancements that address these gaps, offering a holistic solution to automated financial and receipt management.

Features of exemplary embodiments include:
Real-Time Integration with Bank Transactions: Unlike existing solutions, this system seamlessly integrates digital receipts with bank transactions as they occur. This ensures that receipts are automatically filed alongside corresponding incoming sales transactions without requiring manual intervention.
Automated Reconciliation with Bookkeeping Software: The system bridges the gap between banking data and accounting platforms by automatically reconciling categorized receipt data with bookkeeping software such as QuickBooks and Xero. This eliminates the need for manual reconciliation and significantly enhances workflow efficiency.
Comprehensive End-to-End Automation: Beyond receipt management, this system provides a full-scale solution encompassing receipt categorization, banking integration, and bookkeeping reconciliation. This end-to-end approach ensures a streamlined process from transaction initiation to financial record-keeping.
Advanced Features for Enhanced Functionality: Incorporating AI-powered categorization, blockchain-based audit trails, fraud detection mechanisms, and dynamic reward generation, this system extends beyond basic receipt management. These features provide additional layers of security, accuracy, and personalization, making it more robust and versatile than existing solutions.

The combination of these features results in a groundbreaking system that not only addresses the inefficiencies of existing solutions but also introduces innovative functionalities that redefine receipt and financial transaction management. By unifying receipt filing, banking integration, and accounting reconciliation into a cohesive framework, these exemplary embodiments fill a critical market gap, offering unparalleled efficiency, accuracy, and user convenience.

### Technical Problem

The exemplary embodiments address several critical technical challenges that impede the seamless management of digital receipts and financial data. These challenges are outlined as follows:
Lack of a Secure, Automated Receipt Transmission System: Existing solutions do not offer an automated, secure mechanism to transmit receipts directly to customers'banking systems. This results in the absence of a real-time linkage between digital receipts and corresponding transaction details within banking applications, creating a fragmented user experience.
Limited Automation Across Payment Methods: Current systems lack comprehensive automation for generating and transmitting digital receipts across diverse payment ecosystems, including modern platforms like Apple Pay, Alipay, WeChat Pay, and traditional methods such as direct debit. This results in inconsistent receipt management across payment modes.
Absence of a Unified Transmission Framework: There is no unified system capable of transmitting digital receipts directly to banking systems, regardless of whether payments are made through POS terminals, mobile wallets, or direct debits. The disparate handling of payment methods hinders the efficiency and universality of receipt transmission.
POS System Integration Challenges: The heterogeneity of POS systems, which often utilize varying communication protocols and data formats, creates significant challenges in standardizing receipt generation and transmission. This lack of uniformity complicates integration efforts, reducing the overall system efficiency.
Burden of Manual Receipt Categorization: Manual categorization of receipts requires businesses to invest significant effort in organizing and managing financial data. This introduces inefficiencies, increases the potential for errors, and slows down financial processes such as reconciliation and tax compliance.
Environmental Impact of Paper Receipts: The widespread reliance on paper receipts contributes to environmental degradation through resource-intensive production and disposal processes. A sustainable alternative to paper receipts is urgently needed to reduce environmental footprints.
Real-Time Bank Integration for Receipts: Businesses often struggle to file receipts with their bank accounts in real-time for reconciliation purposes. The lack of seamless integration between receipt management systems and banking platforms hampers real-time financial tracking and alignment.
Categorization for Enhanced Financial Management: Both customers and businesses face difficulties in categorizing receipts for reconciliation, tax compliance, and financial reporting purposes. A solution is needed to streamline these tasks and improve the accuracy of financial data.
Security and Fraud Detection Needs: Current systems fail to provide robust mechanisms to ensure the security of receipts and transactions. Fraud detection capabilities are often limited, exposing financial data to risks such as tampering and unauthorized access.
Global Interoperability and Multi-Currency Compatibility: The lack of interoperability with global banking standards and support for multi-currency transactions restricts the usability of existing systems, especially for businesses operating in international markets.

By addressing these challenges, these exemplary embodiments provide a comprehensive, secure, and efficient system for the generation, categorization, transmission, and management of digital receipts, bridging the gap between diverse payment methods, POS systems, banking platforms, and bookkeeping software while ensuring security, environmental sustainability, and global compatibility.

### Technical Solution

These exemplary embodiments introduce a comprehensive system and method for generating digital receipts at the point of sale (POS), extracting transaction data from POS systems, and securely transmitting the digital receipt to the customer's bank. To minimise Payment Card Industry Data Security Standard (PCI-DSS) scope while preserving one-to-one transaction matching, the system uses either a Unique Identifier Number (UIN) that is provisioned by the issuer at card-personalisation (or when a network token is created for a mobile wallet), or a Transaction-Unique Metadata Identifier (TUMI)-a combination of non-sensitive transaction metadata including the Bank Identification Number (BIN), last four digits of the card, expiry date, transaction amount, currency and timestamp. The UIN or TUMI enables the issuing bank to match each digital receipt to its corresponding transaction without requiring access to the full Primary Account Number (PAN) or other sensitive identifiers. Both BIN and UIN are printed only in token form on the card chip/mobile-wallet token data; neither can be reverse-mapped to the Primary Account Number (PAN) outside the issuer environment. They carry no payment capability, thereby reducing compliance overhead and fraud risk. Once transmitted, the receipt is made accessible within the customer's mobile banking app, where it is directly linked to the corresponding financial transaction, creating a seamless and integrated experience.

The system employs a robust framework designed to address the complexities of digital receipt generation, categorization, and transmission. To ensure secure and authenticated access to transaction data, the system utilizes OAuth 2.0 Authentication, which verifies and authorizes interactions between the POS systems, banks, and the receipt management module. The exemplary embodiments also include a universal API that standardizes data extraction across a variety of POS platforms, including traditional POS terminals and modern mobile wallet systems such as Apple Pay and Alipay, ensuring compliance with global banking standards.

For direct debit transactions, the system extends its capabilities by generating and categorizing digital receipts for payment methods like Automated Clearing House (ACH) in the U.S. and Single Euro Payments Area (SEPA) in Europe. A machine learning-based automated receipt categorization algorithm enhances the accuracy and efficiency of the system by classifying receipts into predefined categories such as “Groceries,” “Dining,” and “Travel.”The algorithm improves over time through iterative training on transaction data.

Data security is a cornerstone of the exemplary embodiments. It employs advanced protocols such as AES 256-bit encryption for data storage, multi-factor authentication for access control, and compliance with GDPR and PCI-DSS regulations to safeguard sensitive transaction data. The transmission of digital receipts to customers'banks is conducted through encrypted channels, using secure protocols like Transport Layer Security (TLS) and Hypertext Transfer Protocol Secure (HTTPS), ensuring the privacy and integrity of the data during transmission.

For businesses, the system automates the filing of receipts by linking them to the business's bank account, enabling real-time reconciliation with incoming sales transactions. At the banking level, the system categorizes receipts to streamline reconciliation processes, facilitate tax compliance, and enhance financial reporting accuracy. Moreover, integration with third-party bookkeeping software allows businesses to automatically import categorized receipts and reconcile them with their accounting records, reducing manual effort and errors.

The system further enhances operational transparency and security by incorporating blockchain technology, creating an immutable audit trail of receipts and transactions. This audit trail ensures data integrity and provides verifiable proof of receipt authenticity. Fraud detection algorithms and anti-money laundering (AML) compliance checks are embedded into the framework to analyze and flag suspicious activities in real-time, strengthening trust and compliance.

An additional feature of the exemplary embodiments is its dynamic rewards and offers module, which leverages user purchase history and behavior to provide personalized discounts and rewards. This functionality enables businesses to enhance customer engagement by delivering targeted incentives. Furthermore, the system supports offline mode operations, wherein receipts and transaction data are stored locally and encrypted. Once internet connectivity is restored, the data is automatically synced with the central system, ensuring uninterrupted operation.

By integrating these technical capabilities, the exemplary embodiments offer a unified, automated solution for receipt management, seamlessly bridging the gap between POS systems, banking platforms, and bookkeeping software. It sets a new standard in efficiency, security, and user experience, making it a transformative tool for both customers and businesses.

### Rewards and Discounts Features

These exemplary embodiments incorporate an innovative rewards and discounts feature designed to enhance customer engagement and drive recurring business. By embedding rewards or discounts directly into the digital receipt, businesses can deliver personalized offers such as loyalty points, discounts, or targeted promotions. These customized incentives are automatically generated and seamlessly attached to the digital receipt during its creation, ensuring that the rewards are forwarded to the customer's bank along with the receipt for immediate access and integration.

The rewards management module acts as the central hub for organizing and presenting these offers. Within the customer's mobile banking app, a dedicated rewards page is created, enabling customers to view, track, and redeem all available offers conveniently. This module provides advanced filtering options, allowing rewards to be sorted by categories such as business name, reward type, expiration date, or promotional campaign. This streamlined organization ensures ease of use and maximizes the likelihood of reward redemption, fostering continued engagement.

This feature allows businesses to encourage repeat purchases through targeted incentives tailored to the customer's purchase history and preferences. For instance, a customer who frequently shops for groceries may receive enhanced discounts or loyalty points for similar future purchases. Additionally, the system enables businesses to monitor customer interactions with rewards, allowing them to measure the effectiveness of promotional campaigns by analyzing redemption rates and customer engagement. This data provides actionable insights into campaign performance, helping businesses refine their strategies.

Furthermore, the system supports cross-promotion by enabling businesses to collaborate with partners and offer related rewards. For example, a coffee shop could include a discount for a partnered bakery, encouraging customers to explore complementary products or services. The rewards management module also leverages AI-driven dynamic personalization, allowing businesses to adjust offers in real-time based on customer behavior. This ensures that rewards remain relevant and appealing to customers, improving their overall experience and fostering brand loyalty.

By integrating these capabilities, the rewards and discounts feature transforms traditional receipt management into a comprehensive tool for customer engagement and business growth. It not only enhances customer satisfaction through personalized incentives but also empowers businesses with the tools and data necessary to refine marketing strategies, strengthen customer relationships, and drive repeat transactions.

An exemplary embodiment includes a computer-implemented method of training a neural network and a large language model for reconciliation, the computer-implemented method comprising: collecting a set of reconciliation data from a database; applying one or more transformations to each reconciliation data including iteratively multiplying by a fixed number with each iteration to create a modified set of reconciliation data; creating a first training set comprising the collected set of reconciliation data, the modified set of reconciliation data, and a set of reconciliation data; first training the neural network in a first stage using the first training set; creating a second training set for a second stage of training comprising the first training set and reconciliation data that are incorrectly detected as reconciliation data after the first stage of training; and second training the neural network in a second stage using the second training set.

In some embodiments, this computer-implemented method further comprises the set of reconciliation data including transaction metadata such as transaction identifiers, timestamps, and point-of-sale (POS) system logs. This computer-implemented method may further comprise the set of reconciliation data including financial details such as bank transaction records, payment authorization codes, and TUMI/UIN information.

The transaction-linking identifier may comprise a Transaction-Unique Metadata Identifier (TUMI) supplied by the issuer network, or a pre-provisioned Unique Identifier Number (UIN) embedded by the issuer at card personalisation or token creation, said identifier being non-payment-enable and persistent across subsequent transactions.

Further embodiments include a computer-implemented method comprising: receiving, from a payment terminal, a tokenised identifier (TUMI/UIN) that is cryptographically unlinkable to a primary account number; associating the identifier with corresponding point-of-sale receipt data; and transmitting the linked receipt to a financial-institution endpoint without storing or transmitting the primary account number.

In some embodiments, the computer-implemented method further comprises the set of reconciliation data including merchant-related data including merchant identification, location information, and POS system metadata.

The computer-implemented methods may further comprise the set of reconciliation data including digital receipt images and associated OCR-extracted textual data, sales data and inventory records associated with each transaction, customer account information, loyalty program identifiers, and/or behavioral data.

The first training, in some embodiments, includes categorizing the set of reconciliation data; classifying the set of reconciliation data; augmenting the reconciliation data with synthetic variations derived from statistical transformation functions, wherein the transformations include iterative multiplication, scaling based on standard deviation, and controlled perturbations of numerical values; reconciling the reconciliation data with corresponding accounting data; linking the reconciliation data with incoming sales data; linking the reconciliation data with bank transaction data; and/or linking the reconciliation data with anti-money laundering (AML) watchlist data.

In some embodiments, the computer-implemented method further comprises continuously monitoring performance metrics—including accuracy, precision, and false positive rates—during training and dynamically adjusting transformation parameters and data augmentation methods until predetermined thresholds are met. The computer-implemented method may also further comprises automatically storing misclassified or borderline reconciliation data instances and incorporating these flagged instances into subsequent training sets for iterative retraining.

In some embodiments, the one or more transformations comprise at least one mathematical transformation function selected from the group consisting of iterative multiplication by a fixed number, scaling based on standard deviation, and statistical perturbation operations.

Further embodiments disclosed herein include a system for automatically generating digital receipts at the point of sale, the system comprising; a transaction data extraction module for retrieving transaction details from a point-of-sale terminal; a receipt generation module for formatting these details into a digital receipt; a categorization module for automatically classifying the digital receipt based on transaction details; and a transmission module for securely transmitting the categorized receipt to a customer's bank where the receipt is linked to the corresponding transaction within the customer's mobile banking app and online banking. Such systems may further include an integration module, which forwards the categorized digital receipt to third-party bookkeeping software to enable automatic reconciliation with accounting records.

Further embodiments include a method for generating and transmitting categorized digital receipts is provided which involves; receiving transaction details from a point-of-sale terminal, formatting these details into a digital receipt, categorizing the receipt automatically based on the transaction data, and securely transmitting the categorized receipt to the customer's bank where the receipt is then displayed within the customer's mobile banking app, linked to the corresponding transaction. Such methods may further include forwarding the categorized digital receipt to bookkeeping software, facilitating reconciliation with accounting records.

A system is introduced for automatically filing digital receipts for businesses, the system comprising; a transaction linking module that associates receipts with incoming sales transactions in the business's bank account, a receipt forwarding module that securely transmits receipt data to the business's bank for linkage to the corresponding sales transaction, and a categorization module that classifies receipts for business accounts based on transaction data, simplifying tax compliance, financial reporting, and reconciliation. The system may further comprise a bookkeeping integration module, which automatically forwards categorized receipts to third-party accounting software for streamlined reconciliation and financial reporting.

A method is described for managing and filing digital receipts for businesses which includes receiving transaction data from a POS system, filing the corresponding digital receipt with the business's bank for real-time reconciliation, categorizing the receipt for tax compliance and financial reporting, and forwarding the categorized receipt to the business's bookkeeping software for automatic reconciliation with accounting records.

A method is detailed for generating and transmitting categorized digital receipts for mobile wallet payments made via platforms such as Apple Pay, Google Pay, Alipay, or WeChat Pay, which involves extracting transaction data from the mobile wallet platform, formatting the data into a digital receipt, automatically categorizing the receipt, and securely transmitting it to the customer's bank.

A system is presented for generating and transmitting categorized digital receipts for direct debit transactions, including ACH in the U.S. and SEPA in Europe, this system receives transaction data from a direct debit network, formats the data into a digital receipt, and categorizes the receipt for reconciliation with bank accounts.

A method is specified for managing digital receipts for direct debit payments and mobile wallets, it entails automatically generating a digital receipt for the payment, categorizing the receipt based on the transaction type, and securely transmitting the receipt to both the customer's and business's bank for reconciliation.

A system is proposed for adding rewards or discounts to digital receipts comprising; a rewards generation module that embeds targeted offers, discounts, or loyalty points into the digital receipt, a rewards management module that centralizes these rewards in a dedicated rewards page within the customer's mobile banking app, and a redemption tracking system that monitors reward usage and expiration, providing businesses with data on customer engagement. The system allows businesses to customize the rewards or discounts based on customer behaviour or transaction history.

A method is described for delivering and managing rewards via digital receipts which involves automatically generating a reward offer based on a customer transaction, storing and displaying the offer in the customer's mobile banking app, and enabling the customer to redeem the offer directly through the receipt or app.

A system is outlined for creating a tamper-proof audit trail for digital receipts using blockchain technology comprising a blockchain module for recording each receipt on a decentralized ledger and a verification module for ensuring the authenticity and integrity of each receipt.

A system is provided for detecting fraud and ensuring AML compliance in digital receipt transactions, this system employs a fraud detection algorithm to analyze receipt and transaction data for suspicious patterns and an AML compliance module that cross-references transaction data against global regulatory standards.

A method is introduced for operating the digital receipt system in offline mode which involves processing transactions and generating receipts while the system operates offline, and automatically syncing transaction data and receipts once connectivity is restored.

A system is provided for generating and transmitting digital receipts for cryptocurrency transactions, comprising; a blockchain interface module configured to connect with one or more blockchain networks and detect or retrieve details of a cryptocurrency payment transaction including at least a payer wallet address, a recipient wallet address, and a transaction identifier (hash) on a given blockchain; a receipt generation module configured to format the retrieved transaction details into a digital receipt, the receipt comprising an itemized list of purchased items with associated costs and taxes, as well as cryptocurrency-specific information including the payer wallet address, the recipient wallet address, the transaction hash, an identification of the blockchain network used, a network transaction fee incurred for the payment, and an exchange rate between the cryptocurrency used and a reference fiat currency at the time of the transaction; and a delivery module configured to transmit the digital receipt to the customer, wherein the delivery module is operative in at least two modes: (i) an off-chain mode that associates or stores the digital receipt in a manner accessible to the customer's cryptocurrency wallet application without writing the receipt to a blockchain, and (ii) an on-chain mode that issues the digital receipt as a token on the blockchain by creating a transferable cryptographic token representing the receipt and assigning ownership of that token to the customer's wallet address.

In some systems, the off-chain mode of the delivery module the digital receipt is stored in a secure repository indexed by the customer's wallet address and is made available to be fetched or viewed through a wallet application or service associated with that wallet address, such that the receipt is delivered to the customer privately without publishing the receipt data on the blockchain network. The on-chain mode the delivery module generally utilizes a smart contract to mint a non-fungible token that embodies the digital receipt, compliant with a token standard supporting unique digital assets selected from the group consisting of ERC-721 and ERC-1155 or an equivalent and transmits said token to the customer's blockchain wallet address so that the digital receipt is recorded on the blockchain and owned by the customer.

In some embodiments, the digital receipt generated for the cryptocurrency transaction includes, as the cryptocurrency-specific information, a record of the blockchain transaction fee paid (including miner fees or gas fees) and a timestamped exchange rate or conversion value of the cryptocurrency to a fiat currency, thereby enabling the receipt to reflect the fiat value of the transaction and fees at the time of purchase for accounting or auditing purposes.

The blockchain interface module may be configured to support a plurality of distinct blockchain protocols and networks, including at least Bitcoin and Ethereum networks, such that the system remains blockchain-agnostic and capable of generating digital receipts for transactions occurring on different blockchain platforms without requiring modifications to the receipt generation module or delivery module for each blockchain.

In some embodiments, the system does not handle the transfer of cryptocurrency funds and operates alongside external payment processing mechanisms, the blockchain interface module only monitoring or querying the blockchain for transaction data, thus isolating receipt generation from actual payment custody while maintaining compatibility with any cryptocurrency payment source.

A method is described for automatically generating and transmitting a digital receipt for a cryptocurrency payment transaction, which involves; retrieving transaction data from a blockchain network for a cryptocurrency payment, including at least the payer's wallet address, the recipient's wallet address, a transaction hash identifying the payment, and network-specific details of the transaction; generating a digital receipt that itemizes the purchased products or services with their prices and taxes, and that incorporates the retrieved blockchain transaction data along with cryptocurrency-related fees and an exchange rate at the time of the transaction; and transmitting the digital receipt to the customer by either (a) associating the receipt with the customer's blockchain address in an off-chain repository accessible through a cryptocurrency wallet application, or (b) issuing the receipt onto the blockchain as a token associated with the customer's wallet address, wherein option (b) comprises creating a non-fungible token on the blockchain carrying the receipt information and transferring ownership of said token to the customer.

According to some such methods, the digital receipt is transmitted via option (a) further comprises storing the receipt in a secure off-chain database indexed by the customer's wallet address and providing a notification or interface for the customer's cryptocurrency wallet to retrieve and display the receipt, thereby delivering the receipt without any on-chain transaction. In some embodiments, transmitting the digital receipt via option (b) further comprises invoking a smart contract to mint a unique token representing the receipt on the blockchain and sending that token to the customer's wallet address as recorded on the blockchain, such that the receipt is immutably recorded and verifiable on-chain and accessible to the customer through their wallet.

Some systems further comprise a Warranty Detection and Integration Module configured to automatically identify and integrate warranty information for each purchased item in the digital receipt at the point of sale, wherein the module (i) detects any warranty data provided by the merchant or a third party for an item during receipt generation and (ii) if no such data is detected, automatically determines and assigns applicable warranty terms for the item based on the item's classification and the jurisdiction of the transaction. In some such systems, the Warranty Detection and Integration Module uses an artificial intelligence algorithm to scan the transaction data in real time for indications of warranty information, including parsing item descriptions, transaction metadata, or attached documents for warranty terms or durations offered by the merchant or manufacturer at the time of purchase.

When no explicit warranty information is found for a particular item, the module may employ a classification engine to categorize the item using product identifiers selected from the group consisting of HS (Harmonized System) codes, SKU numbers, and item category or description data, determines a country or jurisdiction of origin for the transaction, and automatically assigns one or more legal warranty terms to the item by querying a proprietary database of consumer protection laws to retrieve the mandatory warranty period and refund/return policy applicable to the determined category and jurisdiction.

The digital receipt generated by the system generally includes, for each purchased item, an embedded warranty record comprising the warranty duration and expiration date, and a status indicator that is dynamically updated to reflect the current status of the warranty as active or expired in real time whenever the digital receipt is accessed by a user.

The status indicator, in some embodiments, comprises a first visual icon or marker displayed (in a first color or style) when the item's warranty is still active and a second visual icon or marker displayed (in a different color or style) when the warranty for the item has expired, and wherein the system further triggers an expiry notification to be sent to the customer a predetermined time period before the expiration of an active warranty as a reminder of the pending expiration.

The warranty information associated with each item is generally stored as a part of the digital receipt data in a secure and immutable manner, such that the warranty data cannot be altered or tampered with by the customer, and wherein the digital receipt with the embedded warranty data is made accessible through both traditional banking application interfaces and cryptocurrency wallet interfaces as a unified record.

The Warranty Detection and Integration Module may permit a merchant to provide an extended warranty term that exceeds the default legal warranty duration for a given item, in which case the extended term is incorporated into the digital receipt for that item, while ensuring that the system prevents any removal or reduction of the minimum legally required warranty terms, thereby guaranteeing that the final recorded warranty for the item is at least equal to the statutory warranty entitlement of the customer.

A method is disclosed for automatically integrating warranty information into a digital receipt at the point of sale, the method comprising: extracting item-level transaction data from a point-of-sale system for a purchase; scanning the extracted data using an AI-driven module to detect any merchant-provided or third-party warranty information associated with each purchased item; for each item for which no explicit warranty data is detected, classifying the item by analyzing product identifiers including HS codes, SKU numbers, or item description to determine a product category, identifying a jurisdiction of the transaction, and retrieving from a database of legal regulations a set of warranty terms and consumer return/refund policies required by law for that product category in the identified jurisdiction; attaching the detected or retrieved warranty information to the digital receipt data for the corresponding item, including setting a warranty expiration date; storing the digital receipt with embedded warranty information in a tamper-resistant data store such that it is linked to the corresponding transaction and cannot be altered without detection; and providing the digital receipt for display to the customer via a banking app or crypto wallet interface, wherein each item's entry on the receipt presents the warranty terms and a dynamically updating indicator showing whether the warranty is active or expired based on the current date.

In some embodiments, this method further comprises: sending an electronic notification to the customer a predefined period (prior to the warranty expiration date of an item on the digital receipt) to remind the customer of the upcoming expiration of that item's warranty coverage. In some embodiments, if the merchant or manufacturer offers an extended warranty for an item beyond the default legal warranty period, the method includes incorporating the extended warranty details into the item's receipt entry such that the longer warranty period is recorded and tracked, and wherein the method automatically enforces inclusion of any minimum legally required warranty for the item if no extended warranty is provided, thereby preventing omission of baseline consumer warranty protections in the finalized digital receipt.

These exemplary embodiments introduce a technical system designed to generate and transmit digital receipts at the point of sale, seamlessly linking them to the corresponding transactions in the customer's mobile banking app. The system utilizes a universal API to extract transaction data from the POS system, categorizing the receipt with the assistance of adaptive machine learning models. The categorized receipt is then securely transmitted to the customer's bank, ensuring accurate integration with their banking records.

For businesses, the system offers a range of enhanced functionalities that streamline financial management and improve customer engagement. It provides an automated mechanism for filing receipts directly with the business's bank account, enabling real-time reconciliation of incoming sales transactions. Additionally, the system categorizes receipts for business accounts, simplifying processes such as tax reporting, cash flow management, and financial reconciliation. Integration with third-party bookkeeping software further facilitates automatic reconciliation, tax filing, and financial reporting, enhancing operational efficiency.

The exemplary embodiments also incorporate an advanced rewards and discounts feature that embeds customer-specific incentives directly into digital receipts. This functionality promotes customer engagement and drives recurring business by delivering personalized offers and loyalty rewards. To ensure the integrity and security of the system, blockchain technology is employed to create tamper-proof audit trails of receipts and transactions. Furthermore, fraud detection algorithms and AML compliance checks provide real-time risk analysis, safeguarding against suspicious activities.

The system supports sustainability efforts by offering metrics to track carbon savings associated with the reduction of paper receipts. Businesses can leverage these metrics to gain insights into their environmental impact, promoting eco-friendly practices. By combining secure receipt generation and transmission with innovative functionalities for businesses and customers, these exemplary embodiments represent a comprehensive solution that addresses technical challenges while enhancing efficiency, security, and customer experience.

In further exemplary embodiments of the present disclosure provide a system and method for the automatic generation and secure transmission of digital receipts associated with point-of-sale transactions. The system is designed to seamlessly integrate with diverse point-of-sale (POS) systems in real time through a universal API interface, enabling the capture of transaction details immediately as purchases occur. Once a transaction is initiated at a POS, the system automatically generates a corresponding digital receipt and ensures its secure transmission to designated recipients (such as a user's mobile device, email, cloud account, or financial institution) over an encrypted channel. In various embodiments, the system's architecture is modular, allowing the core functionality to be implemented in software, firmware, or a combination of hardware and software, and to be deployed in retail environments, mobile applications, or cloud-based platforms as needed.

In one exemplary embodiment, the system includes multiple integrated components working in tandem to produce and manage digital receipts. A POS integration module (e.g., the universal API) is configured to interface with a wide range of cash registers, card payment terminals, and retail management systems, normalizing incoming transaction data from disparate sources into a standardized digital receipt format. The universal API abstracts the differences among various POS vendors and protocols, ensuring that regardless of the retail system in use, itemized sale information (including product identifiers, quantities, prices, timestamps, merchant details, and payment information) is captured accurately and forwarded to the receipt generation engine. The receipt generation engine then compiles this information into a structured digital receipt data object, which can be formatted in a user-friendly manner (for example, as a PDF, JSON, or secure digital ticket) and prepared for transmission. Throughout this process, secure communication protocols are employed at multiple layers. For instance, data exchanged between the POS systems and the receipt management server is encrypted using Transport Layer Security (TLS) 1.3, ensuring in-transit confidentiality and integrity of transaction details. Additionally, the system utilizes robust authentication and authorization mechanisms such as OAuth 2.0 to control access to the API endpoints, so that only authorized POS devices and users can submit or retrieve receipt data. Sensitive information within the receipt (such as payment card details or personal identifiers) may be further protected using encryption standards like AES-256, both during transmission and at rest in storage, thereby maintaining a high level of data security and privacy compliance.

A machine learning-driven data extraction and categorization engine is incorporated to intelligently process the content of each receipt and enhance its utility. In certain embodiments, this engine employs advanced artificial intelligence techniques to interpret and classify receipt data. For example, if the digital receipt originates from a scanned paper receipt or an image, the system can leverage a convolutional neural network (CNN) component for optical character recognition (OCR) and layout analysis, converting printed text and figures into structured digital text. Subsequently, the extracted textual data is analyzed using natural language processing (NLP) models to identify and semantically classify different parts of the receipt (such as merchant name, line-item descriptions, taxes, total amounts, etc.). In one implementation, a long short-term memory (LSTM) neural network or similar sequence modeling technique is utilized to parse line-item descriptions and categorize purchased items into predefined expense categories or product types (for instance, flagging an item as “Groceries-Food” versus “Electronics-Mobile Device” based on its description). This AI-driven classification happens automatically and in real time, allowing the system to tag each transaction with relevant categories, merchant identifiers, and contextual metadata without manual intervention. The categorized data can then be used for downstream purposes such as personal finance management, expense reporting, budgeting, or targeted offers. By employing machine learning for data extraction and categorization, the system significantly improves accuracy and efficiency over manual or rule-based methods, adapting to a variety of receipt formats and continuously learning from new data to enhance recognition of novel merchant names or item descriptions.

To ensure integrity and auditability of the digital receipts, the system maintains a blockchain-based audit trail for each receipt transaction. In one embodiment, as each digital receipt is generated, a cryptographic hash of the receipt data (or the receipt data itself in an encrypted form) is recorded as a transaction on a distributed ledger or blockchain network. This blockchain ledger module links each new receipt record to prior records (using cryptographic hashes in typical blockchain fashion), thereby creating an immutable sequence or chain of receipt audit entries. The blockchain audit trail guarantees that once a receipt is recorded, it cannot be altered or tampered with without detection, providing a high level of trust and transparency. This is particularly valuable for environments requiring verified proof of purchase or regulatory compliance, as any attempt to modify or fabricate receipt data would be evident from the ledger. The blockchain component may be implemented on a private permissioned blockchain managed by the service provider for efficiency and confidentiality, or utilize a public blockchain for added transparency, depending on deployment needs. By leveraging blockchain technology in this manner, the present system offers tamper-evident verification of digital receipts, distinguishing it from conventional digital receipt systems that rely solely on centralized databases which could be vulnerable to undetected modifications.

The system further comprises fraud detection and anti-money-laundering (AML) modules that monitor receipt and transaction data for signs of irregular or illicit activity. These modules use a combination of rules-based algorithms and machine learning models to analyze patterns within the stream of generated receipts and associated payment data. For example, the fraud detection module may cross-reference receipt details against known fraud patterns (such as multiple high value returns or purchases of unusual combinations of goods that often indicate fraud) and apply anomaly detection techniques to flag transactions that deviate significantly from a user's normal purchasing behavior or a merchant's typical sales profile. The AML module similarly scans transaction and receipt information to detect red flags in the context of regulatory watchlists and money laundering typologies—for instance, it might flag a series of transactions just below reporting thresholds, or receipts involving goods frequently used in trade-based money laundering schemes. If suspicious activity is identified, the system can automatically generate alerts or reports, and in some embodiments, temporarily halt the secure transmission of certain receipts pending additional verification. By integrating these fraud and compliance safeguards directly into the digital receipt pipeline, the system not only generates receipts but also adds a layer of security and regulatory compliance, helping institutions and users proactively prevent fraud and ensure AML compliance as part of the receipt generation process. This integrated approach goes beyond prior art solutions that might handle receipts and fraud checks separately, thereby saving time and reducing risk through automation.

Some embodiments use real-time integration with banking systems and seamless reconciliation of POS data with bank account records. The system's integration modules are configured to communicate with financial institutions (for example, via open banking APIs or secure bank data feeds) so that when a purchase is made on a user's payment card or bank account, the system can instantly associate the bank's transaction record with the detailed digital receipt from the merchant's POS. In practice, as soon as a transaction is approved at the POS, the system receives the itemized receipt data (via the POS API integration discussed above) and nearly simultaneously receives a notification or query result from the user's bank indicating that a charge has been posted for a certain amount at that merchant. Using matching logic, the system correlates these two pieces of information—verifying that the total amount on the receipt matches the amount charged by the bank and that other key details (timestamp, merchant identifier) align—and then links or reconciles the records. This POS-bank-account-receipt reconciliation is achieved automatically and in real time, yielding a unified record that combines the financial transaction confirmation with the full purchase details. As a result, a user viewing their bank statement (through an online banking app or a personal finance tool linked to the system) can see each transaction accompanied by its corresponding digital receipt, including line-item details and any applicable warranties or loyalty information, without any manual effort. This real-time reconciliation feature vastly improves record-keeping and accuracy over prior systems which might require users to manually upload receipts or wait for end-of-day batch processing to match receipts with transactions. Additionally, the system's bank integration enables enriched financial services: for instance, the system can post structured receipt data directly into the user's bookkeeping or accounting software (e.g., categorizing and exporting receipts into accounting systems like QuickBooks, Xero, or enterprise ERP systems). Business users benefit from having each expense automatically logged with its supporting documentation, while personal users can have their purchases automatically categorized in budgeting software. The integration with banking and accounting platforms illustrates the broad interoperability of the system, as it bridges the gap between payment transactions and accounting records in a seamless, automated manner.

Moreover, certain embodiments of the system provide dynamic reward calculation and sustainability metrics modules that leverage receipt data to deliver additional value-added services. For example, a rewards module can analyze the items and amounts on a digital receipt in real time and compute loyalty points, cashback, or other incentives the customer may earn from that transaction, based on pre-configured reward rules from the merchant or the customer's bank. These rewards can be dynamically adjusted and issued the system might update the customer's loyalty account instantly or include a reward coupon with the digital receipt-thus enhancing customer engagement at the point of sale without requiring separate steps. Similarly, a sustainability module may use the receipt information to generate environmental impact metrics. In one scenario, the system tracks whether a receipt was delivered digitally (thereby saving paper) and tallies such paper savings for the user or merchant over time, possibly translating it into an environmental score or a carbon footprint reduction metric. In another scenario, the module could analyze the types of products purchased (using the categorized data from the ML engine) to inform the user about sustainable choices—for instance, highlighting if a product is locally sourced or made of recyclable materials, if such data is available. The system can then present sustainability feedback or tips via the digital receipt interface or report aggregate sustainability metrics to merchants who wish to assess and promote eco-friendly consumer behavior. These dynamic reward and sustainability features are integrated into the receipt delivery process, meaning the digital receipt becomes not just a static record of purchase, but an interactive tool for customer engagement and social responsibility. This aspect of the embodiments provides a competitive differentiator over earlier digital receipt systems by transforming receipts into a platform for immediate rewards and actionable insights into purchasing impact.

The various components described-including the POS integration API, secure transmission layer, machine learning extraction engine, blockchain audit ledger, fraud/AML analyzer, banking/bookkeeping synchronizer, and rewards/sustainability modules—operate together under a unified system architecture. They can be implemented as discrete services or combined processes within a cloud-based server environment, accessible through client applications on user devices. In summary, the present disclosure encompasses a comprehensive digital receipt management solution that can be embodied in (i) a networked system of one or more servers and client devices configured to perform the functions described, (ii) a computer-implemented method executed by these systems to carry out automatic receipt generation, secure transmission, and reconciliation, and (iii) a non-transitory computer-readable medium storing program instructions that, when executed by one or more processors, cause the system to perform the steps of the method. The described embodiments are intended to support a broad range of claim scope, covering not only the core system and process for generating and transmitting digital receipts, but also various enhancements and sub-components as dependent features. For instance, alternative embodiments may include additional security layers, different machine learning models or data structures, or various network configurations, all within the spirit of enabling secure, real-time, and intelligent digital receipt handling.

Notably, by integrating real-time bank data synchronization, seamless POS-to-bank reconciliation, and AI-driven receipt content classification into a single platform, the present system achieves results that distinguish it from and improve upon conventional digital receipt solutions. Prior approaches have typically been limited to delivering electronic receipts via email or proprietary apps without robust integration into banking records or automated analysis of receipt contents. In contrast, the exemplary embodiments described herein provide an end-to-end solution: from the moment of purchase, a digital receipt is automatically generated, categorized, securely transmitted, and matched to the purchaser's financial account records, all while ensuring verifiable integrity (through blockchain logging) and proactive security (through fraud and AML monitoring). This comprehensive approach yields broad yet defensible coverage for the subsequent claim set, ensuring that the invention's novel features—including the universal POS API integration, machine learning extraction and categorization system, blockchain audit trail, advanced security protocols (TLS 1.3, OAuth 2.0, AES-256), fraud/AML modules, bank and accounting integrations, and dynamic rewards/sustainability analytics—are fully supported and can be claimed in various combinations as warranted. Accordingly, the Summary of Exemplary Embodiments presented above is intended to facilitate a clear understanding of the system's architecture and advantages, and to lay a foundation for a range of patent claims that capture the innovative aspects of automatic digital receipt generation and secure, intelligent management as disclosed.

### 1. Exemplary System Overview

The software system for automatic generation and transmission of digital receipts is designed to interface with a wide range of point-of-sale (POS) terminals, direct debit networks, and mobile payment platforms to securely extract transaction data, categorize receipts, and transmit them to banking systems. The architecture consists of several interconnected modules, each responsible for handling distinct aspects of the receipt generation, categorization, and transmission process.

The system comprises several components, each addressing distinct functionalities within the framework. These include the OAuth 2.0 Authentication Module, ensuring secure access and data exchange, and the Transaction Data Extraction Module, which retrieves and processes transaction details. The Digital Receipt Generation Module is responsible for creating standardized digital receipts, while the Categorization Module leverages machine learning algorithms to classify transactions efficiently. Secure data handling is further guaranteed by the Secure Transmission Module. The Bank Integration Module and the Bookkeeping Integration Module facilitate seamless interoperability with banking and accounting systems. Additional functionalities include the Rewards Management Module for embedding customer incentives, the Blockchain Audit Trail Module for immutable and verifiable records, and the Fraud Detection and AML Compliance Module, which safeguards against suspicious activities. Finally, the Offline Mode ensures operational continuity, even in the absence of an active internet connection.

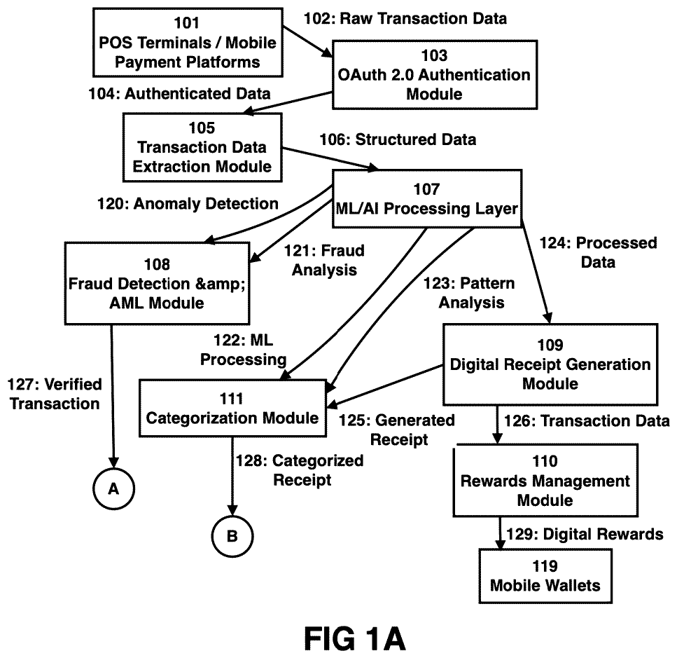

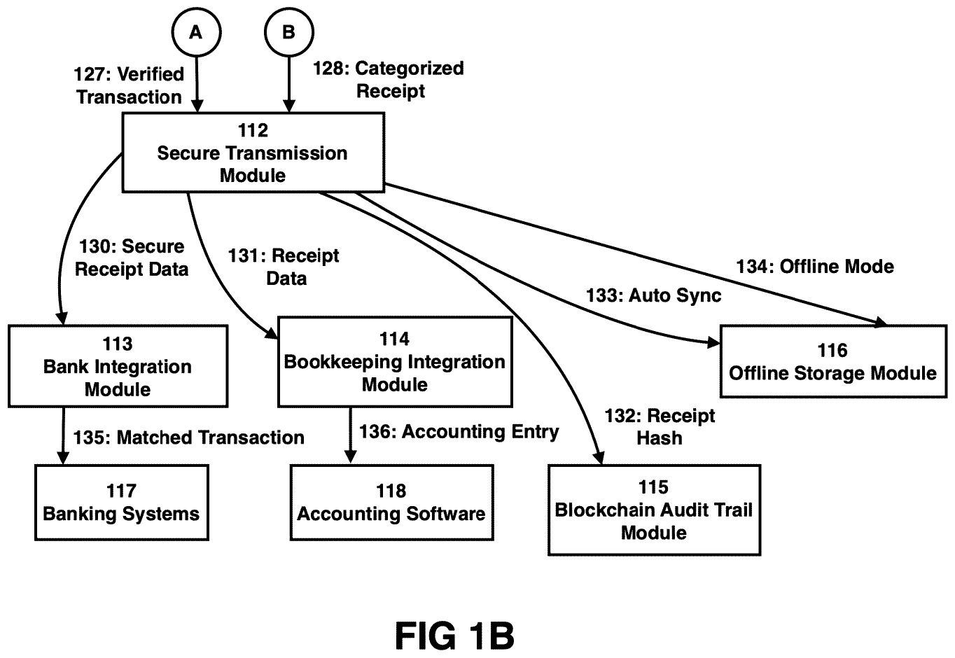

### DETAILED DESCRIPTION OF FIGS. 1A-1B

FIGS. 1A-1B illustrate a comprehensive system architecture for automatic generation and transmission of digital receipts. The system comprises multiple interconnected modules that process transaction data from initial capture through final distribution to various endpoints.

The process begins at the POS Terminals/Mobile Payment Platforms (101), which generate raw transaction data (102). This data undergoes initial security verification through the OAuth 2.0 Authentication Module (103), which employs client credentials and TLS 1.3 encryption to produce authenticated data (104).

The Transaction Data Extraction Module (105) receives the authenticated data and employs Natural Language Processing (NLP) and Optical Character Recognition (OCR) techniques to extract and structure the transaction information into normalized data (106). This module processes essential fields including merchant identifiers, transaction details, payment information, and itemized purchase data.

The ML/AI Processing Layer (107) functions as the central intelligence hub of the system, executing several critical operations to enhance efficiency and security. It incorporates Anomaly Detection (120) and Fraud Analysis (121) mechanisms to monitor and safeguard against security threats effectively. Additionally, it employs advanced ML Processing (122) techniques for recognizing patterns and utilizes Pattern Analysis (123) for accurate transaction categorization. This layer also facilitates the Generation of Processed Data (124), which is instrumental in the seamless creation of digital receipts. Collectively, these capabilities enable the system to deliver reliable and efficient processing of transactional information.

The Digital Receipt Generation Module (109) utilizes the processed data to create standardized digital receipts, while the Fraud Detection & AML Module (108) employs Random Forests and Support Vector Machines to monitor for suspicious activities.

The Categorization Module (111) employs Bidirectional LSTM networks and word embeddings to classify transactions into appropriate categories. Transaction categorization and merchant identification facilitate matching with existing accounting records through the system.

The Secure Transmission Module (112) is responsible for distributing processed information to various endpoints in a secure and efficient manner. It transmits Secure Receipt Data (130) to the Bank Integration Module (113) for financial processing, ensuring that all financial transactions are accurately recorded. Additionally, it forwards Receipt Data (131) to the Bookkeeping Integration Module (114) for accounting purposes, simplifying the reconciliation process for businesses. To ensure data integrity, the Receipt Hash (132) is sent to the Blockchain Audit Trail Module (115) for verification, providing a tamper-proof record of the transaction. Furthermore, the module supports Auto Sync (133) and Offline Mode (134) functionalities through the Offline Storage Module (116), allowing continuous operations even in the absence of internet connectivity.

The system is designed to integrate seamlessly with three primary endpoints. First, Banking Systems (117) receive matched transaction data (135) to facilitate accurate financial reconciliation. Second, Accounting Software (118) processes accounting entries (136), streamlining bookkeeping activities and ensuring compliance with financial reporting standards. Finally, Mobile Wallets (119) store digital rewards, providing customers with easy access to personalized offers and incentives directly within their wallets.

The entire system operates under strict security protocols, employing OAuth 2.0 authentication, TLS 1.3 encryption, and blockchain verification to ensure data integrity and secure transmission of digital receipts throughout the process flow.

### FIGS. 1A-1B: Descriptions of Components

### 101: POS Terminals/Mobile Payment Platforms

This component represents the entry point for transaction data. It interacts with various payment systems, including traditional POS terminals and modern mobile payment platforms like Apple Pay, Alipay, and WeChat Pay. These systems output raw transaction data (102), which includes essential information such as the merchant ID, payment method, and itemized purchases. The interoperability of this component is enabled by a universal API that supports multiple communication protocols like REST and SOAP.

How it works: Data flows from the terminal in diverse formats and structures, necessitating pre-processing at subsequent modules.

Integration: Ensures data compatibility with downstream modules by adhering to standardized formats.

### 103: OAuth 2.0 Authentication Module

The OAuth 2.0 Authentication Module secures the initial data capture process, ensuring that only authorized entities have access to transaction data. This module generates tokens using client credentials, validates requests with TLS 1.3 encryption, and enforces session expiration protocols to maintain security. It establishes secure communication channels between the POS terminals and the central system, managing tokens to authenticate data access and dynamically refreshing these tokens to ensure uninterrupted connectivity. Once authentication is complete, the authenticated data (104) is securely transferred to the Transaction Data Extraction Module (105) for further processing.

### 105: Transaction Data Extraction Module

The Transaction Data Extraction Module plays a role in converting raw transaction data into structured formats (106) for further processing. This module employs advanced techniques such as Optical Character Recognition (OCR) to extract textual details from scanned receipt images and Natural Language Processing (NLP) to analyze item descriptions and merchant information, aligning them with predefined schemas. Additionally, AI-based error correction is utilized to ensure accuracy and consistency when handling diverse receipt formats. Once the data is normalized, the module outputs structured data (106), which is subsequently forwarded to the ML/AI Processing Layer (107) for detailed analysis.

### 107: ML/AI Processing Layer

The ML/AI Processing Layer serves as the intelligence hub of the system, employing a range of advanced AI techniques to improve the accuracy, security, and usability of transactional data. It incorporates Anomaly Detection (120) using unsupervised learning models, such as Isolation Forests, to identify outliers in transaction patterns. Fraud Analysis (121) leverages Random Forest classifiers to detect potential fraudulent behaviors by analyzing historical transaction data. The layer also employs ML Processing (122) with Transformer models to derive deeper semantic insights from transactional data. Additionally, Pattern Analysis (123) identifies recurring trends to support categorization and enable future system improvements. By combining supervised and unsupervised learning techniques, the ML/AI Processing Layer efficiently analyzes transaction data to detect inconsistencies. The processed data (124) generated by this layer is subsequently forwarded for receipt generation (109) and categorization (111), ensuring seamless integration and functionality.

### 109: Digital Receipt Generation Module

The Digital Receipt Generation Module transforms processed data into standardized digital receipts, which are available in both human-readable formats (e.g., PDF) and machine-readable formats (e.g., JSON, XML). The module operates using template engines to populate receipt fields efficiently, ensuring consistent formatting. To maintain data integrity and authenticity, it employs RSA encryption to digitally sign receipts and incorporates unique blockchain hashes, providing tamper-proof verification. This module integrates seamlessly with the Categorization Module (111) to receive categorized data and with the Blockchain Audit Trail Module (115) to ensure secure and immutable record-keeping of the receipts.

### 108: Fraud Detection & AML Module

The Fraud Detection and AML Compliance Module integrates machine learning with rule-based engines to identify fraudulent activities and ensure compliance with anti-money laundering (AML) regulations. This module cross-references receipts against AML watchlists to detect potential risks and evaluates suspicious patterns, such as mismatched transaction amounts or repetitive purchases, which may indicate fraudulent behavior. Any flagged transactions are logged for further review, enabling comprehensive oversight. Verified transactions (127) are subsequently forwarded to the Categorization Module (111) for classification and the Secure Transmission Module (112) for safe delivery to the appropriate endpoints.

### 111: Categorization Module

The Categorization Module leverages Bidirectional LSTM networks to classify transactions into predefined categories, such as “Groceries” or “Dining.” This module operates by tokenizing and vectorizing text fields, preparing them for machine learning input, and applying embeddings like Word2Vec to achieve semantic understanding of the data. To ensure continuous improvement and accuracy, it incorporates feedback loops that allow the system to learn from prior classifications. The module outputs categorized receipts (128), which are then forwarded to the Secure Transmission Module (112) for secure and seamless delivery to their intended endpoints.

### 112: Secure Transmission Module

The Secure Transmission Module guarantees the safe delivery of receipts to various endpoints by employing TLS encryption and blockchain verification. This module encrypts sensitive fields, such as TUMI/UIN values, to ensure secure transport of data. It incorporates retry mechanisms to handle failed transmissions, ensuring reliability and uninterrupted delivery. Before final transmission, the module verifies the authenticity of receipts using blockchain hashes, providing an additional layer of security. This module seamlessly integrates with banking systems (113), bookkeeping platforms (114), and mobile wallets (119), ensuring efficient and secure connectivity across all endpoints.

### 115: Blockchain Audit Trail Module

The Blockchain Audit Trail Module records receipts on a permissioned blockchain ledger, ensuring immutability and traceability of transaction data. This module generates a unique hash for each receipt using the SHA-256 algorithm, providing a secure and verifiable record. It stores receipt metadata in compliance with GDPR and PCI-DSS standards, safeguarding both privacy and data integrity. Additionally, smart contracts are employed to validate receipt authenticity during audits, ensuring reliable verification processes. This module integrates seamlessly with the Secure Transmission Module (112), leveraging hash generation and verification to enhance data security and audit reliability.

### 114: Bookkeeping Integration Module

The Bookkeeping Integration Module streamlines accounting processes by automatically forwarding categorized receipts to platforms such as QuickBooks and Xero. This module maps receipts to accounting categories using decision trees, ensuring accurate classification of financial data. It synchronizes with third-party APIs to update financial records in real time, enhancing efficiency and reducing manual effort. Additionally, the module flags discrepancies for manual review, enabling businesses to address potential issues promptly. The categorized data is seamlessly transmitted to accounting systems (118), ensuring integration and alignment with financial reporting requirements.

### 116: Offline Storage Module

The Offline Storage Module ensures continuous functionality by enabling receipt generation and processing in offline mode, with automatic synchronization upon reconnecting to the network. This module encrypts and stores transaction data locally using AES-256 encryption, ensuring data security even when offline. It queues receipts for transmission, ensuring that no data is lost during network disruptions. Upon reconnection, the module verifies the integrity of the data before syncing it with the system. This module supports the Secure Transmission Module (112) and other downstream components, ensuring seamless integration and functionality.

The system interacts with three primary endpoints to ensure comprehensive functionality. First, Banking Systems (117) match receipt data with transaction records for reconciliation and notify users of receipt updates through their banking apps. Second, Accounting Software (118) automatically reconciles transactions with ledger entries, streamlining financial management and generating reports for tax compliance. Third, Mobile Wallets (119) store digital rewards linked to receipts, providing users with an easy way to redeem offers. These wallets also enable seamless integration of rewards into platforms such as Apple Wallet and Google Wallet, enhancing user convenience and engagement.

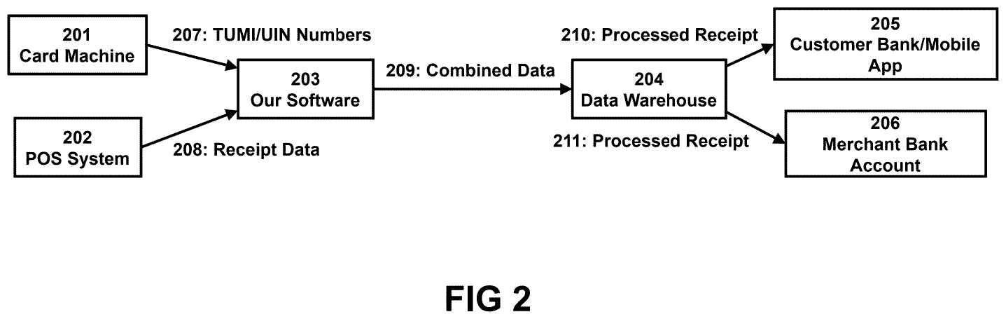

### DETAILED DESCRIPTION OF FIG. 2

FIG. 2 illustrates the data flow architecture between payment capture systems and banking endpoints through the system's core processing components.

The data flow begins with two primary input sources, each contributing essential transaction details to the system. The first source is a Card Machine (201), which securely captures and transmits Transaction-Unique Metadata Identifier (TUMI) or Unique Identifier Number (UIN) data (207). The second source is a POS System (202), responsible for generating and transmitting detailed Receipt Data (208), including itemized transaction information. Together, these inputs form the foundation for the subsequent processing and integration within the system.

Our Software (203) serves as the central processing hub, receiving and combining these dual data streams. The software implements OAuth 2.0 authentication protocols and employs TLS 1.3 encryption to ensure secure data handling. The software processes the input streams to generate Combined Data (209), which encompasses both the payment information and detailed transaction data in a standardized format.

The Combined Data is transmitted to the Data Warehouse (204), which serves as the system's central repository and processing center. Within the Data Warehouse, machine learning algorithms are employed to verify, categorize, and process the data effectively. The warehouse then generates two distinct output streams: the first is a Processed Receipt (210) directed to the Customer Bank/Mobile App (205), which includes complete transaction details along with any associated rewards or offers. The second is a Processed Receipt (211) sent to the Merchant Bank Account (206), providing the necessary transaction and settlement information for accurate reconciliation.

This architecture ensures proper segregation and processing of financial data while maintaining synchronized transmission between customer and merchant endpoints. The system's design facilitates secure and efficient handling of both payment card data and transaction details, adhering to PCI-DSS compliance requirements and implementing proper data encryption throughout the transmission process.

The data flow architecture illustrates the system's robust capabilities in handling transactional data with precision and efficiency. It is designed to process multiple input streams simultaneously, ensuring seamless data handling from diverse sources.

Throughout the transformation process, the architecture maintains data integrity, guaranteeing that all transactional details remain accurate and unaltered. Secure transmission protocols ensure that data is safely delivered to the appropriate banking endpoints.

Furthermore, the architecture supports real-time transaction processing and receipt generation, enabling prompt and reliable service. It also facilitates accurate financial reconciliation between customer and merchant accounts, streamlining financial management and reporting for all stakeholders.

### FIG. 2 Descriptions of Components

### 201: Card Machine

The card machine plays a role in capturing payment information, including the Transaction-Unique Metadata Identifier (TUMI) or Unique Identifier Number (UIN), which are essential for identifying the issuing bank and linking transactions to the appropriate customer account. The card machine interfaces with payment networks to validate the payment method and collects encrypted TUMI or UIN data. This data is then securely transmitted using industry-standard encryption protocols, such as TLS 1.3, ensuring its safety and integrity. The TUMI/UIN data (207) is directly fed into the software module (203) for further processing and association with detailed transaction records, enabling accurate reconciliation and secure data handling.

### 202: POS System

The POS system is responsible for collecting transaction details, including itemized purchases, merchant identifiers, and payment totals, which form the foundation of the receipt generation process. By interfacing with payment terminals, the POS system captures purchase data in real time, ensuring accuracy and immediacy. It then formats the raw transaction data (208) into structured formats such as JSON or XML, making it compatible with downstream modules for further processing. The POS system works in close coordination with the card machine (201), supplying complementary data streams to the software module (203) to enable seamless integration and comprehensive transaction processing.

### 203: Our Software

This component serves as the central processing hub of the system, using TUMI/UIN data from the card machine with receipt data from the POS system to create a unified transaction dataset. The system ensures data security and integrity by using OAuth 2.0 for authenticating data sources and TLS 1.3 encryption for secure data transmission. It integrates the TUMI/UIN and receipt data into a standardized format (209) for efficient processing. In addition, it handles errors by detecting and flagging inconsistencies or missing fields in the input streams, ensuring that data is corrected before transmission. The combined data is then passed to the data warehouse (204) for storage, further processing, and output generation.

### 204: Data Warehouse

The data warehouse functions as a centralized repository and processing unit, employing advanced algorithms to categorize, validate, and transform data in preparation for secure transmission to end-user endpoints. It verifies accuracy by using machine learning to cross-check TUMI/UIN data against transaction details. For categorization, it leverages natural language processing (NLP) to classify transactions based on merchant and item descriptions. The warehouse securely encrypts and stores transaction data for both short-term processing and long-term retrieval. Additionally, it formats the data into “Processed Receipts” (210 and 211), customizing these outputs to meet the requirements of specific endpoints. Separate data streams are then generated for customer-facing (205) and merchant-facing (206) systems, ensuring seamless integration and usability.

### 205: Customer Bank/Mobile App

This endpoint is designed to receive processed receipts intended for customers, containing all relevant transaction details, along with any rewards and offers associated with the purchase. It integrates seamlessly with the customer's banking app, allowing receipts to be displayed alongside transaction histories for a cohesive user experience. The system supports rewards integration by including loyalty points, discounts, or promotional offers tied to each receipt. Additionally, it enables user interaction, allowing customers to view, download, or share receipts directly from the app. The endpoint receives receipt data (210) from the data warehouse (204), ensuring synchronization with customer transaction records and maintaining consistency across all systems.

### 206: Merchant Bank Account

This endpoint caters to the merchant's financial reconciliation needs by receiving processed receipts that contain essential transaction and settlement data. It integrates with merchant banking systems to facilitate transaction matching and reconciliation, ensuring accurate financial tracking. The endpoint provides itemized details that support accounting processes, tax reporting, and settlement tracking, enhancing the efficiency of financial operations. Additionally, it flags anomalies or discrepancies in transaction data, enabling merchants to review and resolve potential issues promptly. The endpoint receives processed receipt data (211) from the data warehouse (204), ensuring precise and timely reconciliation for merchant accounts.

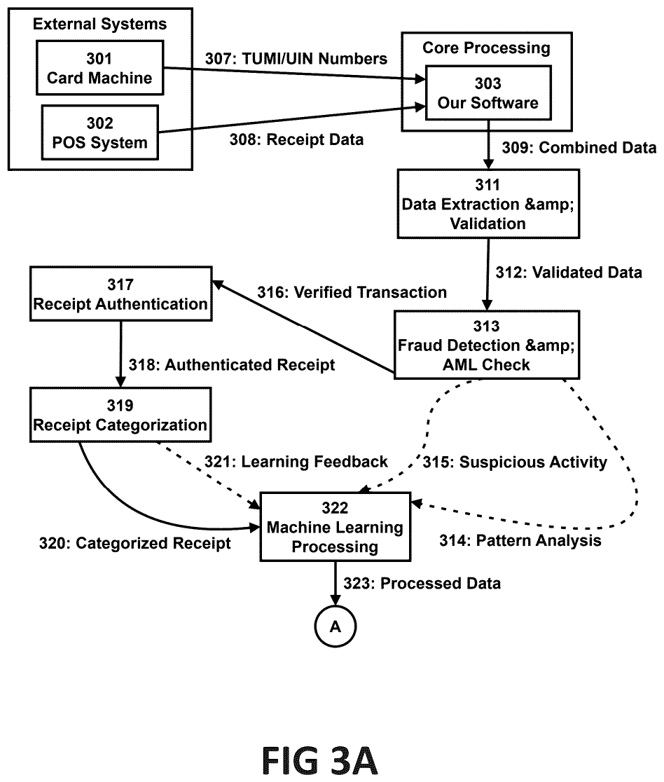

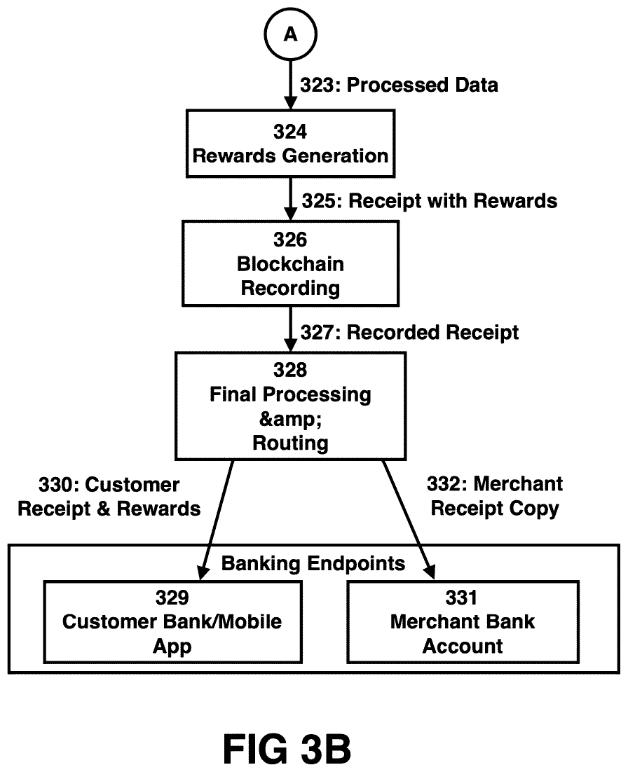

### DETAILED DESCRIPTION OF FIGS. 3A-3B

FIGS. 3A-3B illustrate the detailed data processing workflow within the Data Warehouse, showing the journey of transaction data from initial capture through final distribution.

The process initiates with two primary input sources that serve as the foundation for transactional data capture. The first source is a Card Machine (301), which securely transmits TUMI (Transaction-Unique Metadata Identifier) or UIN (Unique Identifier Number) data (307). The second source is a POS System (302), responsible for generating Receipt Data (308), including detailed information about the transaction. Together, these inputs provide the essential data streams required for subsequent processing and integration within the system.

Our Software (303) combines these inputs into a unified Combined Data stream (309), which is then forwarded to the Data Warehouse Processing (310) environment.

Within the Data Warehouse Processing environment, the data undergoes several sequential processing stages:

The Data Extraction & Validation module (311) performs initial processing of the combined data, employing NLP and OCR techniques as specified in Section 2.2 of the patent, producing Validated Data (312).

The Fraud Detection & AML Check module (313) analyzes validated data to ensure the integrity and security of transactions. It utilizes advanced machine learning techniques, including Random Forests and Support Vector Machines, to detect anomalies in transaction patterns. Additionally, it performs Pattern Analysis (314) for behavioral monitoring, identifying deviations that may indicate fraudulent activity. The module also flags Suspicious Activity (315) for further investigation, providing a robust mechanism to safeguard against financial risks and ensure compliance with anti-money laundering regulations.

Upon successful verification, a Verified Transaction (316) is passed to the Receipt Authentication module (317), which generates an Authenticated Receipt (318) using the security protocols detailed in Section 2.5.

The Receipt Categorization module (319) employs Bidirectional LSTM networks and word embeddings to classify the receipt, producing a Categorized Receipt (320). The system implements a Learning Feedback (321) loop that feeds into the Machine Learning Processing module (322).

The Machine Learning Processing module (322) generates Processed Data (323), which is forwarded to the Rewards Generation module (324). This module creates personalized Receipt with Rewards (325) based on customer behavior analysis and merchant preferences.

The Blockchain Recording module (326) creates an immutable record of the transaction using SHA-256 hashing, producing a Recorded Receipt (327) that ensures data integrity and non-repudiation.

The Final Processing & Routing module (328) oversees the distribution of processed information to the appropriate endpoints. It directs Customer Receipts and Rewards (330) to the Customer Bank/Mobile App (329), ensuring that customers receive a comprehensive record of their transactions and any associated rewards. Simultaneously, the module sends Merchant Receipt Copies (332) to the Merchant Bank Account (331), providing merchants with the necessary documentation for reconciliation and record-keeping. This streamlined routing ensures accurate and efficient dissemination of transactional data to both customers and merchants.

The entire process implements end-to-end encryption using TLS 1.3 and maintains compliance with PCI-DSS requirements throughout the data processing lifecycle.

### FIG. 3 Description of Components

### 301: Card Machine

The card machine securely captures customer payment information, including the TUMI (Transaction-Unique Metadata Identifier) or UIN (Unique Identifier Number), transmitting this data as a secure stream (307). These identifiers play a role in linking transactions to bank accounts and identifying the issuing institution. The card machine communicates with payment networks using advanced encryption protocols, such as TLS 1.3, to ensure the secure capture and transmission of payment details at the point of transaction.

The encrypted TUMI/UIN data is then fed into the core processing software (303), where it is combined with transaction details received from the POS system (302) for further processing and integration.

### 302: POS System

The POS system gathers itemized transaction details, including product descriptions, quantities, prices, taxes, and payment totals, collectively referred to as Receipt Data (308). It interfaces directly with merchant systems to compile detailed purchase information and transforms raw transaction data into structured formats that are compatible with downstream processing modules. The receipt data is then streamed to the core software (303), where it is synchronized with payment details provided by the card machine, ensuring comprehensive and accurate transaction records.

### 303: Our Software

This module operates as the central hub for data synchronization, combining TUMI/UIN data (307) from the card machine and receipt data (308) from the POS system into a single unified data stream (309). It ensures secure handling of data inputs by using OAuth 2.0 for authentication. The module normalizes and integrates the input streams into a standardized schema, preparing them for downstream processing. It also manages sessions effectively and implements dynamic error correction to ensure seamless data synchronization. The combined data (309) is then passed to the Data Extraction & Validation module (311) within the Data Warehouse (310) for further processing.

### 310: Data Warehouse

The Data Warehouse is a central repository for data processing, employing advanced techniques for extraction, validation, fraud detection, and categorization.

### 311: Data Extraction & Validation

This module extracts key information from the combined data and validates it for accuracy and completeness, utilizing advanced techniques such as Natural Language Processing (NLP) and Optical Character Recognition (OCR). NLP is applied to extract textual data from receipts, including merchant names and item descriptions, while OCR digitizes and validates receipt images or non-standard formats. To ensure data integrity, error-detection algorithms are implemented to identify and address any inconsistencies before the data is passed downstream. The validated data (312) is then sent to the fraud and compliance checks module (313) for further processing.

### 313: Fraud Detection & AML Check

The fraud detection module employs machine learning models and rules-based algorithms to identify suspicious activities and ensure compliance with anti-money laundering (AML) regulations. It utilizes Random Forests and Support Vector Machines to detect anomalies by comparing transactions against historical patterns, while behavioral analysis through Pattern Analysis (314) monitors customer behavior to identify irregularities. If deviations from expected norms are detected, the module flags these as Suspicious Activity (315) for further investigation. Verified transactions (316) are forwarded to the Receipt Authentication module (317), while flagged activities are routed for detailed review, ensuring robust security and compliance.

### 317: Receipt Authentication

The Receipt Authentication module ensures the integrity of receipts by applying advanced security protocols such as digital signing and hashing. It digitally signs receipts using RSA encryption, guaranteeing their authenticity and preventing unauthorized modifications. Additionally, the module validates receipt data against recorded transaction data, ensuring consistency and detecting any potential tampering. Authenticated Receipts (318) are then forwarded to the categorization module for further processing, maintaining a secure and reliable data flow.

### 319: Receipt Categorization

The categorization module classifies receipts into predefined categories, such as Groceries, Dining, and Electronics, by leveraging Bidirectional LSTM networks and word embeddings. It tokenizes text fields, such as item names, and applies semantic analysis to achieve accurate classification. To enhance performance, the module incorporates user feedback through a Learning Feedback loop (321), allowing continuous refinement of the categorization algorithms. The output consists of Categorized Receipts (320), which are subsequently processed by the Machine Learning Processing module (322) for further analysis and optimization.

### 322: Machine Learning Processing

The Machine Learning Processing module performs advanced data processing to optimize downstream functionalities such as rewards generation and blockchain recording. It aggregates categorized receipts and user feedback to enhance predictive algorithms, ensuring continuous improvement in system accuracy. Additionally, the module applies feature engineering techniques to extract actionable insights from transaction data, enabling more effective decision-making. The processed data (323) is then output for integration into rewards generation and blockchain recording modules, ensuring seamless and optimized downstream operations.

### 324: Rewards Generation

The Rewards Generation module creates personalized offers and loyalty rewards by analyzing transaction data and customer behavior. It employs collaborative filtering techniques to align rewards with individual customer preferences, ensuring relevance and engagement. The module dynamically generates vouchers or loyalty points based on merchant-specific criteria, tailoring incentives to specific business goals. These rewards are then embedded into receipts (325) for integration with customer-facing systems, providing a seamless and engaging user experience.

### 326: Blockchain Recording

The Blockchain Module guarantees the immutability of transactions by creating a verifiable audit trail. It generates SHA-256 hashes for each receipt, ensuring tamper-proof storage and data integrity. These hashes are recorded on a permissioned blockchain, maintaining compliance with privacy regulations while providing secure and transparent record-keeping. The module outputs Recorded Receipts (327), which are then forwarded for final processing and routing, ensuring secure and reliable downstream integration.

### 328: Final Processing & Routing

The Final Data Distribution module manages the delivery of processed and recorded data to the appropriate endpoints. It routes Customer Receipts and Rewards (330) to the Customer Bank/Mobile App (329), ensuring that users have access to their transaction details and incentives. Simultaneously, it sends Merchant Receipt Copies (332) to the Merchant Bank Account (331) for reconciliation and record-keeping. The module incorporates role-based access controls to ensure that data is securely delivered only to authorized recipients, maintaining confidentiality and compliance with security protocols.

### 2. System Components and Functional Architecture

### 2.1. OAuth 2.0 Authentication Module

The OAuth 2.0 module facilitates secure communication between the system and various POS terminals by implementing a secure token exchange protocol. This ensures that only authenticated POS systems can interact with the digital receipt generation system.

The module employs the OAuth 2.0 client credentials grant flow to verify system identity, retrieve access tokens, and refresh tokens as needed. It uses client credentials, including a client ID and secret, to obtain an access token from the authorization server. All token transmissions occur over encrypted channels using TLS 1.3, maintaining a high level of security. Access tokens are used to interact with POS APIs for a predefined session duration, after which the module initiates a renewal process to extend access securely.

### 2.2. Transaction Data Extraction Module

This module connects directly with the POS system through a universal API that standardizes data retrieval by abstracting the differences between various POS systems. The API is designed to recognize multiple communication protocols, such as REST and SOAP, and handle data formats like JSON and XML, enabling integration with traditional POS terminals as well as mobile payment platforms like Apple Pay®, Alipay®, and WeChat Pay®. The module extracts a range of data fields, including the merchant name and ID, transaction ID, payment method (credit/debit card or mobile wallet), purchase date and time, itemized purchase details (description, SKU, quantity, unit price), tax information, total amount, and TUMI or UIN for secure routing. Data handling includes parsing, validating, and structuring the extracted information into a standardized format using schema definitions such as JSON Schema.

### AI Integration

The system incorporates Natural Language Processing (NLP) and Optical Character Recognition (OCR) techniques to handle the extraction of transaction data from digital receipts directly at the point of sale (POS). The AI extracts key transaction details such as merchant name, item descriptions, price, tax, and total amount, ensuring accuracy across different POS systems with varying formats.

### Backend Features

Data Handling and Pre-processing: The AI first receives raw transaction data from various POS systems, which can vary widely in terms of format, structure, and data fields. Before applying NLP and OCR techniques, the data is cleaned and normalized to ensure consistency. Pre-processing steps include filtering out noise (e.g., irrelevant text or non-transactional data) and aligning receipt formats to standard data structures.

Real-Time Data Processing: Once the data is pre-processed, the AI extraction module processes it in real time, applying deep learning-based OCR models to recognize text fields from the digital receipt. NLP models then analyse the extracted text to understand the context and meaning behind the merchant names, item descriptions, and amounts. The system ensures that items are matched with the appropriate categories (e.g., groceries, electronics).

Monitoring and Logging: The backend maintains a log of each extraction event, including error rates and discrepancies between POS output and extracted data. This log feeds into the AI's retraining loop, allowing it to improve its accuracy over time by learning from past errors.

### Training and Data Handling

The AI system is trained on diverse datasets of receipts from various POS systems, using supervised learning techniques to accurately extract transaction details under different conditions (e.g., varying fonts, formats, languages). The training dataset is enhanced with simulated variations of real-world receipts to ensure robustness.

An iterative learning process is used, whereby the AI is continuously updated with new receipt data from POS systems, improving its ability to handle edge cases and unusual formats. Errors in extraction (e.g., misreading a merchant name) triggers a retraining loop, ensuring the system adapts over time.

Enhanced Iterative Data Augmentation and Retraining: To further enhance the AI's learning capability, an additional iterative training mechanism is implemented. In this process, each receipt data instance undergoes one or more mathematical transformations-such as iteratively multiplying key numerical data by a fixed factor-to generate a modified set of data variants. These transformed instances are then merged with the original training set to form an expanded dataset. Following the initial training stage, the AI is evaluated to identify extraction errors (e.g., incorrect recognition of merchant names or item details). These misclassified instances are reintegrated into the training dataset, prompting a secondary stage of training. This dual-stage approach systematically reduces false positives and enhances the overall robustness and accuracy of the AI models over successive iterations.

### Mathematical Behaviour

The extraction AI relies on deep learning models, such as convolutional neural networks (CNNs) for OCR and transformer-based models for NLP tasks. These models are designed to handle the complexity of unstructured text data and derive structured information from it. The OCR model applies a pixel-level analysis of the receipt image, using convolutional layers to detect text characters, while the NLP model processes the extracted text to interpret merchant and item descriptions based on semantic context.

The system employs a cross-entropy loss function to calculate the error between the extracted data and the actual receipt data. During training, the AI backpropagates this error through the network, adjusting its weights to improve future predictions.

### Additional Details on Transformation Functions and Iterative Retraining

This embodiment further refines the training process by incorporating explicit guidelines for data transformation and iterative retraining. In one implementation, the transformation functions are determined through a preliminary statistical analysis of a representative sample of reconciliation data. Specifically, the system calculates the mean (μ) and standard deviation (σ) for key numerical fields. A fixed multiplier factor (M) is then set, for example, as M=1+k·σ/μ, where k is a predetermined constant. Each data instance is iteratively transformed by multiplying by M, generating synthetic variants that broaden the training set. This process ensures continuous improvement and adaptation to diverse data formats and edge cases without undue experimentation. The iterative retraining process proceeds as follows:
1. Initial Training: Train the neural network using the first training set comprising both original and augmented data.
2. Evaluation: Evaluate the trained model on a separate validation set and compute error metrics (e.g., cross-entropy loss).
3. Error Identification: Identify misclassified or borderline instances based on a threshold error value.
4. Data Augmentation: Integrate these misclassified instances into an expanded training set.
5. Retraining: Retrain the model with the updated training set.
6. Iteration: Repeat steps 2-5 until performance metrics (accuracy, precision, recall) meet or exceed predetermined thresholds.

### Practical Improvement

By employing AI to extract receipt data automatically at the POS, this module eliminates the need for manual data entry or format standardization. It ensures that all receipt data is accurately extracted and transmitted to the bank's systems in real time, regardless of the specific POS format or receipt structure. The AI models improve extraction from various POS systems by using NLP models that adapt to different formats and structures. The robustness in handling discrepancies between POS outputs (e.g., missing or irregular fields) are enhanced. AI models self-adjust to variations in POS configurations, reducing the need for manual adjustments.

Example: A customer purchases a pair of shoes at a retail store. As the POS system processes the transaction, the digital receipt is generated and automatically sent to the AI-powered extraction module. The AI accurately identifies and extracts key data, such as the store name, product description (“Sneakers”), prices, tax, and total amount. This information is then structured and securely transmitted to the customer's bank account, where it is associated with the corresponding transaction without any manual intervention. If the AI encounters any formatting discrepancies (e.g., an unusual font or layout), it flags the issue for retraining, ensuring better performance in future extractions.

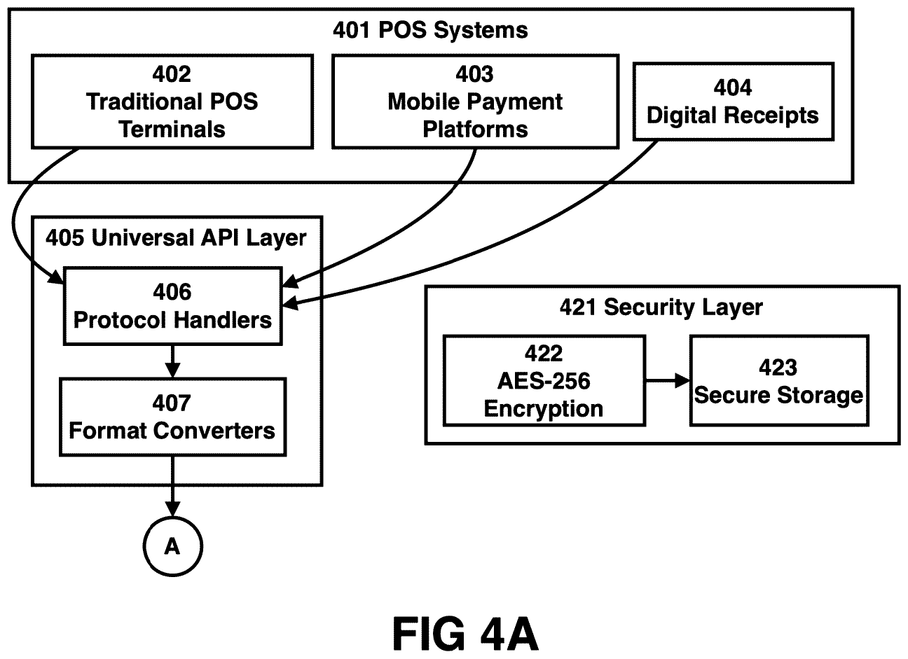

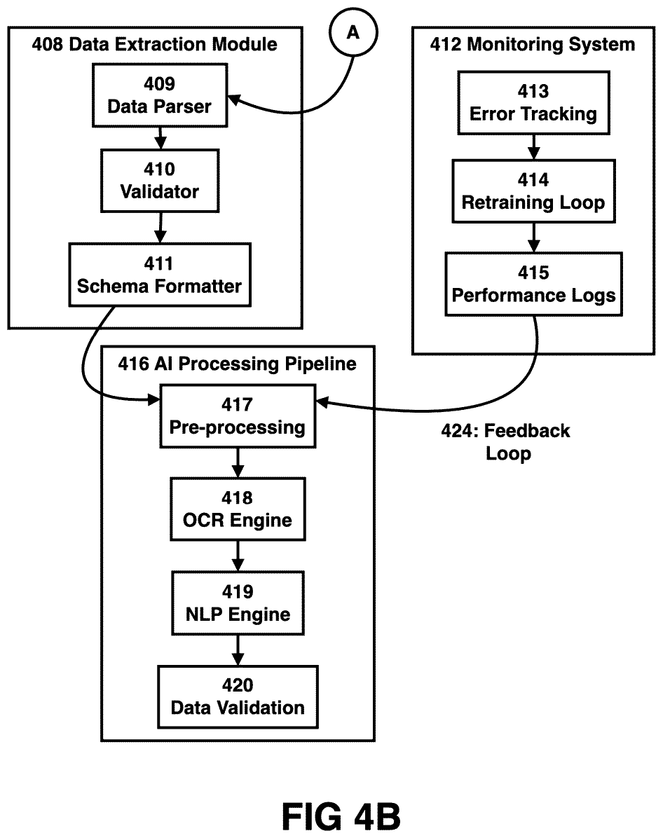

### DETAILED DESCRIPTION OF FIGS. 4A-4B

FIGS. 4A-4B illustrate the detailed architecture of the Transaction Data Extraction Module, which interfaces with various POS systems to securely extract and process transaction data through multiple specialized layers.

The system initiates operations at the POS Systems level (401), which integrates three primary input sources. The first source is Traditional POS Terminals (402), responsible for processing transactions at physical retail locations. The second source encompasses Mobile Payment Platforms (403), including widely used systems such as Apple Pay®, Alipay®, and WeChat Pay®, enabling seamless digital transactions. The third source consists of Digital Receipts (404) generated from various platforms, contributing to a comprehensive and unified data input framework for subsequent processing within the system.

The Universal API Layer (405) provides standardized communication interfaces that facilitate seamless interaction across diverse systems. It employs Protocol Handlers (406) to support multiple protocols, including REST and SOAP, ensuring compatibility with various platforms. Additionally, Format Converters (407) are utilized to standardize data formats, such as JSON and XML, enabling efficient data exchange and processing.

The Data Extraction Module (408) processes the standardized input through a series of robust mechanisms. A Data Parser (409) performs the initial interpretation of the input data, followed by a Validator (410) that ensures the data meets verification standards. Finally, the Schema Formatter (411) structures the data according to predefined schemas, preparing it for downstream processing.

The Monitoring System (412) maintains system integrity and ensures continuous improvement. It incorporates Error Tracking (413) to identify and address issues, a Retraining Loop (414) that enhances system accuracy over time, and Performance Logs (415) to monitor system operations and optimize performance.

The AI Processing Pipeline (416) executes advanced processing steps to extract actionable insights from input data. It begins with Pre-processing (417) to clean and normalize data, followed by the OCR Engine (418) for text recognition. The NLP Engine (419) interprets semantic meaning, and Data Validation (420) ensures the accuracy of processed information.

The Security Layer (421) ensures comprehensive data protection through robust measures. AES-256 Encryption (422) secures sensitive data during processing and transmission, while Secure Storage (423) maintains encrypted information to safeguard against unauthorized access and ensure compliance with data protection standards.

A Feedback Loop (424) connects the Monitoring System to the AI Processing Pipeline, enabling continuous learning and system improvement.

### FIG. 4 Description of Components

### 401: POS Systems

This component serves as the data input layer, incorporating three primary sources of transaction data to ensure comprehensive coverage and seamless integration. Traditional POS Terminals capture payment data from physical retail environments, extracting critical details such as merchant ID, payment type, and transaction amount in structured formats. The extracted data is then fed into the Universal API Layer (405) for standardization and further processing. Mobile Payment Platforms manage modern digital payment systems, including platforms like Apple Pay® and Alipay®. These platforms interface with digital wallets to collect transaction data in real time, ensuring the timely transmission of accurate information. The data is standardized and transmitted to the Universal API Layer for subsequent harmonization and processing. Digital Receipts aggregate pre-generated digital receipts from third-party platforms or in-app systems. This input consolidates receipt data from diverse sources, ensuring consistency and uniformity before transmitting the information to the Universal API Layer for alignment with the system's processing framework.

### 405: Universal API Layer

The Universal API Layer standardizes communication across diverse input sources by utilizing Protocol Handlers and Format Converters. Protocol Handlers interpret multiple protocols, such as REST for web services and SOAP for legacy systems, converting them into a unified communication format to ensure compatibility. Format Converters translate input data from various formats, including JSON and XML, into a consistent schema, preparing the data for downstream processing. The standardized data is then sent to the Data Extraction Module (408) for parsing and validation, ensuring seamless integration across the system.

### 408: Data Extraction Module

The Data Extraction Module processes and structures input data through a series of systematic steps. The Data Parser (409) analyzes raw transaction data to extract relevant fields, such as item descriptions and totals, and passes the parsed data to the Validator (410) for further checks. The Validator ensures data completeness, format accuracy, and logical consistency before forwarding it to the Schema Formatter (411). The Schema Formatter structures the transaction data into predefined schemas, preparing it for downstream AI processing. The formatted data is then sent to the AI Processing Pipeline (416) for advanced analysis and interpretation.

### 412: Monitoring System

The system ensures operational integrity and continuous improvement of the data processing workflow through a combination of error tracking, model retraining, and performance monitoring. Error Tracking (413) identifies and logs issues encountered during data extraction, such as incomplete fields or formatting errors, and triggers retraining in the AI Processing Pipeline through the Feedback Loop. The Retraining Loop (414) continuously updates AI models by incorporating insights from logged errors, enhancing the accuracy and performance of future processing tasks. Performance Logs (415) capture critical system metrics, including processing times and error rates, providing actionable insights to optimize system efficiency and maintain reliability.

### 416: AI Processing Pipeline

The AI Processing Pipeline utilizes advanced machine learning techniques to refine and validate transaction data through a series of interconnected stages. Pre-processing (417) cleans and normalizes raw data, resolving inconsistencies and outliers to ensure a reliable input for subsequent processes. The cleaned data is then fed into the OCR Engine (418), which recognizes and digitizes text from scanned receipt images or non-standard formats, producing structured text data. This output is passed to the NLP Engine (419), which performs semantic analysis on the transaction data, interpreting item descriptions and merchant categories to enrich the dataset. Finally, Data Validation (420) verifies the accuracy and consistency of the AI-processed data, preparing it for transfer to the next module or designated endpoints.

### 421: Security Layer

The Security Layer ensures robust protection for all sensitive transaction data through advanced encryption and secure storage mechanisms. AES-256 Encryption (422) is employed to encrypt data fields such as TUMI/UIN numbers and transaction totals, preventing unauthorized access and maintaining data confidentiality. This encryption is applied to both stored and transmitted data, ensuring comprehensive security throughout the system. Secure Storage (423) further enhances protection by securely storing encrypted data in compliance with PCI-DSS standards, while also enabling safe and efficient retrieval for subsequent processing tasks.

### 424: Feedback Loop

This iterative loop connects the Monitoring System (412) with the AI Processing Pipeline (416) to facilitate continuous improvement. It logs errors and performance metrics, which are then used to retrain AI models, enhancing their accuracy and efficiency. The loop updates pre-processing, OCR, and NLP algorithms to address new patterns and anomalies, ensuring the system remains robust and adaptable. By iteratively refining processing models, the loop enables the system to maintain resilience and effectively handle evolving data challenges.

### 2.3. Digital Receipt Generation Module

This module generates a structured digital receipt by assembling extracted data fields into a predefined template. The receipts are created in both human-readable formats, such as PDF and HTML, and machine-readable formats, including JSON and XML. Template processing is performed using engines like Jinja2 for Python, which populate placeholders with transaction-specific data. The system also supports template customization to align with merchant preferences and customer configurations. To ensure security, all digital receipts are digitally signed using RSA-based public-private key pairs, guaranteeing data integrity and non-repudiation. Additionally, each receipt includes a unique hash stored in the blockchain ledger, enabling secure and tamper-proof verification.

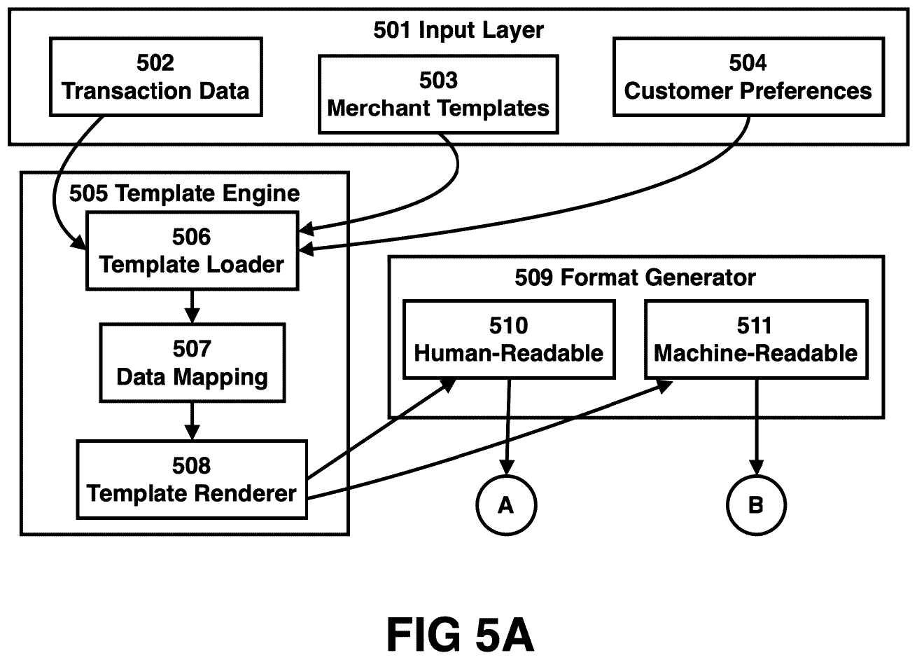

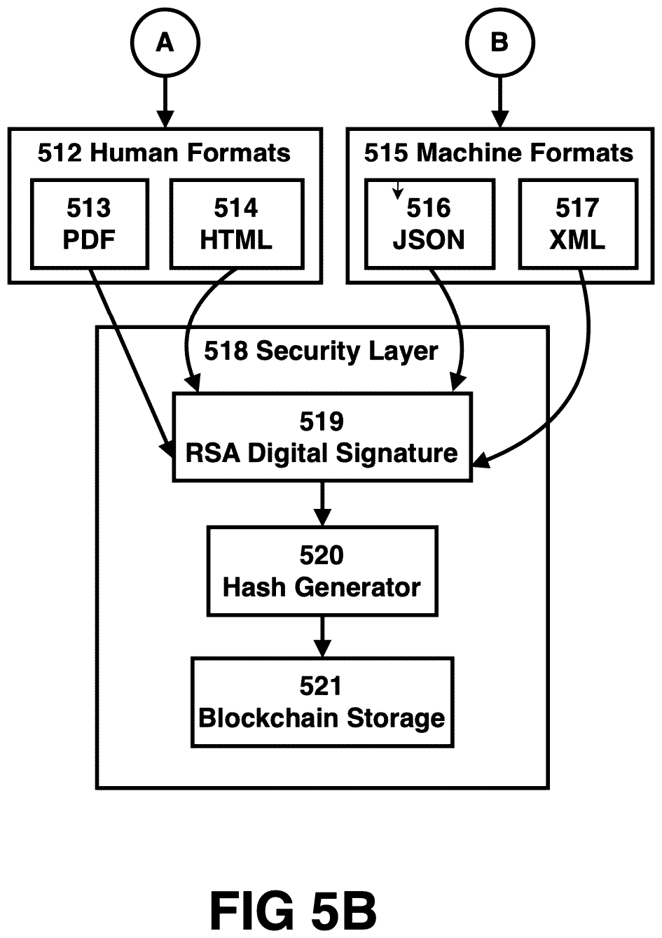

### DETAILED DESCRIPTION OF FIGS. 5A-5B

FIGS. 5A-5B illustrate the architecture of the Digital Receipt Generation Module, which processes transaction data through multiple layers to generate secure and standardized digital receipts in various formats. The Input Layer (501) receives three primary data streams: Transaction Data (502) containing purchase details and payment information, Merchant Templates (503) for customized receipt formatting, and Customer Preferences (504) for personalized receipt delivery.

The Template Engine (505) processes these inputs through several subcomponents. The Template Loader (506) combines the three input streams into a unified structure. Data Mapping (507) arranges the data according to the specifications of the selected template. The Template Renderer (508) generates the final receipt structure, ensuring the output aligns with both merchant and customer requirements.

The Format Generator (509) produces two parallel output streams to meet diverse needs. Human-Readable formats (510) are designed for direct customer access, while Machine-Readable formats (511) facilitate seamless system integration and processing.

The Human Formats section (512) outputs receipts in PDF format (513), which ensures document preservation, and HTML format (514), optimized for web-based viewing.

The Machine Formats section (515) generates receipts in JSON format (516) for programmatic access and XML format (517) for system interoperability, providing compatibility with various applications and workflows.

The Security Layer (518) ensures receipt integrity and security. It employs RSA Digital Signatures (519) using public-private key pairs to verify authenticity. A Hash Generator (520) creates unique receipt identifiers, while Blockchain Storage (521) maintains immutable records of the receipts, safeguarding against tampering and ensuring traceability.

This architecture implements the complete receipt generation workflow detailed in Section 2.3 of the patent, incorporating template processing, multiple format generation, and security measures to ensure receipt authenticity and non-repudiation.

The system employs RSA-based digital signatures and blockchain storage to maintain an auditable trail of all generated receipts, ensuring compliance with regulatory requirements while providing both human-readable and machine-readable formats for maximum utility.

### FIG. 5 Description of Components

### 501: Input Layer

The Input Layer serves as the starting point for the receipt generation process, integrating data from three distinct streams. Transaction Data (502) includes detailed purchase information such as merchant ID, item descriptions, totals, and payment methods, providing essential fields for receipt generation and feeding into the Template Engine (505). Merchant Templates (503) supply pre-configured designs for customizing receipts to align with merchant branding and formatting preferences, ensuring compliance with specific requirements. Customer Preferences (504) define how customers wish to receive and interact with receipts, including preferred language and delivery methods, enabling personalized receipt delivery tailored to individual needs.

### 505: Template Engine

The Template Engine is the core of the receipt generation module, responsible for combining and processing input data streams to produce structured outputs. The Template Loader (506) integrates transaction data, templates, and customer preferences into a unified format, preparing the data for further processing. This combined data is then passed to the Data Mapping module (507), which aligns input fields with predefined placeholders in the templates, ensuring data consistency and accuracy. Finally, the Template Renderer (508) finalizes the receipt structure by populating the template with transaction details and formatting it according to merchant and customer specifications. The completed receipt structures are then output to the Format Generator (509) for further processing and distribution.

### 509: Format Generator

The Format Generator produces receipts in two distinct output streams, catering to both customer interaction and system interoperability. Human-Readable Formats (510) include PDF Format (513), which generates a static, printable version of the receipt suitable for archiving or sharing, and HTML Format (514), which creates web-friendly versions for viewing on mobile or desktop browsers. These formats are made accessible to customers via portals, banking apps, or email delivery. Machine-Readable Formats (511) include JSON Format (516), which produces lightweight, structured data optimized for programmatic use, enabling integration with bookkeeping systems or third-party APIs. XML Format (517) generates interoperable data structures that comply with enterprise standards, facilitating regulatory submissions and seamless data exchange in banking and accounting systems.

### 518: Security Layer

The Security Layer ensures the authenticity, integrity, and immutability of the generated receipts through advanced cryptographic measures. RSA Digital Signatures (519) are applied to each receipt using a public-private key pair, guaranteeing authenticity and enabling verification of receipt origin and integrity by banks and merchants. The Hash Generator (520) creates a unique hash for every receipt, serving as a tamper-proof identifier that links to the blockchain storage module for creating an audit trail. Blockchain Storage (521) stores these hashed receipts on a permissioned blockchain, providing an immutable record of receipt generation. This ensures verifiable proof of transaction authenticity and compliance with audit and regulatory requirements.

### 2.4. Categorization Module

The categorization module employs a supervised machine learning (ML) model to classify receipts into predefined categories, such as “Groceries,” “Dining,” and “Electronics,” using Natural Language Processing (NLP) techniques to analyze item descriptions, merchant names, and contextual clues. The model architecture is based on a Bidirectional LSTM (Long Short-Term Memory) network, which processes text fields in receipt data. It utilizes word embeddings, such as Word2Vec or GloVe, to convert textual information into numerical vectors for input, with a SoftMax layer providing the probability distribution across various categories. The model is periodically updated using new receipt data to account for emerging trends and patterns. A feedback loop integrates user corrections from miscategorized receipts to fine-tune the model's parameters for improved accuracy. During processing, receipt text fields are tokenized, vectorized, and passed through the LSTM layers, ultimately outputting a category label (e.g., “Groceries”) that is attached to the corresponding receipt in the database.

### AI Integration

The Categorization Module employs supervised machine learning algorithms to classify receipts into specific categories (e.g., Groceries, Dining, Travel) based on both the merchant information and the specific items bought. By analysing the item descriptions on the receipt (e.g., food, electronics, clothing), the AI accurately categorizes the transaction for detailed financial tracking and reporting.

### Backend Features

Data Handling and Pre-processing: The AI pre-processes data by cleaning and structuring the transaction details and individual item descriptions. It applies tokenization and stemming to the item descriptions, breaking them into smaller meaningful units and reducing words to their base forms (e.g., “Sneakers” would be stemmed to “Sneaker”). The system also handles incomplete descriptions and normalize different merchant terminologies (e.g., “Electronics Store”vs. “Electronics”).

Model Training and Optimization: The categorization AI is trained on large datasets that include both merchant-level and item-level categorizations. The system uses feature engineering to extract meaningful attributes from the receipt data (e.g., merchant category, item keywords) and applies these features to improve the classification accuracy.

Regularization techniques (such as L2 regularization) are applied during training to prevent overfitting, ensuring that the model generalizes well to new data.

Model Monitoring: The system monitors the AI's performance in real time, tracking accuracy metrics such as precision, recall, and F1-score. It also monitors how well the AI performs when presented with unusual or edge-case receipt data. The model is retrained periodically to improve accuracy, incorporating feedback from previous categorization errors.

### Training and Data Handling

The AI is trained on a wide range of labelled transaction data that includes both merchant and item-level information. The AI learns to accurately categorize not just by merchant type (e.g., restaurant or retail store) but also by analysing specific item descriptions (e.g., groceries, electronics, office supplies). This ensures that even non-standard item descriptions are categorized correctly.

The system continuously improves its performance through iterative training and backpropagation, adjusting its model weights based on misclassifications or user feedback.

Enhanced Iterative Data Augmentation and Retraining: To further refine the categorization model's accuracy and robustness, an advanced two-stage iterative training process is implemented. In one embodiment, a set of labelled receipt categorization data is collected from the database. Controlled transformation functions are applied to each data instance—such as minor alterations in tokenization, synonym substitution, adjustments in punctuation, or iterative scaling of numerical attributes—to generate a modified set of synthetic training examples. The first training set is created by combining the original labelled data with these augmented instances. The categorization model is initially trained on this combined dataset. Following this first training stage, the model's outputs are closely monitored to identify misclassified instances (e.g., receipts assigned incorrect categories).

These misclassified instances are then merged with the original training set to create an enhanced, second-stage training set. The model is retrained using this expanded dataset, and the process is iteratively repeated until key performance metrics—such as precision, recall, and F1—score-reach or exceed predetermined thresholds, thereby minimizing classification errors and improving overall model performance.

### Mathematical Behaviour

The categorization model uses a multi-class classification algorithm, such as a random forest classifier or a deep neural network. The model calculates probabilities for each possible category based on the features extracted from the receipt data, assigning the category with the highest probability to each transaction.

A SoftMax activation function is applied at the output layer of the neural network, converting the raw scores into a probability distribution across the possible categories. The model uses a cross-entropy loss function to quantify the error in its categorization, backpropagating this error through the network during training.

### Practical Improvement

Categorization accuracy is improved through the continuous learning and adaptation of ML models.

The system understands and classifies complex item descriptions that rule-based systems struggle with.

Manual corrections and user input are reduced by enhancing the granularity of categorization, making it suitable for tax compliance and financial reporting.

By analysing both merchant information and item-level details, the AI provides more granular categorization, ensuring that all aspects of a receipt are properly classified. This detailed categorization supports accurate financial tracking, tax compliance, and reporting, especially useful for businesses and personal finance management.

Example: A customer buys a meal at a restaurant and pays using their debit card. The receipt is generated with details including the merchant name, itemized purchases (e.g., “Burger,” “Fries,” “Soda”), prices, tax, and total amount. The AI categorization module processes this data and not only identifies the merchant as a dining establishment but also analyses the specific items bought. It categorizes the transaction under “Dining” based on both the merchant and the purchased items. This categorized information is then transmitted to the bank, where the customer's financial records are updated with the correct classification for easy reference, reporting, and budgeting.

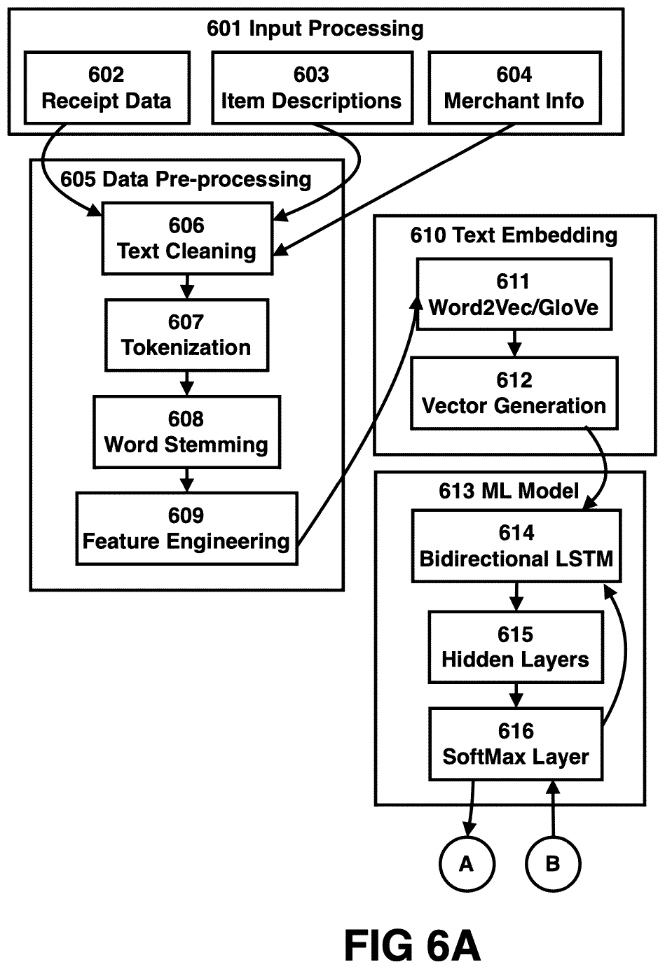

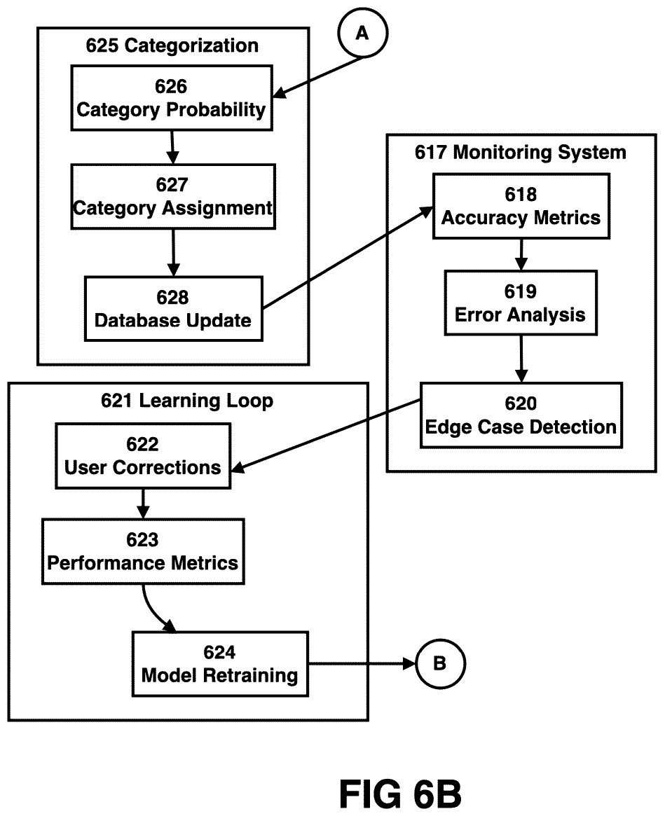

### DETAILED DESCRIPTION OF FIGS. 6A-6B

FIGS. 6A-6B illustrate the architecture of the Receipt Categorization Module, which employs sophisticated machine learning algorithms to automatically classify receipts into appropriate categories. This system is designed to streamline receipt organization by utilizing advanced computational techniques.

The Input Processing layer (601) forms the foundation of the categorization process. It receives Receipt Data (602) containing transaction details, Item Descriptions (603) for granular analysis, and Merchant Info (604) to provide contextual information for category assignment.

The Data Pre-processing stage (605) executes several sequential steps to prepare input data for analysis. Text Cleaning (606) normalizes and standardizes the data, Tokenization (607) breaks text into analyzable units, Word Stemming (608) reduces words to their base forms, and Feature Engineering (609) extracts relevant characteristics from the data.

The Text Embedding component (610) converts textual information into numerical representations. This involves the implementation of Word2Vec or GloVe (611) for semantic encoding, followed by Vector Generation (612) to create mathematical representations of the text.

The ML Model (613) processes the numerical data through a neural network architecture. A Bidirectional LSTM layer (614) handles sequential data processing, Hidden Layers (615) identify patterns within the data, and a SoftMax Layer (616) calculates probability distributions for category predictions.

The Monitoring System (617) ensures optimal model performance by tracking Accuracy Metrics (618), performing Error Analysis (619) to identify issues, and detecting anomalies through Edge Case Detection (620).

The Learning Loop (621) supports continuous improvement by incorporating User Corrections (622) as feedback, evaluating Performance Metrics (623), and conducting Model Retraining (624) to optimize accuracy and reliability over time.

The Categorization component (625) finalizes the process by calculating Category Probability (626), assigning a Category (627) based on the highest probability, and updating the Database (628) to maintain accurate records of categorized receipts.

This architecture implements the complete categorization workflow detailed in Section 2.4 of the patent, incorporating the Bidirectional LSTM network, word embeddings, and continuous learning mechanisms to ensure accurate and adaptive receipt categorization.

The system employs sophisticated machine learning techniques while maintaining a feedback loop for continuous improvement, ensuring that categorization accuracy increases over time through user corrections and automated retraining processes.

### FIG. 6 Description of Components

### 601: Input Processing

The Input Processing layer gathers key data inputs that form the foundation for receipt categorization. Receipt Data (602) includes raw transaction details, such as itemized purchases, prices, taxes, and payment methods, providing the base information necessary for pre-processing and semantic analysis. Item Descriptions (603) supply detailed information about purchased items, enabling granular categorization and helping to distinguish similar transactions based on specific content. Merchant Info (604) incorporates contextual details, such as merchant category, name, and location, which support context-aware classification by aligning transactions with merchant profiles.

### 605: Data Pre-processing

The pre-processing stage cleans and structures input data to prepare it for machine learning analysis. Text Cleaning (606) removes irrelevant characters, punctuation, and redundant information to normalize the data, ensuring clean text is ready for tokenization. Tokenization (607) breaks the text into smaller units, such as words or phrases, creating structured data for subsequent processing. Word Stemming (608) simplifies linguistic variations by reducing words to their root forms, such as converting “running” to “run,” ensuring uniformity in feature extraction. Finally, Feature Engineering (609) extracts relevant attributes, including product categories, merchant types, and transaction patterns, generating structured features that serve as input for text embedding.

### 610: Text Embedding

This component transforms text data into numerical representations suitable for machine learning. Word2Vec and GloVe (611) encode semantic relationships between words, creating embeddings that capture contextual meaning and produce vectors representing these relationships. These word embeddings are then processed during Vector Generation (612), which converts them into multi-dimensional vectors optimized for mathematical analysis. The resulting vectorized data is supplied to the ML Model for further processing and categorization.

### 613: ML Model

The ML Model utilizes a neural network architecture specifically designed for sequential data, enabling precise receipt categorization. The Bidirectional LSTM (614) processes sequential data in both forward and backward directions, capturing contextual dependencies within the text. The output from the LSTM layer is passed to the Hidden Layers (615), which identify complex patterns and relationships within the data. These patterns are then transmitted to the SoftMax Layer (616), which calculates the probability distribution across predefined categories and outputs the category with the highest probability for assignment.

### 625: Categorization

This component finalizes the classification process, ensuring accurate and systematic receipt categorization. The Category Probability module (626) calculates the likelihood of each category based on the outputs from the SoftMax layer, selecting the most probable category for assignment. The Category Assignment module (627) assigns the receipt to the category with the highest probability and updates the database accordingly. Finally, the Database Update module (628) records the categorized receipt, making it available for downstream applications such as bookkeeping or customer-facing systems, ensuring that the categorized data is accessible for future use.

### 617: Monitoring System

This system monitors the performance and accuracy of the categorization process, identifying areas for continuous improvement. Accuracy Metrics (618) measure categorization success rates to ensure consistent performance, flagging discrepancies for further analysis. Error Analysis (619) examines incorrect categorizations and identifies patterns that contribute to errors, feeding this data into the Learning Loop for refinement. Edge Case Detection (620) recognizes anomalies and uncommon transaction patterns, enhancing model robustness by addressing these edge cases and improving overall system reliability.

### 621: Learning Loop

The Learning Loop integrates feedback to improve the ML Model's accuracy and adaptability. User Corrections (622) are collected to address miscategorized receipts, enhancing the accuracy of future categorizations by updating the training data used for model retraining. Performance Metrics (623), including precision, recall, and F1 scores, are evaluated to assess system performance and identify areas for optimization. Model Retraining (624) utilizes the updated data and feedback to continuously refine the ML Model, deploying improved versions to the categorization pipeline for enhanced accuracy and reliability.

### 2.5. Secure Transmission Module

The secure transmission module facilitates the real-time delivery of digital receipts to the customer's bank, ensuring secure and reliable data transfer. It employs TLS 1.3 for end-to-end encryption and HTTPS for secure transport. The Transmission Protocol includes mutual TLS for server-to-server authentication and leverages public key infrastructure (PKI) to encrypt fields, such as the TUMI, before transmitting the receipt. For Error Handling, the module incorporates retry mechanisms and logging for failed transmissions, securely storing undelivered receipts and periodically retrying delivery until confirmation is received.

### 2.6. Bank Integration Module

This module ensures seamless interoperability with various banking systems, supporting multiple protocols such as ISO 20022 for payment messaging and MT940/MT942 for bank statement reconciliation. Its functionalities include mapping receipt fields to the corresponding bank transaction records and utilizing TUMI/UIN information to accurately route the receipt to the correct customer account, enabling efficient integration with diverse banking infrastructures.

### AI Integration

AI models optimize the matching and reconciliation of receipt data with bank transactions. This ensures that the receipt information corresponds accurately with the actual transactions recorded by the customer's bank.

### Backend Features

Data Handling and Pre-processing: The AI pre-processes incoming receipt and transaction data, ensuring that data from various banking systems is standardized. The AI handles normalization, missing fields, and data transformation.

Model Monitoring: The system logs and monitors any discrepancies between receipts and bank transactions, allowing the AI to learn and improve over time.

Scaling and Load Balancing: The system scales horizontally to handle peak transaction times, ensuring that multiple transactions can be processed and reconciled simultaneously without delay.

### Additional Details on External System Integration

To ensure seamless interoperability with external banking and bookkeeping systems, the system implements configurable mapping rules that standardize receipt data into the formats required by these systems. For instance, receipt fields are transformed into ISO 20022-compliant messages for bank reconciliation and into API-compatible structures for third-party accounting software such as QuickBooks or Xero. These mappings are established using a set of configurable transformation rules stored within the system. Feedback from integration processes—such as mismatches identified during bank transaction reconciliation or accounting record synchronization—is automatically captured. The system then employs the iterative retraining mechanism to refine these mapping rules, ensuring the transformation parameters are continuously updated based on actual integration performance. This dynamic adaptation minimizes manual adjustments and enhances overall system robustness.

### Training and Data Handling

The AI is trained on historical transaction-receipt pairs to learn patterns and resolve discrepancies. It continues to learn and improve as it processes more transactions.

Enhanced Iterative Data Augmentation and Retraining: To further optimize the matching accuracy between receipt data and bank transactions, an advanced iterative training process is implemented. In one embodiment, a set of historical reconciliation data is first collected from the database, comprising paired receipt and bank transaction records. One or more mathematical transformation functions are then applied to key identifiers and numerical fields—such as iteratively multiplying these values by a fixed factor—to generate modified data instances. A first training set is created by combining the original reconciliation data with these transformed instances. After training the neural network using this first training set, the system identifies any mismatches or false positives through detailed monitoring. These misclassified instances are then integrated with the original training set to form a second training set. The neural network is retrained using this expanded set, thereby refining its ability to reconcile receipt data with bank transactions. This iterative process continues until the model achieves or exceeds predefined accuracy thresholds for anomaly detection and data matching.

### Mathematical Behaviour

The AI applies unsupervised learning to identify anomalies in reconciliation and use supervised learning to optimize the matching of receipt fields to bank transactions.

### Practical Improvement

By automating the reconciliation process, this module ensures that receipts are accurately linked with bank transactions, reducing manual errors and improving the accuracy of financial records.

Data Matching and Reconciliation: AI models are used (e.g., clustering algorithms) to intelligently match receipt data to bank transactions, especially when identifiers are missing or ambiguous.

Handling Anomalies: AI automatically detects anomalies in data mappings and suggest corrections, minimizing manual oversight and reducing errors.

Adaptive Integration: ML models learn from past reconciliation patterns and improve their accuracy in matching receipts to banking records over time.

Example: A customer purchases a flight ticket using their debit card. The POS system generates a digital receipt and sends it to the bank. The AI compares the receipt data with the transaction recorded by the bank and ensures they match. If any discrepancies, such as different merchant names or transaction amounts, are detected, the AI resolves them by learning from previous patterns and matching the correct details.

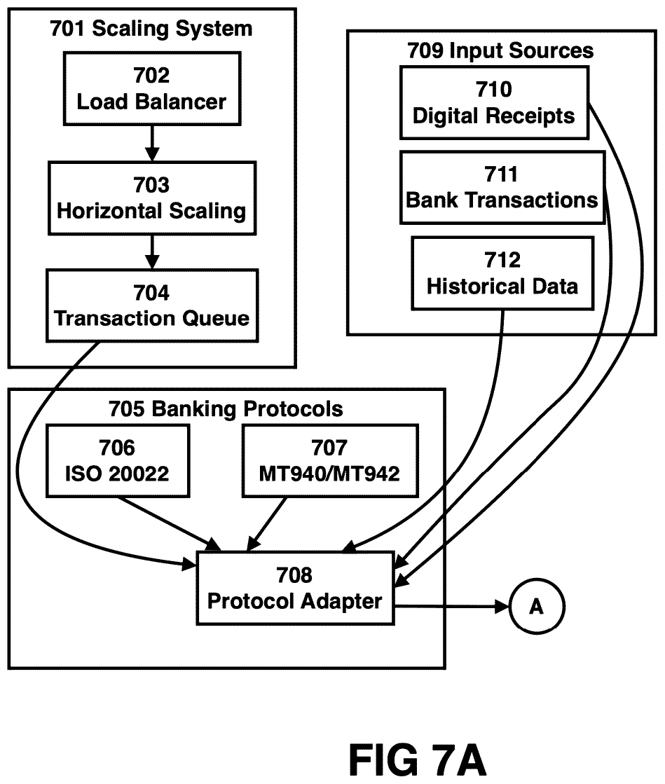

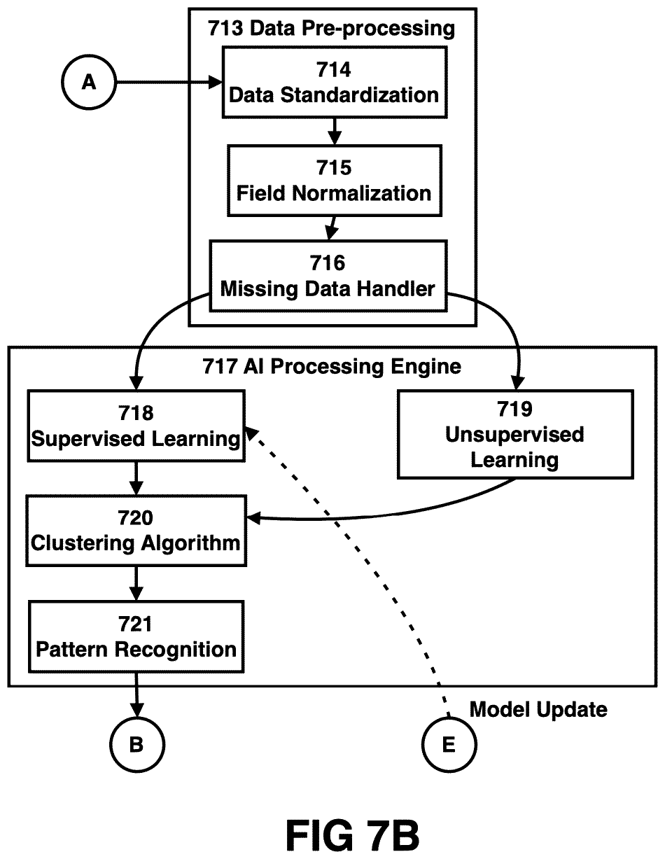

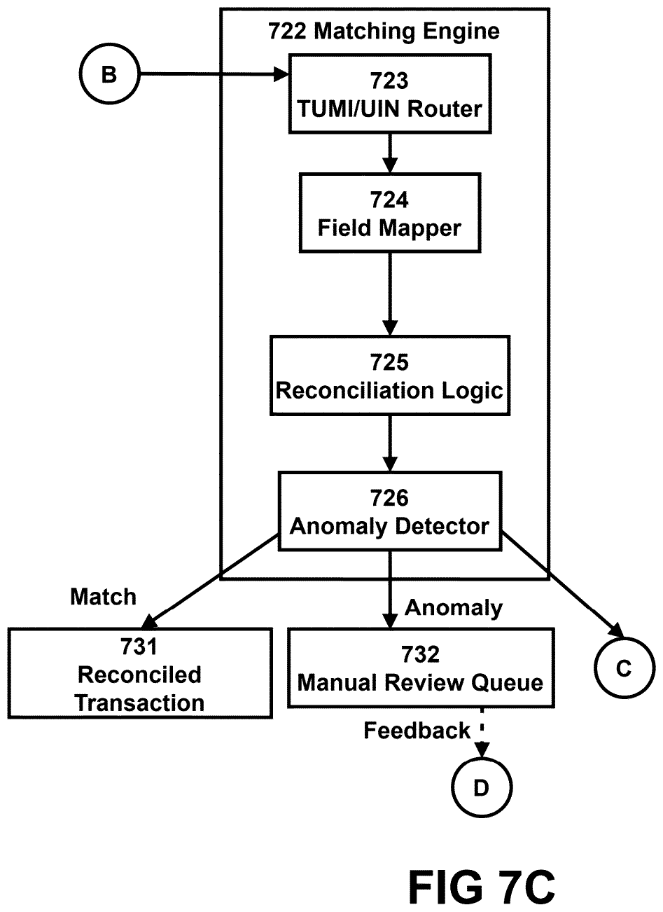

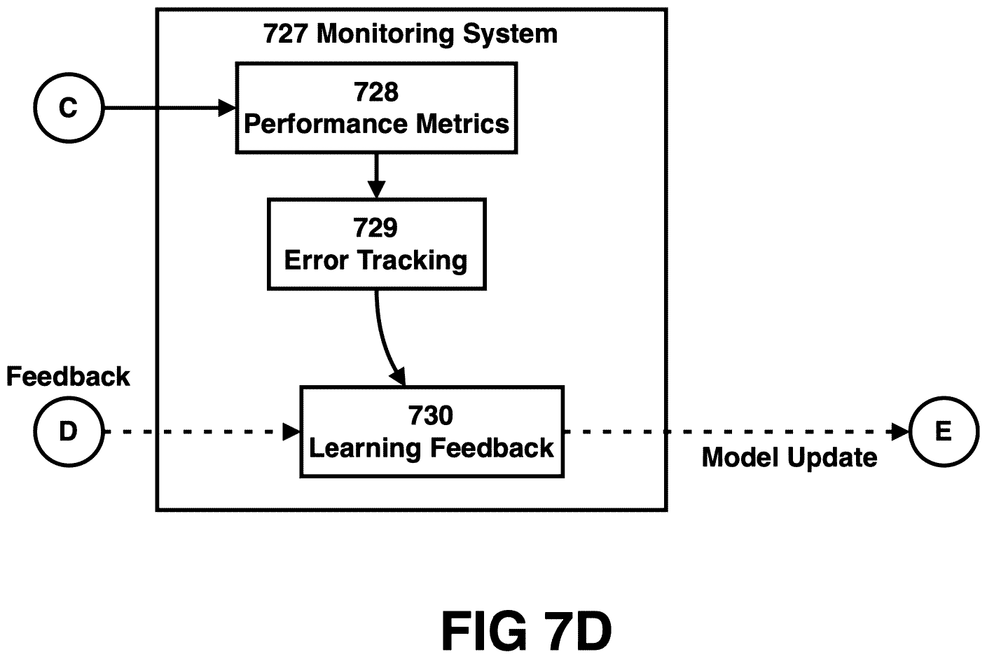

### DETAILED DESCRIPTION OF FIGS. 7A-7D

FIGS. 7A-7D illustrate the Bank Integration Module's architecture, which is designed to facilitate the secure and efficient matching of digital receipts with banking transactions. It ensures interoperability with various banking protocols while maintaining scalability to handle high transaction volumes. The system comprises multiple specialized components organized in a hierarchical flow.

The Scaling System (701) addresses high transaction volumes through key functionalities. The Load Balancer (702) efficiently distributes incoming traffic across the system. Horizontal Scaling (703) dynamically expands system capacity as transaction loads increase. The Transaction Queue (704) organizes incoming data for ordered processing and feeds this data into the Protocol Adapter.

The Banking Protocols section (705) ensures standardized communication with banking systems. It supports ISO 20022 (706) and handles MT940/MT942 message formats (707) to maintain compatibility across diverse protocols. The Protocol Adapter (708) acts as a bridge, receiving input from the Transaction Queue and adapting it for communication with banking protocols.

Input Sources (709) gather data from various channels to support the integration process. Digital Receipts (710), Bank Transactions (711), and Historical Data (712) provide comprehensive inputs for matching and analysis, ensuring accuracy and consistency in reconciliation.

The Data Pre-processing component (713) standardizes and prepares input data for AI analysis. This involves Data Standardization (714) to ensure format consistency, Field Normalization (715) for uniformity, and the Missing Data Handler (716) to address incomplete datasets before they proceed to the AI Processing Engine.

The AI Processing Engine (717) employs both Supervised Learning (718) for recognizing known patterns and Unsupervised Learning (719) for identifying new patterns. These learning systems feed into the Clustering Algorithm (720), which groups transactions, and the Pattern Recognition module (721), which identifies relationships within the data.

The Matching Engine (722) performs the task of transaction reconciliation. The TUMI/UIN Router (723) directs payment card data to appropriate systems, while the Field Mapper (724) aligns data fields for matching. The Reconciliation Logic (725) matches transactions, and the Anomaly Detector (726) identifies discrepancies that may require further review.

The Monitoring System (727) ensures the reliability and performance of the Bank Integration Module. Performance Metrics (728) track the system's efficiency, Error Tracking (729) identifies issues, and Learning Feedback (730) provides insights for continuous improvement.

The system generates two types of outputs: Reconciled Transactions (731) for items successfully matched and a Manual Review Queue (732) for anomalous cases that require human intervention. This comprehensive architecture ensures secure, efficient, and scalable integration of banking transactions with digital receipts.

A continuous feedback loop is maintained where the Learning Feedback component provides Model Updates to the Supervised Learning system, and the Manual Review Queue provides Feedback to enhance system accuracy over time.

This architecture implements the complete bank integration workflow detailed in Section 2.6 of the patent, incorporating ISO 20022 and MT940/MT942 protocols while maintaining secure and efficient transaction processing and reconciliation capabilities. The system's design ensures scalability, reliability, and continuous improvement through its integrated feedback mechanisms.

### FIG. 7 Description of Components

### 701: Scaling System

The Scaling System ensures that the system maintains optimal performance and efficiently handles high transaction volumes without degradation. The Load Balancer (702) plays a key role in distributing incoming transaction requests evenly across available servers. This approach prevents bottlenecks and ensures optimal resource utilization, allowing for a balanced workload distribution throughout the system. Horizontal Scaling (703) dynamically provisions additional computational resources as transaction volumes increase. This functionality provides real-time scalability, enabling the system to adjust to fluctuating demands seamlessly. The Transaction Queue (704) organizes incoming transactions into a sequential queue for efficient processing. It ensures that transactions are systematically fed into the Protocol Adapter (708), streamlining the flow of data for downstream handling and maintaining order within the system's operations.

### 705: Banking Protocols

This component ensures seamless interoperability with banking systems by supporting multiple communication standards, thereby facilitating efficient and standardized data exchange. ISO 20022 (706) is employed to process standardized XML-based payment messages, widely used in global banking systems. This enables seamless data exchange with modern banking infrastructures, ensuring compatibility with the latest industry standards. MT940/MT942 (707) provides support for legacy SWIFT message formats used for bank statement reconciliation. This functionality ensures continued compatibility with older banking infrastructures, making the system versatile across different banking environments. The Protocol Adapter (708) plays a pivotal role by converting transaction data into formats compatible with specific banking protocols. Acting as a bridge between the transaction queue (704) and banking systems, it ensures that data is correctly formatted and transmitted to meet the requirements of various banking protocols.

### 709: Input Sources

The Input Sources deliver essential data streams for accurate transaction matching and reconciliation, forming the foundation for the system's functionality. Digital Receipts (710) supply itemized transaction details that facilitate precise alignment with bank records. By providing detailed purchase information, these receipts ensure that the reconciliation process accounts for all transaction specifics accurately. Bank Transactions (711) contribute transaction logs and payment details sourced directly from banking systems. These logs serve as the primary reference points for matching with the corresponding digital receipt data, ensuring consistency and reliability. Historical Data (712) offers contextual information to support anomaly detection and pattern recognition. By leveraging past transaction patterns, this data enhances the AI Processing Engine's ability to accurately identify discrepancies and maintain robust reconciliation processes.

### 713: Data Pre-processing

This component ensures that transaction data is consistently formatted and complete, enabling accurate analysis and processing downstream. Data Standardization (714) converts input data into uniform formats across all sources. By eliminating formatting discrepancies, it facilitates seamless integration and compatibility for subsequent stages of the processing pipeline. Field Normalization (715) aligns data fields, including merchant names, transaction IDs, and timestamps. This step ensures consistency in data interpretation, making it easier to compare and analyze information across different data sources. Missing Data Handler (716) addresses gaps in the input data by estimating missing values or introducing placeholders. By filling these gaps, the system prevents incomplete data from disrupting the AI-driven analysis, ensuring robust and reliable processing.

### 717: AI Processing Engine

The AI Processing Engine applies machine learning to analyze transaction data and identify relationships. Supervised Learning (718) is employed to train on labelled data, enabling the system to recognize known patterns. This facilitates the identification of straightforward matches between digital receipts and corresponding bank transactions, ensuring efficient and accurate reconciliation for routine scenarios. Unsupervised Learning (719) complements this approach by detecting hidden patterns and clusters within the data that do not have prior labels. This capability is particularly valuable for discovering anomalies and uncovering relationships that are not immediately evident, enhancing the system's ability to adapt to novel transaction types or irregularities. The Clustering Algorithm (720) organizes similar transactions into logical groups, which streamlines the reconciliation process by reducing redundant comparisons and focusing on meaningful associations. These clusters are then processed by the Pattern Recognition (721) component, which analyzes various transaction attributes such as timestamps, amounts, and merchant identifiers to define precise matching criteria. The insights generated by this pattern analysis are passed to the Matching Engine (722), where they are utilized to ensure accurate alignment and validation of transaction data within the broader reconciliation workflow.

### 722: Matching Engine

This component performs the core task of reconciling receipts with bank transactions, ensuring alignment between financial records and purchase details. The TUMI/UIN Router (723) plays a role by routing transactions based on card details such as the Transaction-Unique Metadata Identifier (TUMI) or Unique Identifier Number (UIN), ensuring 1-to-1 matching without exposing sensitive card numbers. This routing enables precise matching of receipt data with the corresponding bank transactions, streamlining the reconciliation process. The Field Mapper (724) is responsible for aligning receipt fields with their corresponding bank transaction fields. This alignment ensures that the data is formatted and prepared for the Reconciliation Logic (725), which undertakes the task of matching receipts with transactions. By comparing attributes such as transaction amounts, dates, and merchant details, the reconciliation logic determines accurate matches or identifies discrepancies for further analysis. To enhance the robustness of the system, the Anomaly Detector (726) monitors for mismatches or unusual patterns in transaction data. When irregularities are detected, these anomalies are flagged for manual review, ensuring that the system maintains high accuracy and reliability even in the presence of atypical transaction behavior. This integrated workflow facilitates comprehensive and efficient reconciliation while addressing potential discrepancies proactively.

### 727: Monitoring System

The Monitoring System is designed to ensure ongoing performance optimization and effective error management throughout the reconciliation process. Performance Metrics (728) are tracked to evaluate system efficiency, accuracy, and processing speed. This tracking provides critical data that aids in capacity planning and system optimization, ensuring the platform can handle varying transaction volumes while maintaining high performance. Error Tracking (729) plays a pivotal role in identifying and categorizing issues that arise during transaction reconciliation. By logging these errors systematically, the system generates actionable insights that can be used to refine and improve the underlying AI models, addressing root causes and minimizing the recurrence of issues. To facilitate continuous improvement, the system integrates a Learning Feedback (730) loop. This component utilizes performance data and user feedback to update the AI Processing Engine, ensuring that the models evolve and adapt to new patterns and challenges. By leveraging these feedback mechanisms, the Monitoring System drives ongoing enhancements, improving both accuracy and system resilience over time.

### Outputs

The system produces two primary outputs to ensure comprehensive transaction reconciliation and effective handling of discrepancies. The first output, Reconciled Transaction (731), comprises successfully matched receipts and corresponding transactions. These reconciliations are seamlessly integrated into banking records or financial systems, ensuring that all data is accurately updated and ready for downstream applications, such as financial reporting or compliance checks. The second output is the Manual Review Queue (732), which captures flagged anomalies or mismatches that require human intervention. This queue routes these discrepancies to human operators for detailed review and resolution. Furthermore, insights gained from this manual process feed back into the system, enhancing its learning and improving the accuracy and efficiency of future reconciliations.

### 2.7. Bookkeeping Integration Module

The bookkeeping module facilitates seamless integration with third-party accounting software, such as QuickBooks and Xero, through the use of dedicated APIs provided by these platforms. This module ensures that categorized receipts are efficiently forwarded to the accounting systems, streamlining financial record-keeping for businesses. The module employs mapping and reconciliation mechanisms to match incoming transaction data with existing accounting records. By leveraging receipt categorization and merchant identification, it accurately aligns transactions with their respective ledger entries. Additionally, automatic reconciliation algorithms are employed to suggest appropriate ledger classifications and highlight any discrepancies, enabling timely adjustments and enhancing overall financial accuracy.

### AI Integration

AI assists in automating the bookkeeping process by predicting which transactions should be matched to specific accounting categories based on historical data.

### Backend Features

Model Training and Optimization: The AI is optimized using AutoML techniques, ensuring the best models are selected for categorizing financial transactions.

Real-Time Data Processing: The AI categorizes receipts in real time, immediately updating financial records.

Security and Privacy: The backend enforces data encryption and role-based access control (RBAC) to ensure secure handling of bookkeeping data.

### Training and Data Handling

The system is rained on historical bookkeeping data, enabling it to categorize transactions automatically. It continuously improves based on feedback and adjustments.

Enhanced Iterative Data Augmentation and Retraining: To further enhance the accuracy and reliability of the AI-assisted bookkeeping process, an advanced iterative training mechanism is implemented. In one embodiment, historical bookkeeping data is collected from integrated accounting records, comprising transaction details and their corresponding ledger entries. Controlled transformation functions are applied to key data attributes—such as minor perturbations in transaction amounts, modifications in ledger code representations, or iterative scaling of numerical values—to generate synthetic variations of the original data. A first training set is then formed by combining the original bookkeeping data with these augmented instances. Following the initial training phase, the AI model's outputs are evaluated to identify any mismatches between predicted ledger classifications and the established ledger entries. These misclassified instances are merged with the original training set to form a refined, second-stage training dataset. The AI model is retrained on this enhanced dataset, progressively improving its ability to accurately map receipt data to corresponding ledger entries and reconcile transactions. This iterative process continues until the model achieves or surpasses predetermined performance benchmarks for predictive accuracy and anomaly detection in bookkeeping tasks.

### Mathematical Behaviour

The AI uses decision tree models or random forest algorithms to predict which category a transaction belongs to, based on transaction attributes such as amount, merchant, and type.

### Practical Improvement

The automated bookkeeping feature reduces the need for manual reconciliation, streamlining financial reporting and ensuring accuracy.

Smart Reconciliation: AI models suggest appropriate ledger entries and provide context-sensitive recommendations for bookkeeping, reducing the effort required by accountants.

Predictive Tagging: Based on previous categorizations, AI predicts and suggest bookkeeping categories, improving efficiency.

Fraud Detection: AI identifies patterns in bookkeeping data that indicate possible fraud or discrepancies.

Example: A business purchases office supplies, and the AI-powered bookkeeping integration module automatically categorizes the transaction as “Office Supplies.” This categorization is then synced with the company's bookkeeping system, reducing the need for manual input by accountants.

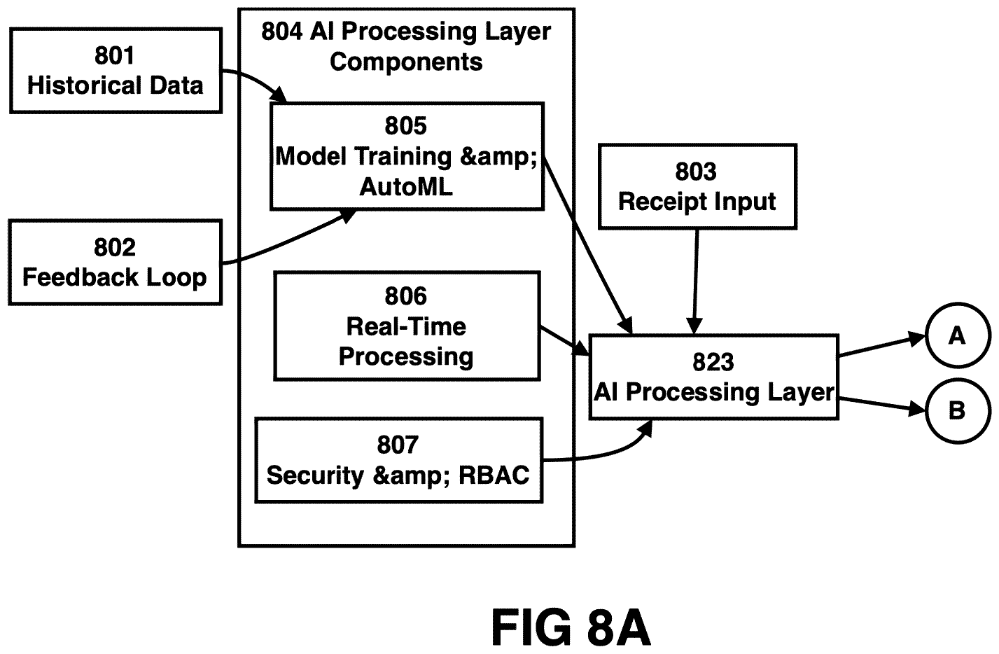

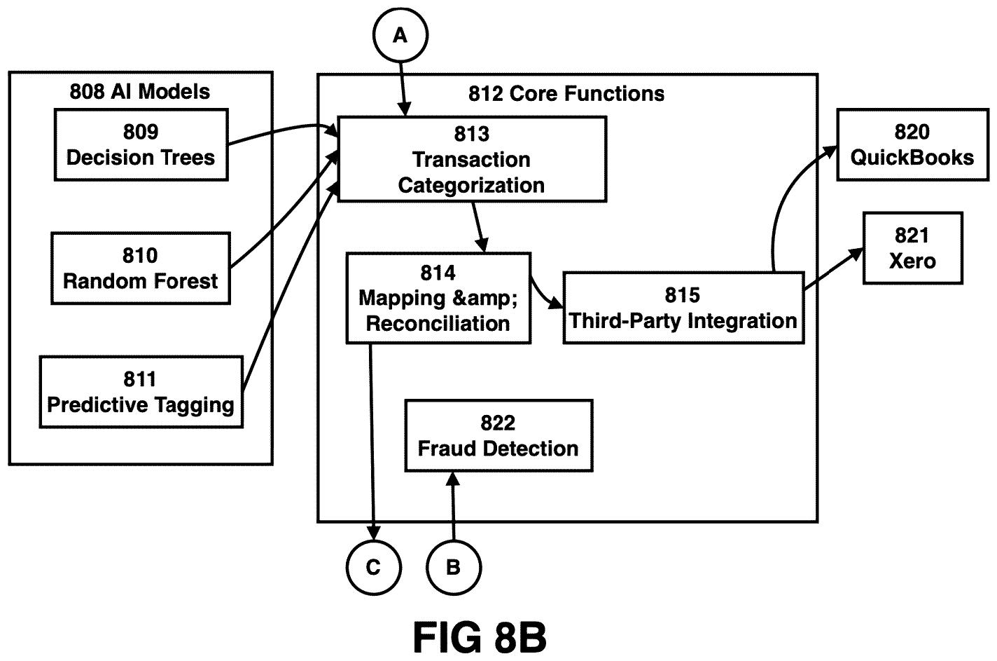

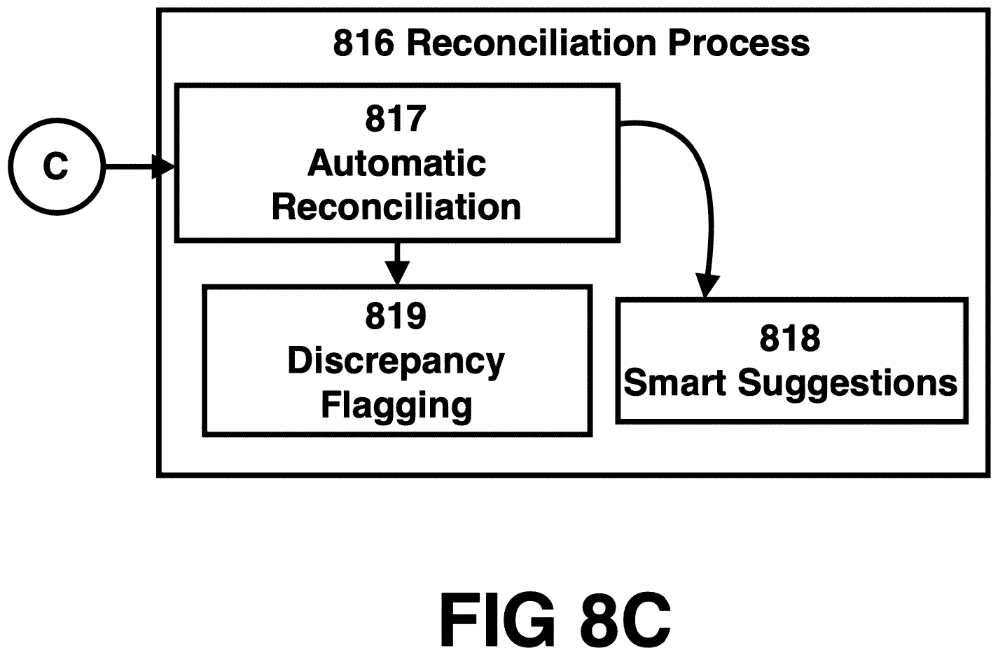

### DETAILED DESCRIPTION OF FIG. 8A-8C

FIGS. 8A-8C illustrate the architecture of the Bookkeeping Integration Module, which automates the categorization and reconciliation of financial transactions with third-party accounting software systems. This module ensures efficient integration while maintaining high levels of security and incorporating fraud detection measures.

The system processes inputs from three primary sources: historical data (801) used for model training and refinement, a feedback loop (802) that drives continuous improvement, and receipt input (803) that enables real-time transaction processing. These sources provide a robust foundation for both real-time and learning-based operations.

At the heart of the system, the AI Processing Layer Components (804) include essential functionalities such as model training and AutoML (805), which utilize historical data and user feedback for enhancing predictive capabilities. The Real-Time Processing module (806) ensures immediate handling of transactions, while the Security & Role-Based Access Control (RBAC) system (807) guarantees secure and authorized access to sensitive financial data.

The central AI Processing Layer (823) acts as the intelligence hub, orchestrating all AI-driven operations. It integrates inputs from the various processing components, enabling seamless coordination and execution of tasks.

The AI Models component (808) employs multiple algorithms to achieve precise and efficient categorization and reconciliation. Decision Trees (809) facilitate hierarchical classification, Random Forest (810) ensures robust categorization across diverse datasets, and Predictive Tagging (811) enables automated labeling of transactions based on patterns and prior data.

Core functions of the system (812) include transaction categorization (813) powered by AI models to classify transactions accurately. The Mapping & Reconciliation module (814) matches transactions with corresponding financial records, while Third-Party Integration (815) connects the system with external platforms. Fraud Detection (822) actively monitors transaction data to identify and flag suspicious activities.

The Reconciliation Process (816) includes Automatic Reconciliation (817) that matches transactions with minimal user input, Smart Suggestions (818) that assist users in resolving ambiguities, and Discrepancy Flagging (819) to detect and highlight errors for further review.

The system seamlessly integrates with major accounting platforms, including QuickBooks (820) for enterprise-level accounting and Xero (821) for small business bookkeeping. This comprehensive integration enables businesses to maintain accurate, up-to-date financial records with reduced manual effort and enhanced security.

This architecture implements the complete bookkeeping integration workflow detailed in Section 2.7 of the patent, employing AutoML techniques for model optimization and maintaining secure integration with third-party accounting systems. The centralized AI Processing Layer ensures coordinated processing of all AI operations, while the fraud detection component provides additional security measures. The system's design enables automated categorization and reconciliation through continuous learning and real-time processing, reducing the need for manual intervention while maintaining high accuracy in financial record-keeping.

### FIG. 8 Description of Components

### 801: Historical Data

Historical data forms the foundational dataset used for training machine learning models and uncovering patterns over time. This component aggregates past transactions, categorizations, and reconciliations, providing a comprehensive dataset that serves as input for training AI algorithms. Integration is achieved by feeding this historical dataset into the Model Training & AutoML component (805), enabling the creation of accurate and robust predictive models that improve the system's ability to process and reconcile transactions efficiently.

### 802: Feedback Loop

The feedback loop is designed to continuously enhance the system by integrating user corrections and operational performance metrics. It works by capturing feedback from identified discrepancies and suggestions generated by the system, which are then utilized to update AI models. This iterative process is integrated with the Model Training component (805) and the AI Processing Layer (823), ensuring ongoing refinement and improvement of system accuracy and efficiency.

### 803: Receipt Input

This component functions as the system's entry point for real-time transaction processing. It operates by receiving itemized receipt data from various digital sources, including payment systems and POS terminals. This live data is then integrated into the Real-Time Processing unit (806) to ensure immediate and accurate transaction handling.

### 804: AI Processing Layer Components

The AI Processing Layer comprises three subsystems. The Model Training & AutoML component (805) operates by automatically training and optimizing machine learning models using historical data and user feedback. This subsystem continuously refines the models employed in transaction categorization, fraud detection, and predictive tagging. The Real-Time Processing subsystem (806) handles transactions in real time, applying the trained AI models for immediate categorization and reconciliation, with results fed directly to the Core Functions (812). Lastly, the Security & RBAC subsystem (807) ensures secure role-based access control (RBAC) and data encryption, safeguarding sensitive transaction data throughout the system.

### 808: AI Models

The AI Models layer implements advanced algorithms to automate transaction handling and classification. Decision Trees (809) hierarchically classify transactions based on attributes such as merchant, category, or transaction details, generating initial categorizations for refinement by other models. Random Forest (810) enhances accuracy and robustness by aggregating multiple decision trees, delivering high-confidence classifications for mapping and reconciliation processes. Predictive Tagging (811) complements these models by automatically assigning labels to transactions, leveraging historical trends and real-time insights. The labelled data produced by Predictive Tagging is then passed to the Categorization function (813) for further processing.

### 812: Core Functions

The core functions are responsible for executing workflows related to transaction categorization, reconciliation, and integration. Transaction Categorization (813) utilizes AI models to classify transactions into predefined categories, such as “Groceries” or “Utilities,” and provides this categorized data to the Mapping & Reconciliation module (814). The Mapping & Reconciliation (814) component matches transactions with ledger entries or banking records, employing reconciliation logic to output reconciled transactions to accounting platforms while flagging anomalies when necessary. Third-Party Integration (815) connects the system to external accounting software platforms such as QuickBooks (820) and Xero (821), facilitating seamless synchronization of categorized and reconciled data. Additionally, Fraud Detection (822) enhances system security by employing clustering and anomaly detection techniques to identify irregular or suspicious patterns in transactions, flagging potential fraud for further investigation within the Reconciliation Process (816).

### 816: Reconciliation Process

The reconciliation process is designed to accurately match transactions while efficiently addressing discrepancies. Automatic Reconciliation (817) applies predefined rules and AI-generated suggestions to match transactions with corresponding records, significantly reducing manual effort by resolving straightforward cases automatically. Smart Suggestions (818) offer actionable recommendations to users for resolving more complex discrepancies, leveraging AI insights to facilitate a semi-automated reconciliation process. Discrepancy Flagging (819) identifies mismatches or missing data that require manual review, ensuring that unresolved cases are appropriately escalated to the Manual Review Queue for further investigation.

### Third-Party Integration

The system interfaces with major accounting platforms to enable seamless data exchange and comprehensive reporting. QuickBooks (820) facilitates enterprise-level accounting by syncing reconciled and categorized transactions, ensuring automated ledger updates and streamlined reporting capabilities. Xero (821) supports small business bookkeeping and financial management by updating its records with categorized and reconciled data, enhancing financial accuracy and efficiency for smaller organizations.

### 823: AI Processing Layer

This centralized layer orchestrates all AI-driven operations, acting as the system's intelligence hub by dynamically applying AI models to both live and historical data. It coordinates model execution, transaction categorization, and fraud detection to ensure comprehensive functionality. By seamlessly connecting all upstream and downstream components, this layer facilitates efficient and synchronized operation across the entire system.

### 2.8 Rewards Management Module

The Rewards Management Module dynamically attaches personalized rewards, offers, or vouchers to digital receipts, tailored based on customer behaviour, historical purchase data, and merchant preferences. Once the receipt and reward are transmitted to the customer's banking app, the reward can be accessed directly in the app or saved to the customer's mobile wallet (e.g., Apple Wallet or Google Wallet) for convenient future use.

### Personalization Engine

AI-Driven Recommendation: Utilizes collaborative filtering and content-based filtering models to predict customer preferences and identify the most engaging rewards for each customer based on historical purchase patterns and merchant-specific data.

Dynamic Reward Generation: Generates personalized discount codes, loyalty points, or vouchers that are attached to the receipt in real time at the POS. For example, the system may offer a “10% off next purchase” voucher for a customer who frequently shops at a specific store.

Reinforcement Learning: Applies multi-armed bandit algorithms to continually test and optimize reward offers, ensuring they align with customer preferences and enhance engagement.

### Integration with Mobile Banking Apps and Wallets

Centralized Display: Rewards and vouchers are displayed alongside transaction details within the customer's banking app, with an option to view them in a dedicated Rewards Page for easy access.

Mobile Wallet Compatibility: Allows customers to save rewards directly to Apple Wallet or Google Wallet, where they can view and redeem them conveniently on return visits to the store.

Real-Time Tracking and Analytics: Tracks the redemption status of each reward, providing merchants with real-time feedback on engagement metrics, such as redemption rates and customer responses to offers. This data informs merchants about the effectiveness of rewards and helps optimize future offers.

AI Integration:

The Rewards Management Module leverages AI to analyse customer transaction history, merchant preferences, and purchasing behaviours to deliver personalized rewards and offers. The module allows merchants to attach customized rewards or vouchers directly to the digital receipt generated at the POS. Once transmitted to the customer's banking app, the reward can be viewed alongside the receipt or added directly to the customer's preferred mobile wallet (e.g., Apple Wallet or Google Wallet) for easy access and future redemption.

### Backend Features

Data Handling and Pre-processing: The AI pre-processes customer transaction histories and preferences, creating feature sets for reward personalization. It analyzes the merchant's past offers, customer response rates, and the type of items purchased to create relevant reward options.

Reward Attachment to Receipt: The POS system, upon generating a receipt, attaches a reward or voucher customized by the merchant. This reward is digitally linked to the receipt, enabling it to be transmitted securely along with the transaction data.

Mobile Wallet Compatibility: The rewards are formatted to be compatible with mobile wallet standards (e.g., PassKit for Apple Wallet and Google Pay API for Google Wallet). The customer can choose to save the reward directly to their wallet, ensuring it's readily accessible and usable upon return to the store.

Model Serving and Deployment: The AI models responsible for analysing and personalizing rewards are containerized for scalable deployment, enabling easy updates and expansion as customer data and merchant preferences evolve. Experiment tracking and version control help the AI refine reward strategies based on user engagement.

### Training and Data Handling

The AI is trained on datasets comprising historical transaction data, customer preferences, and reward redemption behaviours. This training enables it to suggest optimal rewards for each transaction, increasing the likelihood of customer engagement. The AI learns from previous reward interactions, continuously improving its personalization accuracy.

The system incorporates reinforcement learning to dynamically adjust offers based on user feedback, optimizing rewards to match customers'purchasing patterns and merchant-specific goals.

Enhanced Iterative Data Augmentation and Retraining: To further enhance the precision and personalization of reward offers, an advanced iterative training mechanism is implemented. In one embodiment, historical data comprising reward issuance, redemption behaviours, customer transaction histories, and merchant preferences is collected from the system's databases. Controlled transformation functions are applied to key data attributes—such as minor perturbations in reward percentages, slight adjustments in redemption timeframes, or iterative scaling of reward amounts—to generate synthetic variations of the original dataset. A first training set is created by combining the original data with these augmented instances. After the initial training phase, the AI model's performance is evaluated to identify mis-predicted or suboptimal reward assignments. These underperforming cases are then merged with the original training set to form a refined, second-stage training dataset. The AI model is retrained using this enhanced dataset, and the iterative process is repeated until key performance metrics (such as reward redemption prediction accuracy, customer engagement, and offer effectiveness) consistently meet or exceed predetermined thresholds.

### Mathematical Behaviour

The AI uses collaborative filtering and content-based filtering models to identify reward types most likely to engage individual customers. A matrix factorization approach predicts which rewards resonate best with specific customer segments based on historical data.

For personalized targeting, the AI applies a SoftMax function to convert preference scores into probabilities, assigning the highest probability reward for each transaction. It also uses multi-armed bandit algorithms to dynamically test reward effectiveness and refine choices based on immediate customer feedback and past redemption rates.

### Practical Improvement

The Rewards Management Module not only personalizes offers but also provides customers with added convenience by allowing them to save rewards directly to their mobile wallets. This functionality encourages repeat visits to the merchant, enhances customer satisfaction, and increases engagement by ensuring rewards are easily accessible and redeemable.

Personalization: Use of AI models like collaborative filtering or deep learning models for recommendation systems generate personalized rewards, making the offers more relevant and effective.

Dynamic Adjustments: AI dynamically adjusts offers based on real-time purchase behaviour and previous reward redemptions, improving customer satisfaction and engagement.

Predictive Analytics: AI predicts which rewards are most likely to be redeemed, allowing businesses to optimize their promotional spending and increase ROI.

Example: A customer buys a pair of sneakers at a retail store. As the digital receipt is generated, the POS system attaches a “10% off next purchase” voucher to the receipt. This receipt, along with the attached voucher, is transmitted to the customer's banking app, where the customer can view it alongside their transaction details. The customer has the option to save the voucher directly to their Apple Wallet or Google Wallet for convenient access on their phone. When the customer returns to the store, they can simply present the voucher from their mobile wallet, making redemption seamless and encouraging repeat business.

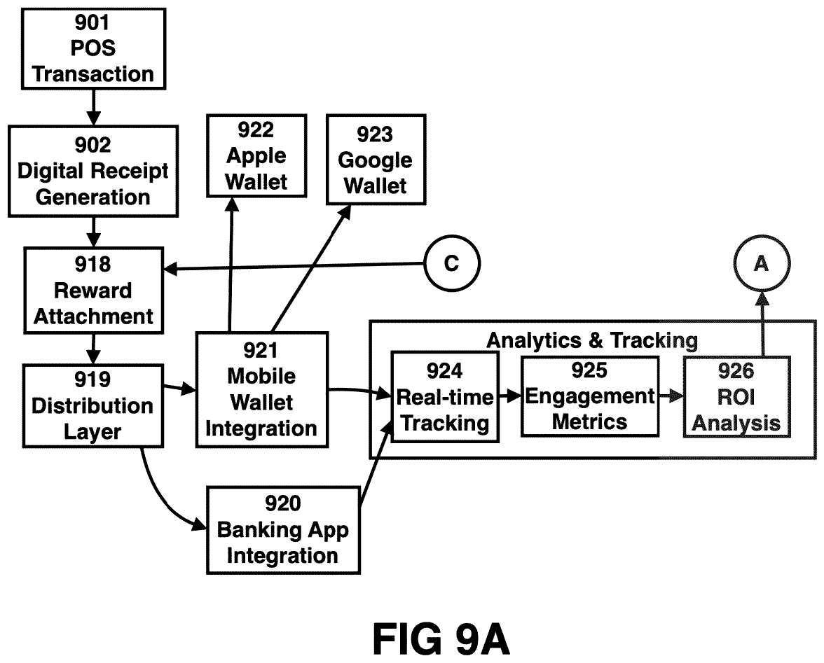

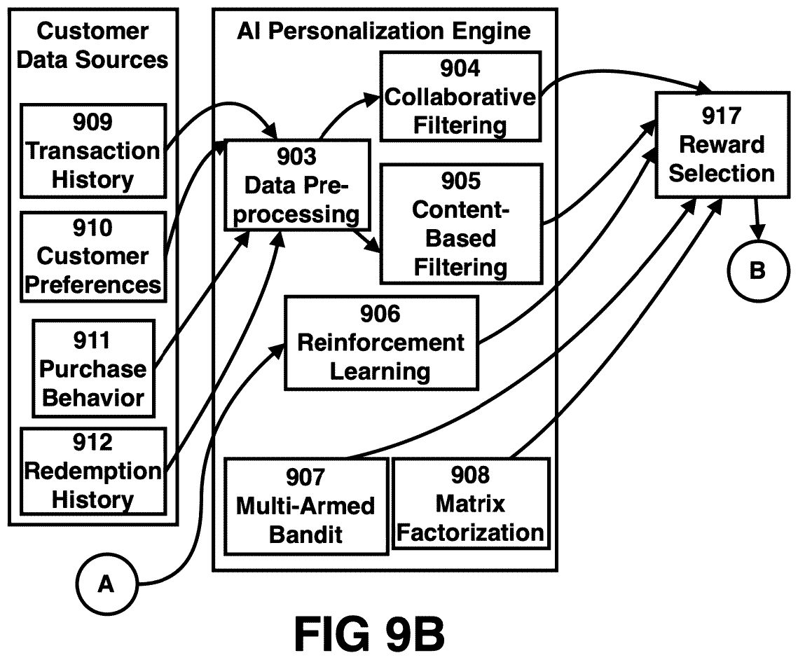

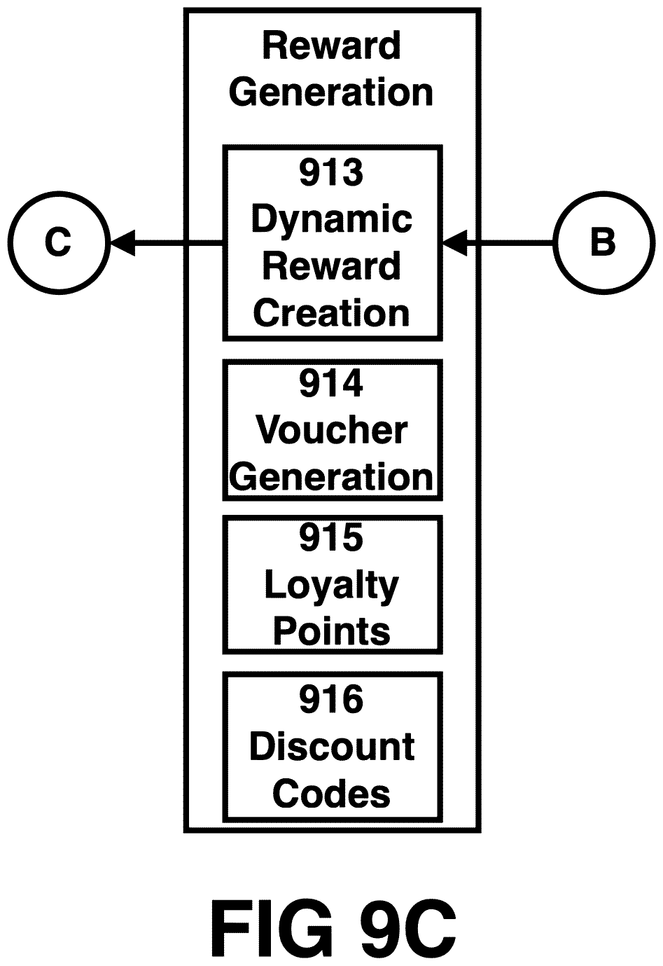

### DETAILED DESCRIPTION OF FIGS. 9A-9C

FIGS. 9A-9C illustrate the detailed architecture of the Rewards Management Module, which employs an AI-driven system for generating and distributing personalized rewards based on customer transaction data, as described in Section 2.8 of the patent document. This module integrates advanced machine learning techniques to analyze customer behavior and deliver highly targeted rewards.

The process initiates with a POS Transaction (901) that generates a Digital Receipt (902). Concurrently, data is gathered from multiple Customer Data Sources, including Transaction History (909) of past purchases, Customer Preferences (910) for personalization, Purchase Behavior (911) patterns, and Redemption History (912) to track reward effectiveness. This comprehensive data collection ensures the personalization engine has robust and relevant inputs for decision-making.

The AI Personalization Engine processes this data through several sophisticated components. Data Pre-processing (903) normalizes and structures input data, while Collaborative Filtering (904) identifies patterns across customer segments. Content-Based Filtering (905) focuses on analyzing individual preferences. Reinforcement Learning (906) optimizes reward strategies by adapting to customer behaviors, and the Multi-Armed Bandit (907) technique tests and refines reward offerings in real-time. Matrix Factorization (908) further enhances the system by predicting customer preferences based on historical and behavioral data.

The Reward Selection component (917) aggregates inputs from all AI models to determine the most suitable rewards for each customer. The Reward Generation process then creates tailored offerings, including Dynamic Reward Creation (913), Voucher Generation (914), Loyalty Points (915), and Discount Codes (916). These personalized rewards are crafted to maximize customer engagement and satisfaction.

In the Reward Attachment process (918), the generated rewards are combined with digital receipts and forwarded to the Distribution Layer (919). This layer ensures seamless routing of rewards to Banking App Integration (920) for direct banking access and Mobile Wallet Integration (921), supporting both Apple Wallet (922) and Google Wallet (923). These integrations provide customers with convenient access to their rewards.

Finally, the Analytics & Tracking system monitors the performance of the rewards program. Real-time Tracking (924) captures reward usage, while Engagement Metrics (925) measure customer responses. ROI Analysis (926) evaluates the overall effectiveness of the program, providing insights for further optimization. This comprehensive approach ensures that the rewards management system remains effective, adaptive, and customer focused.

A continuous feedback loop is maintained where ROI analysis informs the Reinforcement Learning component, enabling dynamic optimization of reward strategies based on actual performance data.

This architecture implements the complete rewards management workflow detailed in Section 2.8 of the patent, incorporating sophisticated AI models for personalization while ensuring convenient reward delivery through mobile wallet integration. The system's design enables real-time reward generation and distribution while maintaining comprehensive analytics for continuous optimization.

### FIG. 9 Description of Components

### 901: POS Transaction

The process initiates with a transaction at a point-of-sale (POS) terminal, generating the foundational data required for reward processing. This step captures essential transaction details, including items purchased, merchant information, and payment method. The data collected during the POS transaction triggers the creation of a Digital Receipt (902), which serves as the primary input for the Rewards Management Module, enabling subsequent personalization and reward generation processes.

### Customer Data Sources

The system aggregates multiple data streams to inform reward personalization by utilizing transaction history, customer preferences, purchase behavior, and redemption history. Transaction History (909) tracks previous purchases to identify recurring patterns and preferred product categories, providing historical context to enhance personalization. Customer Preferences (910) captures customer-specified preferences such as favored rewards, brands, or categories, directly influencing the selection and prioritization of rewards. Purchase Behavior (911) analyzes behavioral trends, including the frequency of purchases and spending patterns, which helps predict future purchases for proactive reward offerings. Redemption History (912) tracks past reward redemptions to assess customer engagement and the effectiveness of rewards, feeding this data into the ROI analysis and reinforcement learning loop to continually refine the system.

### 903-908: AI Personalization Engine

The AI Personalization Engine processes data from customer sources and applies advanced algorithms to determine the most effective rewards by leveraging a multi-step approach. Data Pre-processing (903) normalizes, cleans, and structures input data, ensuring compatibility with AI models and supplying structured inputs for subsequent analysis. Collaborative Filtering (904) identifies shared patterns among customer segments, suggesting rewards based on the preferences of similar users, and generates insights that complement content-based filtering. Content-Based Filtering (905) focuses on individual preferences, analyzing transaction details and past redemptions to tailor rewards, working alongside collaborative filtering to refine recommendations further. Reinforcement Learning (906) continuously tests and adjusts reward strategies based on customer engagement and program outcomes, dynamically improving reward effectiveness over time. The Multi-Armed Bandit (907) algorithm balances exploration by testing new rewards with exploitation by offering proven rewards, optimizing customer engagement and fine-tuning reward offerings to maximize ROI. Finally, Matrix Factorization (908) analyzes latent factors in transaction and engagement data to predict customer preferences, enabling highly personalized reward generation.

### 917: Reward Selection

This component aggregates inputs from all AI models to determine the optimal rewards for each customer. It prioritizes reward options by analyzing customer data, predicted preferences, and merchant-defined objectives to create a personalized and impactful reward strategy. The outputs generated by this component directly inform the Reward Generation process, ensuring that the selected rewards align with both customer expectations and business goals.

### Reward Generation

The system creates various types of rewards tailored to customer preferences. Dynamic Reward Creation (913) generates customized rewards in real-time by leveraging transaction details and AI predictions to ensure relevance to customer needs and merchant objectives. Voucher Generation (914) produces digital vouchers with unique codes for seamless redemption, attaching them directly to digital receipts. Loyalty Points (915) allocate points to customer accounts that can be redeemed for discounts or products, integrating with loyalty programs in banking apps or mobile wallets. Additionally, Discount Codes (916) create unique codes offering percentage-based or fixed-amount discounts, which are embedded in digital receipts or distributed via mobile wallets.

### 918: Reward Attachment

The system integrates generated rewards directly into the customer's Digital Receipt (902), combining reward data with receipt details to create a unified digital file. This integration prepares the enhanced receipt for seamless distribution through banking apps or mobile wallets, ensuring customers can easily access and redeem their rewards.

### 919: Distribution Layer

This layer ensures the seamless routing of rewards to customer-facing platforms, enhancing accessibility and redemption capabilities. Banking App Integration (920) embeds rewards directly into customer banking applications, allowing for easy access and tracking while synchronizing with transaction histories for a contextual display.

Additionally, Mobile Wallet Integration (921) delivers rewards directly to digital wallets, facilitating seamless redemption. This integration supports popular platforms such as Apple Wallet (922) and Google Wallet (923).

### Analytics & Tracking System

This system measures and optimizes the performance of reward programs through continuous monitoring and analysis. Real-Time Tracking (924) monitors reward usage, redemption rates, and customer interactions as they occur, providing immediate feedback to the reinforcement learning loop for dynamic adjustments. Engagement Metrics (925) evaluate customer engagement levels, including click-through and redemption rates, to identify which rewards are most effective and should be prioritized. Additionally, ROI Analysis (926) assesses the return on investment for each reward type by analyzing redemption data and engagement metrics, generating insights that are fed back into the AI Personalization Engine to refine and enhance reward strategies.

### Feedback Loop

The system maintains a continuous learning cycle by leveraging ROI analysis and engagement metrics to enhance AI-driven reward strategies. It reinforces and adjusts reward offerings based on actual performance data, ensuring that future rewards are more effective and aligned with customer preferences. This dynamic integration allows the system to evolve continuously, maximizing both effectiveness and customer satisfaction by adapting to changing behaviors and trends.

### 2.9. Blockchain Audit Trail Module

This module securely records every generated receipt on a permissioned blockchain ledger to ensure the data remains tamper-proof. The ledger structure represents each receipt as a transaction on the blockchain, employing SHA-256 hashing to generate a unique signature for every receipt. Verification and compliance mechanisms are embedded through the use of smart contracts, which validate receipt authenticity. Additionally, the module adheres to GDPR and PCI-DSS regulations by anonymizing user data, maintaining privacy while ensuring the blockchain's role in secure and immutable record-keeping.

### 2.10. Fraud Detection and AML Compliance Module

This module employs advanced machine learning algorithms to detect patterns that may indicate fraudulent or money laundering activities. The algorithmic framework incorporates Random Forests and Support Vector Machines (SVM) for classification and anomaly detection, alongside a rules-based engine designed to flag suspicious transactions in real-time by analyzing historical patterns. Integration with anti-money laundering (AML) databases enables the module to cross-reference transaction details against global watchlists and sanctions databases, ensuring a robust and compliant fraud detection mechanism.

### AI Integration

The Fraud Detection and Receipt Integrity AI Module employs machine learning algorithms to monitor and ensure the accuracy and authenticity of digital receipts before they are transmitted from point-of-sale (POS) systems to banks. The AI detects any attempts to manipulate, alter, or generate fraudulent receipts, ensuring that only legitimate, untampered receipt data reaches the bank.

### Backend Features

Data Handling and Pre-processing: The AI pre-processes receipt data, normalizing and structuring the information to ensure consistency across various POS systems. It analyzes the receipt data for anomalies, such as unusual transaction patterns, altered amounts, or discrepancies in item descriptions, before transmission.

Anomaly Detection: The AI continuously monitors for suspicious patterns in receipt generation, including unusual purchasing behaviours, excessive refunds, duplicate transactions, or improbable item quantities, which could indicate fraudulent activity.

Model Monitoring and Updating: The system employs continuous monitoring to log and track any instances of flagged or suspicious receipts. The AI adapts and improves by learning from past fraud attempts, using new patterns to refine its detection capabilities. Model versioning ensures that updates are tracked, and improved models are deployed seamlessly.

### Training and Data Handling

The AI is trained on large datasets of legitimate and fraudulent receipt data to accurately differentiate between normal transactions and suspicious activities. It learns to detect patterns such as repeated identical receipts, abnormal transaction amounts, or out-of-character purchases from a merchant.

The AI learns from flagged transactions, enabling it to continuously improve its ability to identify fraudulent receipts and receipt manipulation.

Enhanced Iterative Data Augmentation and Retraining: To further strengthen the module's capability to detect fraud and ensure AML compliance, an advanced iterative training process is implemented. In one embodiment, historical receipt data—including both legitimate and fraudulent transactions, along with outcomes from AML checks—is aggregated into a comprehensive training dataset. Controlled transformation functions are applied to key data attributes—such as slight perturbations in transaction amounts, variations in timestamps, or simulated alterations in receipt patterns—to generate synthetic examples that mimic subtle fraudulent behaviors. A first training set is formed by combining the original dataset with these augmented instances. Following this initial training phase, the AI model is evaluated to identify misclassified or borderline cases that were not correctly flagged as suspicious. These cases are then incorporated into an expanded second-stage training set, and the model is retrained accordingly. This iterative process, which also integrates updated AML watchlist matches, continues until performance metrics-such as precision, recall, and false positive rates-consistently meet or exceed predetermined thresholds, thereby ensuring robust fraud detection and compliance with AML regulations.

### Mathematical Behaviour

The fraud detection AI relies on a combination of unsupervised learning (to detect anomalies in the receipt data that deviate from established patterns) and supervised learning (to classify receipts as legitimate or potentially fraudulent based on known patterns).

The AI uses clustering algorithms to group similar transactions and identify outliers that could indicate receipt fraud. It also applies classification models to assess the risk level of each receipt, flagging high-risk receipts for further review.

### Practical Improvement

By ensuring the authenticity and accuracy of digital receipts, this module protects customers, merchants, and banks from fraudulent activities. It prevents the transmission of manipulated or fake receipts, ensuring that only legitimate transaction data is sent to the bank.

This module secures the integrity of the receipt transmission process, giving stakeholders confidence in the system's reliability.

Anomaly Detection: The module uses unsupervised learning (e.g., clustering, isolation forests) to detect deviations from normal transaction patterns.

Predictive Models: Supervised learning models (e.g., Random Forests, SVMs) is trained on known fraudulent behaviours to predict the likelihood of new suspicious activities.

Automated AML Checks: AI automates compliance checks against AML watchlists, reducing false positives and enhancing detection accuracy.

Real-time Analysis: AI models perform real-time analysis, flagging high-risk transactions as they occur.

Example: A customer purchases an expensive watch from a high-end retailer. The receipt is generated by the POS system and sent for transmission to the bank. Before sending, the Fraud Detection AI analyses the receipt and identifies that the purchase is unusually large compared to the customer's typical spending patterns. Additionally, the AI detects discrepancies in the item description, flagging it as potentially manipulated. The transmission is paused, and an alert is sent to the merchant and bank for further investigation. This prevents fraudulent or incorrect data from being transmitted and recorded, ensuring the integrity of the receipt.

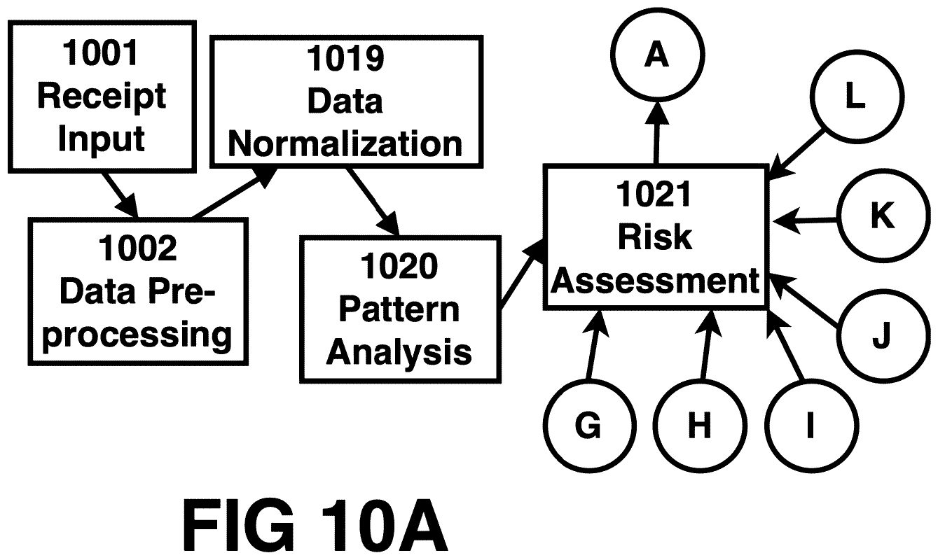

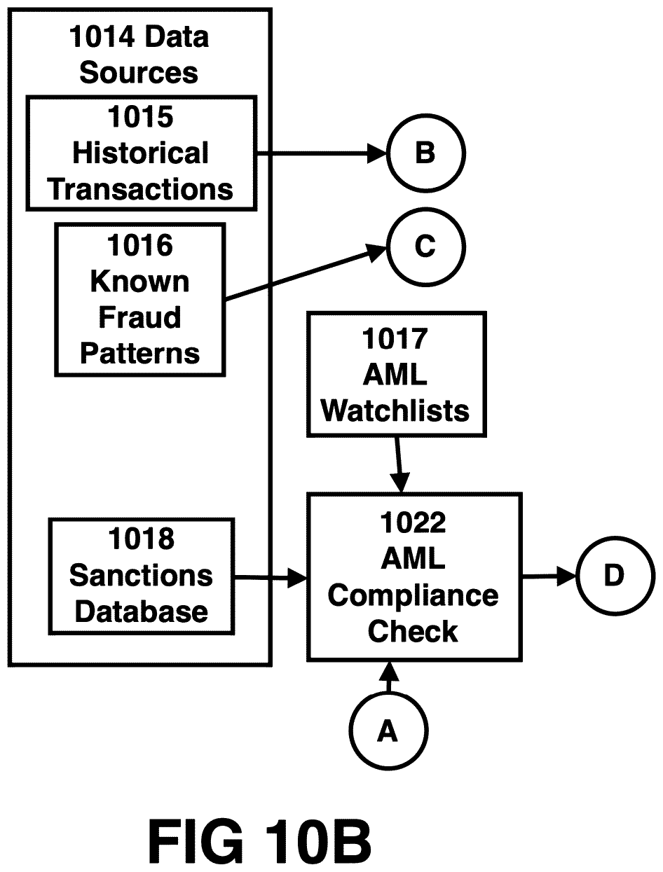

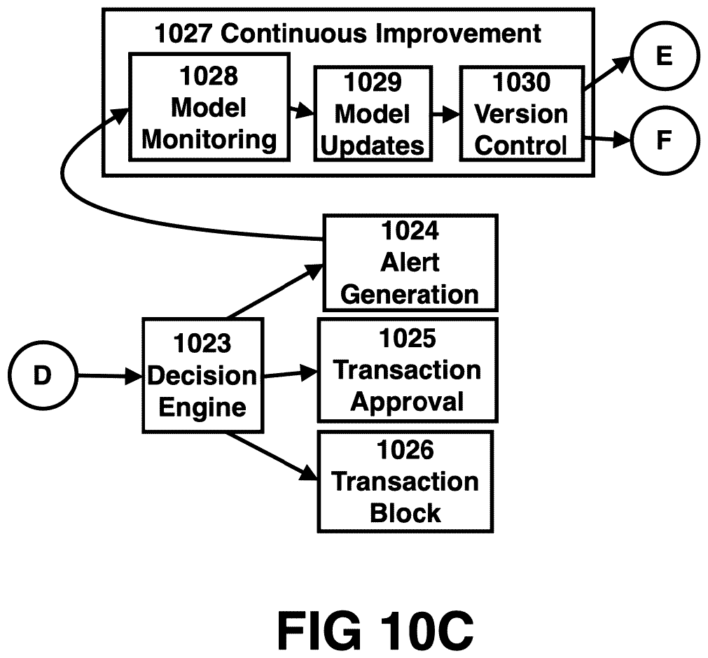

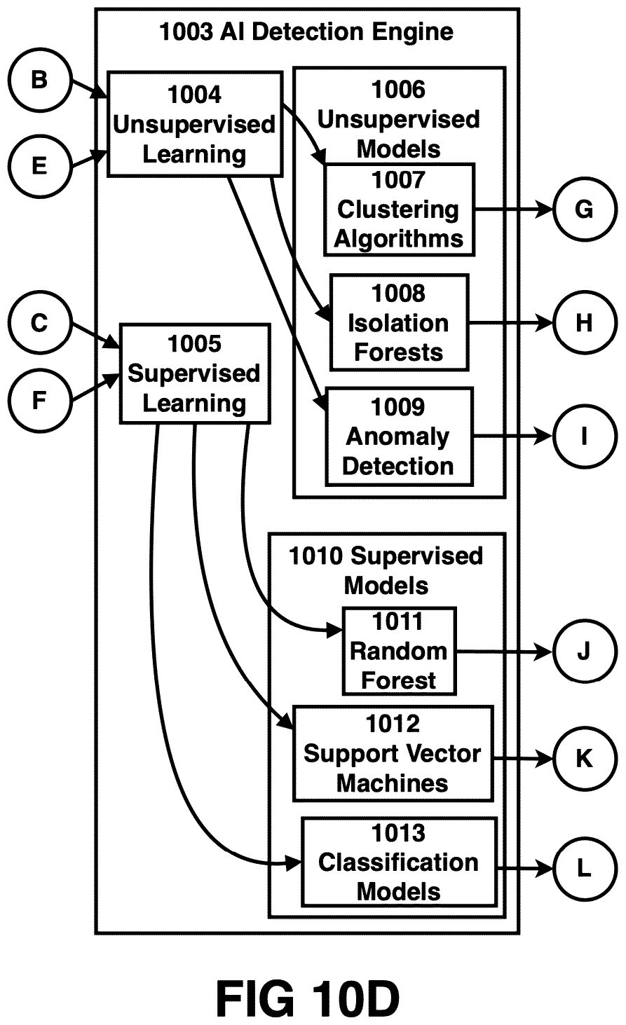

### DETAILED DESCRIPTION OF FIG. 10A-10D

FIGS. 10A-10D illustrate the Fraud Detection and AML Compliance Module's architecture, designed to identify and mitigate fraudulent activities while ensuring adherence to regulatory standards. The system employs advanced machine learning algorithms and a structured processing pipeline to achieve its objectives.

The process begins with Receipt Input (1001), which undergoes initial Data Pre-processing (1002) to standardize and prepare the data for analysis. The processed data is then fed into the AI Detection Engine (1003), which leverages two parallel learning approaches for comprehensive analysis.

The Unsupervised Learning component (1004) incorporates advanced techniques such as Clustering Algorithms (1007) for pattern discovery, Isolation Forests (1008) for anomaly isolation, and Anomaly Detection (1009) to identify outliers. These methods enable the system to discover hidden patterns and anomalies in transaction data without prior labelling.

The Supervised Learning component (1005) complements this by utilizing Random Forest (1011) for robust classification, Support Vector Machines (1012) for precise pattern recognition, and Classification Models (1013) tailored for fraud detection. This component benefits from labelled datasets to enhance its detection capabilities.

The system relies on multiple Data Sources (1014) to inform its analysis, including Historical Transactions (1015) for pattern learning, Known Fraud Patterns (1016) for model training, AML Watchlists (1017) for compliance verification, and Sanctions Databases (1018) for regulatory screening. These diverse sources provide a rich foundation for both fraud detection and regulatory compliance.

The processing pipeline integrates several steps: Data Normalization (1019) ensures standardized inputs, Pattern Analysis (1020) extracts key features, Risk Assessment (1021) aggregates outputs from the AI models, and AML Compliance Check (1022) verifies adherence to regulatory requirements. These stages ensure accurate and reliable results.

The Decision Engine (1023) evaluates model outputs to determine appropriate actions. It generates Alerts (1024) for suspicious activities, approves legitimate Transactions (1025), and blocks high-risk cases (1026). This ensures real-time decision-making for secure and compliant transaction processing.

The Continuous Improvement system (1027) ensures the module remains effective over time. Model Monitoring (1028) tracks performance metrics, Model Updates (1029) refine algorithms based on new data, and Version Control (1030) manages changes systematically. Together, these mechanisms enable the system to evolve dynamically in response to emerging threats and changing regulatory landscapes.

This architecture implements the complete fraud detection workflow detailed in Section 2.10 of the patent, employing both supervised and unsupervised learning approaches while maintaining strict compliance with AML regulations. The system's design ensures real-time fraud detection while continuously improving through feedback loops and model updates.

### FIG. 10 Description of Components

### 1001: Receipt Input

The Receipt Input serves as the foundational entry point for transaction data, enabling the system to initiate fraud detection and compliance checks. It collects critical transaction details from point-of-sale systems or digital receipt platforms, including merchant information, itemized purchases, and payment data. This input ensures that all necessary transactional elements are captured for subsequent analysis. The collected data is then directed to the Data Pre-processing (1002) stage, where it undergoes normalization and preparation, ensuring compatibility with the advanced algorithms employed in later stages. This streamlined integration ensures a seamless flow of accurate and structured data throughout the system.

### 1002: Data Pre-processing

The Data Pre-processing stage plays a role in preparing incoming transaction data for advanced analysis. This stage focuses on cleaning and normalizing the data to ensure consistency across all inputs. It systematically removes redundancies and addresses missing fields, which enhances the accuracy and reliability of downstream machine learning models. Once the data is standardized and structured, it is seamlessly supplied to both the Unsupervised Learning (1004) and Supervised Learning (1005) components within the AI Detection Engine. This integration ensures that pre-processed data is optimized for effective analysis and detection.

### 1003: AI Detection Engine

The AI Detection Engine serves as the primary module for identifying fraudulent activities, utilizing advanced machine learning techniques to detect both known and unknown fraud patterns. The Unsupervised Learning component (1004) focuses on uncovering hidden patterns and anomalies within transaction data. This is achieved through Clustering Algorithms (1007), which group transactions with similar characteristics to highlight unusual clusters, and Isolation Forests (1008), which isolate anomalous transactions by distinguishing them from normal data distributions. Additionally, Anomaly Detection (1009) techniques are employed to flag unusual patterns that may indicate potential fraud.

The Supervised Learning component (1005) complements the unsupervised approach by leveraging labelled datasets to train models capable of identifying previously observed fraud patterns. Within this framework, Random Forest (1011) algorithms provide robust classification for distinguishing between fraudulent and legitimate transactions, while Support Vector Machines (1012) analyze data to define precise boundaries in high-dimensional spaces, enhancing the accuracy of fraud detection. Finally, Classification Models (1013) apply these learned rules to categorize transactions effectively, ensuring a comprehensive approach to fraud identification.

### 1014: Data Sources

The system relies on a range of authoritative data sources to facilitate both training and operational compliance checks. Historical Transactions (1015) provide a foundational dataset that enables the identification of patterns commonly found in legitimate transactions. These patterns help refine the machine learning models used in fraud detection. Known Fraud Patterns (1016) contribute by supplying datasets of previous fraudulent activities, serving as critical input for supervised learning and model training to enhance the system's ability to detect and prevent similar occurrences.

To ensure regulatory adherence, the system integrates with Anti-Money Laundering (AML) Watchlists (1017), which screen transactions against global databases aimed at identifying potential money laundering activities. Furthermore, the Sanctions Database (1018) plays a role in verifying that transactions comply with international sanctions and regulatory requirements, ensuring that flagged activities are reviewed for compliance and appropriate action is taken.

### 1019-1022: Processing Pipeline

The pipeline systematically processes and evaluates transactions by employing multiple analytical layers to ensure comprehensive risk assessment and compliance. The process begins with Data Normalization (1019), which standardizes critical transaction fields such as merchant names, amounts, and dates to create a consistent dataset for analysis. This standardization ensures uniformity across diverse data sources and improves the reliability of downstream processes.

Subsequently, Pattern Analysis (1020) extracts essential features from the normalized data, such as transaction frequency, geographical locations, and behavioral trends. These features provide valuable insights for assessing the context and potential risks associated with each transaction. Following this, Risk Assessment (1021) aggregates the outputs from both unsupervised and supervised machine learning models to calculate a comprehensive risk score. This score reflects the likelihood of fraudulent or non-compliant activity and prioritizes transactions for further action.

Finally, the AML Compliance Check (1022) ensures regulatory adherence by cross-referencing transactions against global compliance databases and watchlists. This step verifies that transactions meet anti-money laundering (AML) standards and regulatory requirements, flagging high-risk cases for additional scrutiny. Together, these layers create a robust framework for transaction evaluation and fraud prevention.

### 1023: Decision Engine

The Decision Engine utilizes the results of the risk assessment process to determine the most appropriate course of action for each transaction, ensuring both operational efficiency and regulatory compliance. The process begins with Alert Generation (1024), where transactions flagged as suspicious are assigned alerts that prompt further investigation. This mechanism ensures that potentially fraudulent activities are swiftly identified and subjected to additional scrutiny.

For transactions assessed as low risk, the Transaction Approval (1025) function facilitates seamless processing by automatically granting approval. This minimizes unnecessary delays and enhances the overall user experience while maintaining security standards. Conversely, the Transaction Block (1026) feature is activated for high-risk transactions, effectively preventing their execution. This safeguard ensures that regulatory requirements are upheld and that financial systems remain secure from potential threats. Together, these functions form a robust decision-making framework tailored to mitigate risks while enabling efficient transaction handling.

### 1027: Continuous Improvement System

This system is designed to ensure the fraud detection module remains consistently effective and evolves to address emerging threats. Model Monitoring (1028) plays a role by continuously tracking the performance of AI models. It identifies issues such as drift or degradation in accuracy, ensuring that the system adapts to changing data patterns and maintains its reliability.

To further enhance precision, the Model Updates (1029) component integrates new fraud patterns and updated datasets into the system. This process allows the models to refine their predictive capabilities and stay ahead of emerging fraudulent techniques.

Additionally, the Version Control (1030) mechanism provides an organized history of all model versions. This ensures auditability and facilitates rollback capabilities when necessary, enabling seamless management of updates while maintaining the integrity and effectiveness of the fraud detection system.

### 2.11. Offline Mode and Automatic Syncing

The offline mode ensures that the system continues to function seamlessly even in the absence of network connectivity. Transactions and receipts are securely stored locally, utilizing AES-256 encryption to protect sensitive data. Once network connectivity is restored, the system automatically synchronizes with the central server, maintaining data consistency and integrity across all components. This feature guarantees uninterrupted operation and reliable data management under varying connectivity conditions.

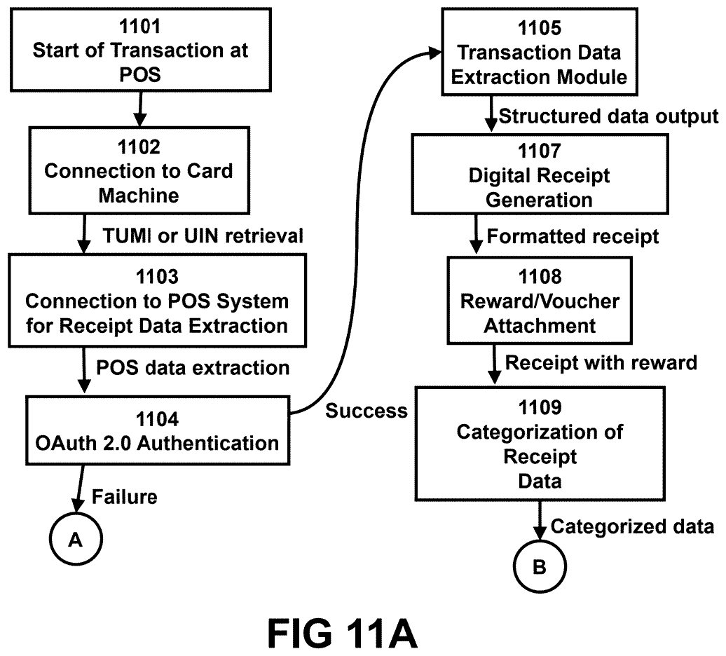

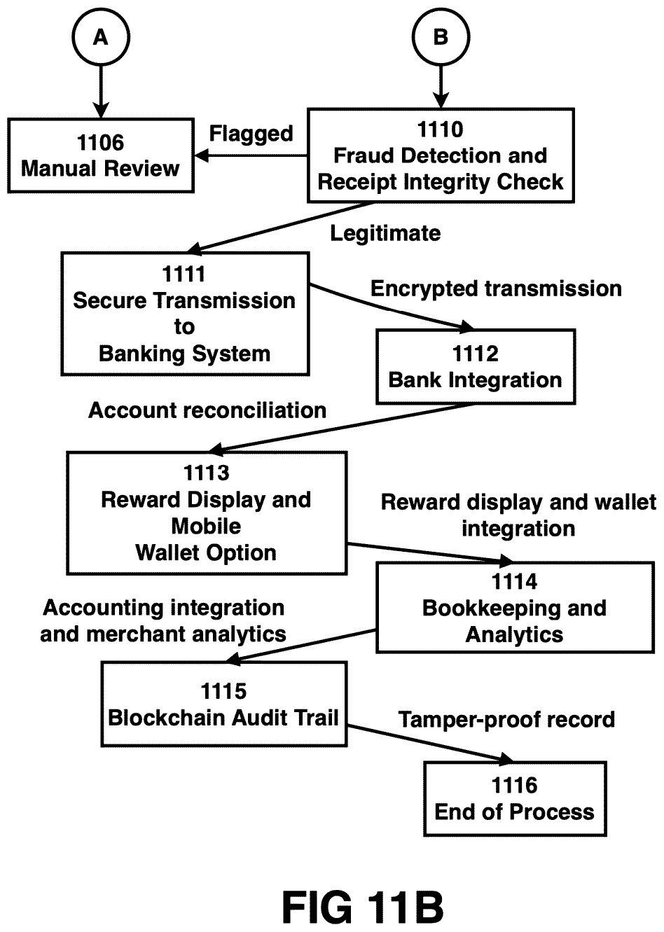

### DETAILED DESCRIPTION OF FIGS. 11A-11B

The process begins with a transaction at the point-of-sale (POS) system, triggered by a customer making a purchase using a payment card at a participating merchant's terminal (1101). During this step, the POS system captures transaction details, such as the merchant name, item descriptions, quantities, prices, taxes, and the total amount. Simultaneously, the card machine processes the payment details, including the Transaction-Unique Metadata Identifier (TUMI) or Unique Identifier Number (UIN). This step initiates the retrieval and preparation of data for generating a digital receipt. The collected data forms the foundation for subsequent steps involving authentication, retrieval, and processing.

Following the transaction initiation, the OAuth 2.0 Authentication Module (1104) is activated. This module authenticates and validates the credentials of the POS system and the card machine to ensure that only authorized and authenticated devices can access sensitive transaction data. This process includes the exchange of secure tokens between the devices and the central system. If the authentication succeeds, the system proceeds to the data retrieval stage. If the authentication fails, access to transaction data is blocked, and an alert is raised for review by the merchant or system administrator. This ensures data security and compliance with privacy regulations.

Once the authentication is successful, the system initiates parallel data retrieval from two sources: the card machine (1102) and the POS system (1103). The card machine securely retrieves payment-related data, including the TUMI/UIN. Concurrently, the POS system extracts comprehensive transaction data, including itemized purchase details, merchant identifiers, and the transaction total. This dual-stream data retrieval ensures that all required information is gathered efficiently and securely. Once both the payment and receipt data are retrieved, they are consolidated for further processing.

The consolidated data is processed by the Transaction Data Extraction Module (1105), which employs advanced AI technologies like Optical Character Recognition (OCR) and Natural Language Processing (NLP). This module extracts and interprets unstructured data, such as text from printed or digital receipts, to structure it into a standardized format.

For example, item descriptions, prices, and quantities are parsed and categorized to ensure consistency and readability. By automating this step, the system eliminates manual data entry errors and handles diverse receipt formats from various merchants, ensuring the structured data is ready for digital receipt generation.

The structured transaction data is passed to the Digital Receipt Generation Module (1107). This module assembles the extracted information into a standardized digital receipt template, which includes all essential details such as the merchant name, date, itemized purchases, payment method, and total amount. The digital receipt is designed to be universally readable across banking apps, accounting software, and mobile wallets, ensuring compatibility and usability. This stage finalizes the core receipt format that will later accommodate personalized features like rewards or vouchers.

If applicable, the Rewards Management Module (1108) enriches the digital receipt by attaching personalized offers, discounts, loyalty points, or vouchers. This module utilizes AI-powered algorithms, including collaborative filtering and content-based filtering, to analyze customer purchase history, preferences, and behavior patterns. For example, if a customer frequently shops for groceries, the system might attach a discount for a specific grocery retailer. These personalized rewards aim to increase customer engagement and loyalty. The AI further optimizes these rewards based on merchant preferences and customer profiles, ensuring relevance and effectiveness.

Once the receipt data is enriched, the Categorization Module (1109) classifies it into predefined categories such as “Dining,” “Groceries,” “Travel,” or “Utilities.” This categorization is powered by machine learning models, including random forests and neural networks, which analyze merchant information and item-level details to determine the appropriate classification. This step ensures that transaction data is accurately categorized for financial record-keeping, budgeting, and analytics purposes. The categorized data is then prepared for transmission.

Before transmission, the Fraud Detection and Receipt Integrity Check Module (1110) evaluates the receipt data for anomalies or signs of tampering. This module leverages unsupervised learning models, such as clustering algorithms and isolation forests, to detect unusual patterns, while supervised learning models like random forests assess known fraud indicators. For example, mismatches between item totals and prices or unusual transaction patterns trigger a flag for manual review. Receipts that pass these checks proceed to secure transmission.

The Secure Transmission Module (1111) ensures that the validated and categorized receipt data is transmitted securely to the customer's bank account. Advanced encryption protocols, such as TLS 1.3, are used to protect the data during transmission. The system also ensures that the receipt is routed to the correct account based on the previously retrieved TUMI/UIN data. This guarantees that the digital receipt reaches the intended recipient without any risk of interception or data loss.

Upon receipt at the bank, the Bank Integration Module (1112) associates the digital receipt with the corresponding transaction in the customer's account. Using the TUMI/UIN as a reference, the module reconciles the receipt data with the bank's transaction records, ensuring accuracy and consistency. The receipt, along with any attached rewards, is then made available in the customer's banking app for easy access and review.

The Rewards Management Module (1113) ensures that any attached rewards are prominently displayed in the customer's banking app. Customers can view these rewards alongside their transaction details or choose to save them to a mobile wallet, such as Apple Wallet or Google Wallet, for future redemption. The system dynamically updates rewards based on customer behavior and merchant objectives, ensuring a tailored and engaging user experience.

For merchants integrated with bookkeeping software, the Bookkeeping Integration Module (1114) categorizes the transaction data into appropriate accounting records. Additionally, analytics such as reward redemption rates, customer preferences, and engagement metrics are shared with the merchant. These insights help merchants refine their marketing strategies and optimize reward programs to better serve their customer base.

To enhance transparency and integrity, the Blockchain Audit Trail Module (1115) logs the receipt data onto a permissioned blockchain ledger. Each receipt is assigned a unique cryptographic hash, ensuring that the data is tamper-proof and immutable. This step is particularly useful for auditing purposes and regulatory compliance, providing an additional layer of security and trust.

The process concludes with all steps completed. The digital receipt, along with any attached rewards, is now fully processed and available for the customer to view in their banking app or mobile wallet. These digital assets are ready for future redemption or use, completing the end-to-end transaction and reward management process. This seamless integration of technologies ensures efficiency, security, and personalization, benefiting both customers and merchants alike.

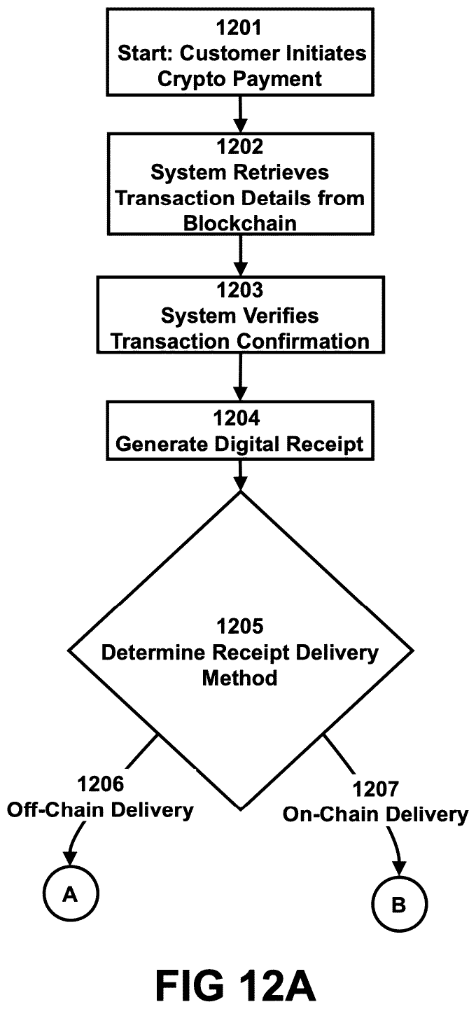

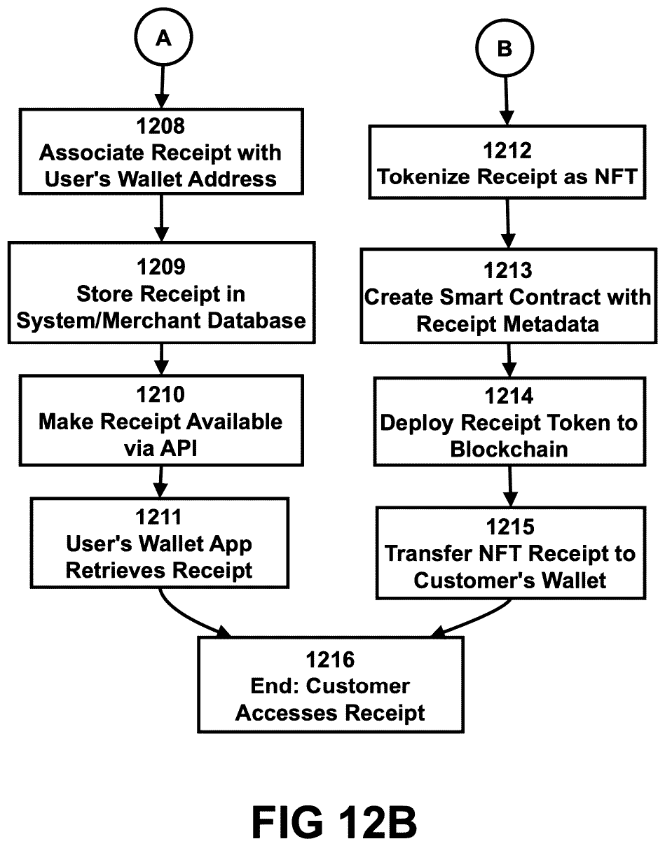

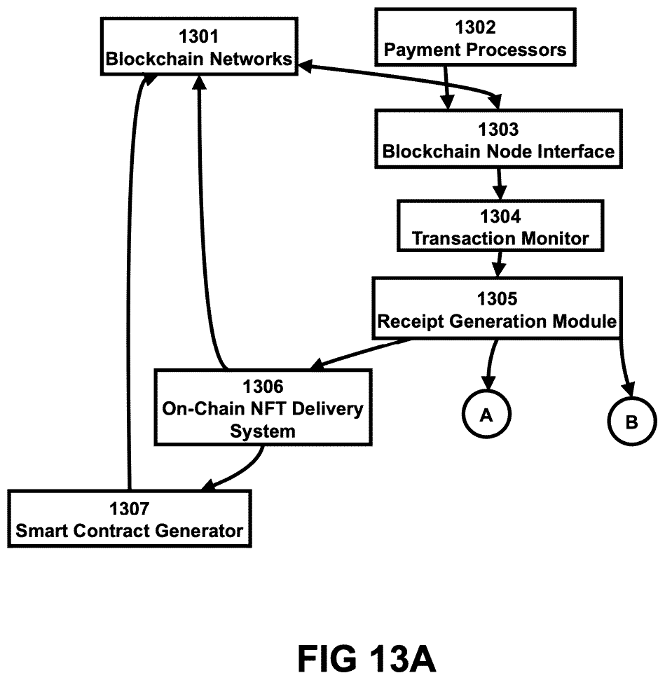

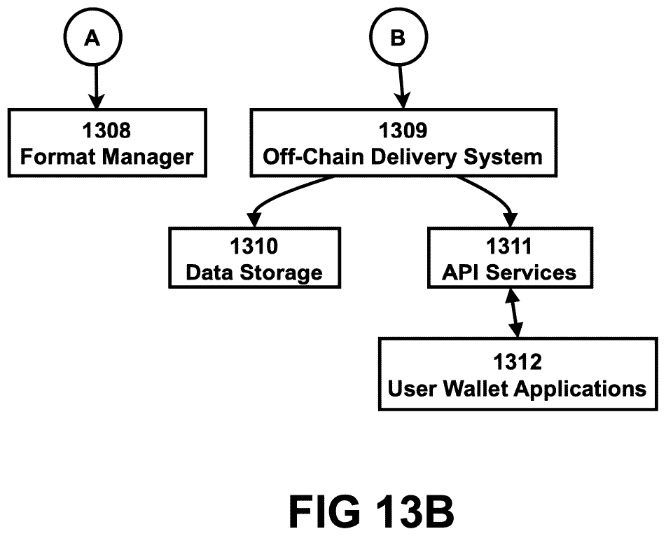

### DETAILED DESCRIPTION OF FIGS. 12A-12B AND 13A-13B

### 2.12. Cryptocurrency Payment Integration Module

In further exemplary embodiments, the system supports transactions conducted via cryptocurrencies for both online e-commerce payments and in-store point-of-sale purchases. The architecture is adapted to interface with major blockchain networks (1301) (e.g., Bitcoin, Ethereum, and others) in a chain-agnostic manner, allowing it to retrieve and process transaction data regardless of the underlying blockchain protocol. When a customer makes a purchase using cryptocurrency, the system receives or retrieves the transaction details (1202) from the relevant blockchain in real-time, typically via a dedicated cryptocurrency payment gateway or a blockchain node interface (1303). To ensure the transaction is confirmed before issuing a receipt, the system employs a transaction monitor (1304) that continuously checks the blockchain for final confirmation status. This integration operates without requiring any personal identifying information from the user; instead, it relies solely on blockchain addresses as identifiers, thereby preserving the pseudonymous nature of cryptocurrency transactions in the receipt generation process.

The system automatically generates and transmits digital receipts for cryptocurrency payments with a level of detail comparable to traditional payment receipts. In the case of a crypto payment, the receipt generation module (1305) assembles an itemized purchase list that includes the goods or services purchased, quantity, price, applicable taxes (e.g., VAT), and the total amount paid. Alongside these conventional line items, the receipt incorporates cryptocurrency-specific transaction metadata and financial details. This includes the payer's wallet address and the recipient merchant's wallet address used in the transaction, the unique transaction hash (identifier) of the blockchain payment, and an indication of the network or blockchain (for example, Bitcoin mainnet, Ethereum mainnet, etc.) on which the payment was conducted. Additionally, the receipt records any network fees associated with the transaction—such as miner fees or gas fees required to execute the payment on the blockchain—providing transparency into the extra costs paid in cryptocurrency to complete the transfer. To facilitate accounting and user understanding, the system also captures the exchange rate between the cryptocurrency and a reference fiat currency at the time of transaction, allowing the receipt to display an equivalent fiat value for the purchase and the fees. All of this information is formatted into the digital receipt (1204) in a structured manner using a format manager (1308), which ensures compatibility across various wallet apps and merchant systems. This ensures that the crypto payment receipt contains both the standard purchase details and the pertinent crypto transaction details for comprehensive record-keeping.

Off-Chain Receipt Delivery for Crypto Transactions: In one delivery mode, the system transmits the generated cryptocurrency receipt off-chain by associating it with the user's wallet address through participating wallet applications (1312) or services. In practice, the digital receipt (1204) can be sent to a secure cloud service or database managed by the system or the merchant, indexed by the customer's public wallet address. The customer, using a supported cryptocurrency wallet app or banking app linked to their crypto wallet, can then retrieve and view the receipt. For example, if the user's wallet application integrates this receipt system's API (1311), it can query for any receipts associated with the user's blockchain address and download the receipt data (e.g., in JSON or PDF format) for display within the app's interface. This off-chain delivery (1206) (1309) does not publish the receipt on the blockchain itself; instead, it leverages the wallet address as a key to deliver the receipt through a parallel secure channel. The approach maintains user privacy (only the wallet address (1208) is used, with no need for names or emails) and avoids additional blockchain transactions for receipt handling. The receipt data, once retrieved by the wallet app, can be stored locally on the user's device or in the app for offline access, much like viewing a bank statement or a past transaction receipt in a banking application. This off-chain mechanism ensures that users can conveniently receive and manage receipts for their crypto purchases in real time, integrated into the tools they already use to manage their cryptocurrency.

On-Chain Receipt Delivery (1306) via Tokenization: In an alternative embodiment, the system can optionally issue the digital receipt as an on-chain record by tokenizing the receipt and sending it to the customer's blockchain address. Specifically, the system employs a smart contract (1307) to create a non-fungible token (NFT) or similar cryptographic token that represents the digital receipt. Standards such as ERC-721 or ERC-1155 (on Ethereum or compatible blockchains) are utilized for this purpose, encoding the receipt details either directly in the token's metadata or via a reference (for instance, a hash or URI pointing to the detailed receipt data stored off-chain). Once generated, this receipt token is transmitted to the customer's wallet address on the blockchain network. The result is that the customer's crypto wallet will contain a tamper-proof token that serves as the receipt for the transaction. Because the receipt is embodied as an NFT on the blockchain, it inherits the immutability and transparency of that blockchain: the receipt cannot be altered without detection, and the ownership of the receipt (tied to the customer's address) is verifiable publicly on the ledger. The user can view the receipt token in any compatible wallet or blockchain explorer; wallet interfaces may display the token as a “digital receipt (1204)” with human-readable details if they support that functionality. This on-chain delivery (1207) (1206) mode provides an innovative way to persist receipts, allowing them to be freely transferred or archived by the user independent of any central repository. Moreover, by leveraging smart contract (1307) capabilities, additional features can be enabled—for example, an NFT receipt could be interactively verified for authenticity (since it's signed by the issuing contract) or even used in decentralized applications for warranty or returns processing, though the core purpose remains providing the customer with a durable, blockchain-verifiable proof of purchase. Notably, this on-chain approach is used in a privacy-preserving manner: the receipt token does not reveal any more personal information than the original transaction did, and it can be made semi-private by using secure metadata storage (1310) (such as encrypting the detailed contents so that only the user or authorized parties can decode them).

Pseudonymity and Privacy Preservation: Both off-chain and on-chain receipt delivery (1306) methods are designed to support pseudonymous receipt issuance. The system does not require the customer to provide any identity information beyond their blockchain wallet address to deliver the receipt. In the context of a cryptocurrency transaction, the wallet address itself serves as the customer's identifier. The receipt generation process uses this address to route the receipt appropriately—either by tagging it in the off-chain database or by sending an NFT to it on-chain—without linking to the customer's real-world identity. This ensures that the privacy of the user is maintained: a customer can receive a full detailed receipt for a purchase made with, say, Bitcoin or Ether, yet remain anonymous except for the cryptographic address that they control. The system's design aligns with the decentralized ethos of cryptocurrency by allowing receipt delivery (1207) (1206) in a way that doesn't undermine user privacy. For merchants and banks, the receipts can still be useful for auditing and accounting, but any personal identification would come only from outside the system (for instance, if a customer later volunteers information to a merchant for a return or loyalty program). Absent such voluntary disclosure, the receipts are simply recorded against wallet addresses. This pseudonymous receipt handling is compliant with scenarios where regulatory or privacy concerns necessitate minimal personal data usage, and it offers users comfort that adopting digital receipts won't inadvertently compromise the anonymity they had in the blockchain transaction itself.

It should be noted that in providing support for cryptocurrency transactions, the system itself remains a passive receipt generation and delivery service and does not handle or process the cryptocurrency payments directly. The actual transfer of funds in crypto is handled by existing payment mechanisms—for example, a cryptocurrency payment processor (1302), a smart contract (1307), or a direct wallet-to-wallet transfer initiated by the customer. The system interfaces with these mechanisms (through APIs (1311), webhooks, or direct blockchain node queries) to get the pertinent transaction details needed for receipt issuance. This design choice ensures that the system can be easily integrated with a wide range of crypto payment platforms and does not become a custodian of cryptocurrency at any point, thereby avoiding additional security or regulatory burdens associated with handling financial assets. Furthermore, the cryptocurrency integration is implemented to be blockchain-agnostic. In practice, this means the Cryptocurrency Payment Integration Module is built with the flexibility to support multiple blockchain protocols and can be extended to new cryptocurrencies as they emerge. For instance, the module may use different sub-drivers or API (1311) adapters for Bitcoin, Ethereum, Litecoin, or other payment-capable blockchains, each handling the particularities of transaction confirmation and data extraction on that network. However, these differences are abstracted away from the core receipt generation logic. From the perspective of the rest of the system (e.g., the receipt formatting (1308), categorization, and transmission components), a crypto transaction is normalized into a standard internal format (including fields for addresses, transaction ID, fees, etc.), just like any other transaction type. This abstraction and agnostic design ensure that adding support for a new digital currency is as simple as plugging in the appropriate interface for that blockchain, without requiring fundamental changes to the system's architecture. By not being tied to any single cryptocurrency or platform, the system can continue to operate robustly in the evolving landscape of digital payments, providing universal digital receipt solutions across both traditional and decentralized payment channels.

### 2.13. Warranty Detection and Integration Module

An additional feature of the exemplary embodiments is a Warranty Detection and Integration Module, which automatically detects and applies warranty information for each purchased item within the digital receipt. This module leverages artificial intelligence to scan transaction data at the point of sale for any merchant-provided or third-party warranty details associated with the items. For example, if a merchant or manufacturer offers a one-year warranty on a product and includes this information in the transaction data or receipt metadata, the module will identify and capture these details in real time. Each item's digital receipt entry is thus augmented with any available warranty terms (e.g., warranty duration, coverage scope, provider details) at the moment of receipt generation, without requiring additional input from the customer or manual data entry by the merchant.

In circumstances where no explicit warranty information is provided by the merchant for a given item, the Warranty Detection and Integration Module intelligently determines and attaches the applicable warranty terms by default. The module's AI components classify the product based on available identifiers such as Harmonized System (HS) codes, Stock Keeping Unit (SKU) numbers, or the item's category and description. By analyzing these product identifiers, the system identifies the product category with a high degree of accuracy. The module then determines the jurisdiction or country of origin of the transaction—for instance, by referencing the merchant's location or the point-of-sale country—to understand the legal context for consumer warranties. Using these two pieces of information (product category and jurisdiction), the system queries a proprietary legal database that aggregates warranty regulations and consumer protection laws from government and third-party databases. This database lookup returns the legally required warranty terms for the specific type of product in that jurisdiction, including any mandatory warranty period (e.g., a two-year statutory warranty for electronics in certain regions) as well as standard refund and return policies mandated by local law. The module then automatically assigns these warranty terms to the item on the digital receipt. In effect, even if a merchant does not volunteer warranty details, the system ensures that the customer is informed of their minimum legal warranty rights for each purchase.

Once warranty data (either merchant-provided or legally assigned) is attached to each item, the system displays the warranty information directly on the digital receipt, in context with the item details. Each item entry on the receipt is augmented with a clear notation of its warranty status and terms—for example, the coverage period (start and end dates of the warranty) and any applicable return-by date if a return/refund policy is included. Additionally, the module introduces a dynamic status icon next to each item's warranty information to provide at-a-glance status of the warranty's validity. In one embodiment, a green icon indicates an active warranty (within the coverage period), whereas a red icon indicates an expired warranty. This status icon is not static; it is dynamically updated in real-time whenever the digital receipt is accessed by the customer. The system or the viewing application recalculates the warranty status based on the current date against the warranty expiration date each time the receipt data is retrieved. This real-time tracking ensures that a customer looking at a past purchase can immediately know whether that product is still under warranty or if it has since expired, without any manual tracking. The warranty terms and status are thus seamlessly integrated into the digital receipt, enhancing the informational value of the receipt far beyond a traditional proof of purchase.

To further assist customers, the Warranty Detection and Integration Module can optionally issue warranty expiry reminders. In some embodiments, the system sends a notification or message to the customer a predetermined period before an active warranty is due to expire—for example, one month before the warranty expiration date. This reminder can be delivered through the same channel as the digital receipt (such as the banking app's notification system or the linked email/SMS associated with the customer's account), alerting the user that a particular product's warranty will end soon. Such a feature helps customers take full advantage of warranty coverage (for instance, to get a product serviced or repaired under warranty before it expires) and is a value-added service enabled by the digital receipt platform. These reminders are typically optional or configurable; for example, a user may opt in to receive warranty alerts, and the system will then automatically manage and send these pre-expiry notifications without any manual calendar tracking by the user.

It is important to note that all warranty data is securely managed and controlled within the system's receipt framework. The customer cannot manually add, modify, or remove warranty information on a receipt. Once the warranty details (either provided by the merchant or assigned by the system) are integrated into the digital receipt, they become a fixed, tamper-resistant part of the receipt record. In one implementation, the warranty information is embedded in the receipt data structure which is digitally signed or hashed via the system's Blockchain Audit Trail Module. This means any alteration of the warranty terms by an end user would break the verification hash, thus preventing undetected tampering. Similarly, merchants are restricted in how they can influence the warranty data: they may offer to extend warranty coverage beyond the legal minimum (for example, a merchant might voluntarily provide a 1-year warranty on a product even if the law requires only 6 months), and the system will duly note and display such extended warranty. However, the merchant cannot shorten, remove, or otherwise undermine the default warranty terms that are legally required. The module automatically ensures that the final warranty presented for each item is at least as protective as the statutory requirements. In practice, if a merchant-provided warranty is longer than the default legal warranty, the longer period is applied (often labeled as an “Extended Warranty” on the receipt). If a merchant attempts to provide a shorter duration than the legal requirement or no warranty at all, the system will override that omission by inserting the necessary minimum terms from the legal database. This governance guarantees that the digital receipt always reflects the most protective warranty coverage available for the consumer and prevents any unilateral removal of warranty rights.

The warranty information captured by this module is displayed consistently across all user platforms that are integrated with the digital receipt system. Whether a customer views their receipt through a traditional banking application (for example, their mobile banking app or online banking portal) or through a cryptocurrency wallet interface, the receipt will include the warranty details per item. The integration module ensures that these warranty fields and status indicators are part of the standard data payload of the digital receipt that gets transmitted to various endpoints. Banking apps can present this data in the transaction details view (e.g., under each item line, showing “Warranty valid until [date]” with a color indicator). Likewise, in crypto wallet interfaces or other digital wallet platforms that support the receipt display, the same warranty information is rendered alongside purchase details. This cross-platform presence is enabled by using common data standards and APIs for the receipt format, so that warranty metadata is preserved and visible regardless of the viewing application. The result is a unified user experience where digital receipts double as warranty certificates, accessible from anywhere the customer manages their transactions.

Under the hood, the AI model logic and architecture supporting the Warranty Detection and Integration Module combines several advanced components to achieve product classification and jurisdiction-specific legal mapping. In one embodiment, the module is part of the system's ML/AI Processing Layer and utilizes a multi-stage AI approach: first, a Natural Language Processing (NLP) sub-module scans the incoming transaction and item data for any text or codes that indicate warranty information (keywords like “warranty”, “guarantee”, or known warranty plan codes). If found, this NLP engine extracts the relevant details (such as duration in months or years, coverage type, issuer of the warranty, etc.) using named entity recognition and context analysis trained on retail receipt data. If no explicit warranty text is present, the system invokes a product classification model-for example, a trained machine learning classifier (which could be implemented as a neural network, decision tree ensemble, or a combination thereof) that takes as input the item name, category, SKU, or HS code and outputs a standardized product category or HS classification. This classifier may be trained on a large corpus of product data and HS code mappings, allowing it to accurately infer the category of an item even from a textual description. Once the item's category is identified, a rules engine or knowledge graph component handles the legal mapping: the system's proprietary database of warranty laws is structured such that queries can be made by product category and jurisdiction. The jurisdiction is determined via business logic (for instance, using the merchant's address, the store's country code, or the transaction currency and location data). The rules engine then retrieves the relevant legal warranty requirements (e.g., “electronics->EU->2 years warranty, 14-day return policy”) from the database. This database is kept up to date with regulatory information pulled from consumer protection agencies and legal resources, ensuring accuracy of the terms applied. The architecture is designed to be modular and extensible—the AI classification model can be updated or retrained independently as new products and categories emerge, and the legal database can be updated to reflect new laws or changes without altering the core classification algorithm. The combination of machine learning for understanding products and a curated legal knowledge base for jurisdiction-specific rules allows the Warranty Detection and Integration Module to intelligently bridge the gap between purchase data and legal compliance. By architecting the module in this manner, the system can automatically provide consumers with accurate warranty information worldwide, enhancing trust and utility of the digital receipt system while maintaining compliance with diverse regional regulations.

1. A method for transaction data security, the method being executable by at least one processor communicatively coupled to at least one memory, the at least one memory storing one or more instructions for executing the method by the at least one processor, the method comprising:
receiving raw transaction data from a transaction terminal;
extracting line-item text using optical character recognition and natural language processing to extract and structure the authenticated data into normalized data;
executing anomaly detection and fraud analysis against the normalized data by an artificial intelligence detection engine, the artificial intelligence detection engine comprising:
an unsupervised learning component comprising one or more machine learning models trained on user transaction history, the unsupervised learning component employing a clustering algorithm to group a plurality of transactions with similar characteristics, and further employing isolation forests which isolate anomalous transactions by distinguishing the anomalous transactions from normal data distributions; and
a supervised learning component comprising one or more machine learning models trained on historical fraud data and further trained on regulatory compliance data to identify fraud patterns, the supervised learning component employing at least one random forest algorithm to the normalized data;
the executing of the anomaly detection and fraud analysis further comprising:
generating and dynamically updating an adaptive threshold for high risk of fraud, the adaptive threshold being determined by the supervised learning component;
calculating a risk score for any of the plurality of transactions by the unsupervised learning component;
blocking any of the plurality of transactions upon determination that the risk score exceeds the adaptive threshold; and
enabling a multi-factor authentication requirement upon determination that the risk score exceeds the adaptive threshold.

2. The method of claim 1, further comprising:
applying an initial security verification, including client credentials and Transport Layer Security 1.3 encryption to the raw transaction data to produce authenticated data;
categorizing any of the plurality of transactions linked to the normalized data, the categorization using bidirectional long short-term memory networks and word embeddings;
generating a digital receipt, the digital receipt including a receipt hash;
transmitting the receipt hash for recordation on a blockchain ledger; and
transmitting the digital receipt to a banking application of an account holder.

3. The method of claim 1, further comprising:
collecting a set of reconciliation data from a database;
applying one or more transformations to each reconciliation data including iteratively multiplying by a fixed number with each iteration to create a modified set of reconciliation data;
creating a first training set comprising the collected set of reconciliation data, the modified set of reconciliation data, and a set of reconciliation data;
first training a neural network in a first stage using the first training set;
creating a second training set for a second stage of training comprising the first training set and reconciliation data that are incorrectly detected as reconciliation data after the first stage of training; and
second training the neural network in a second stage using the second training set.

4. The method of claim 3, further comprising the set of reconciliation data including transaction metadata such as transaction identifiers, timestamps, and point-of-sale (POS) system logs.

5. The method of claim 3, further comprising the set of reconciliation data including financial details such as bank transaction records, payment authorization codes, or Transaction-Unique Metadata Identifier (TUMI) or the pre-provisioned Unique Identifier Number (UIN) information.

6. The method of claim 4, the transaction-linking identifier comprising a Transaction-Unique Metadata Identifier (TUMI), or a pre-provisioned Unique Identifier Number (UIN) embedded by the issuer at card personalisation or token creation, said identifier being non-payment-enable and persistent across subsequent transactions.

7. The method of claim 3, further comprising the set of reconciliation data including merchant-related data including merchant identification, location information, and POS system metadata.

8. The method of claim 3, further comprising the set of reconciliation data including digital receipt images and associated OCR-extracted textual data.

9. The method of claim 3, further comprising the set of reconciliation data including sales data and inventory records associated with each transaction.

10. The method of claim 3, further comprising the set of reconciliation data including customer account information, loyalty program identifiers, and behavioral data.

11. The method of claim 3, further comprising the first training including at least one of: categorizing the set of reconciliation data; classifying the set of reconciliation data; and augmenting the reconciliation data with synthetic variations derived from statistical transformation functions, the transformation functions including iterative multiplication, scaling based on standard deviation, and controlled perturbations of numerical values.

12. The method of claim 3, further comprising the first training including at least one of: reconciling the reconciliation data with corresponding accounting data; linking the reconciliation data with incoming sales data; linking the reconciliation data with bank transaction data; and linking the reconciliation data with anti-money laundering (AML) watchlist data.

13. The method of claim 1, further comprising:
continuously monitoring performance metrics, the performance metrics including accuracy, precision, and false positive rates, during training, and
dynamically adjusting transformation parameters and data augmentation methods until predetermined thresholds are met.

14. The method of claim 3, further comprising automatically storing misclassified or borderline reconciliation data instances and incorporating flagged instances into subsequent training sets for iterative retraining, the flagged instances comprising at least one of the misclassified or borderline reconciliation data instances.

15. The method of claim 3, the one or more transformations comprising at least one mathematical transformation function selected from the group consisting of iterative multiplication by a fixed number, scaling based on standard deviation, and statistical perturbation operations.

16. A system for transaction data security, the system comprising:
at least one convolutional neural network configured to receive at least a first set of training data and a second set of training data; and
at least one processor communicatively coupled to at least one memory, the at least one memory storing one or more instructions for executing the method by the at least one processor, the method comprising:
receiving raw transaction data from a transaction terminal;
extracting line-item text using optical character recognition and natural language processing to extract and structure the authenticated data into normalized data;
executing anomaly detection and fraud analysis against the normalized data by an artificial intelligence detection engine, the artificial intelligence detection engine comprising:
an unsupervised learning component comprising one or more machine learning models supported by the at least one convolutional neural network and trained on user transaction history, the unsupervised learning component employing a clustering algorithm to group a plurality of transactions with similar characteristics, and further employing isolation forests which isolate anomalous transactions by distinguishing the anomalous transactions from normal data distributions; and
a supervised learning component comprising one or more machine learning models trained on historical fraud data and further trained on regulatory compliance data to identify fraud patterns, the supervised learning component employing at least one random forest algorithm to the normalized data;
the executing of the anomaly detection and fraud analysis further comprising:
generating and dynamically updating an adaptive threshold for high risk of fraud, the adaptive threshold being determined by the supervised learning component;
calculating a risk score for any of the plurality of transactions by the unsupervised learning component;
blocking any of the plurality of transactions upon determination that the risk score exceeds the adaptive threshold; and
enabling a multi-factor authentication requirement upon determination that the risk score exceeds the adaptive threshold.

17. The system of claim 16, the method further comprising:
applying an initial security verification, including client credentials and Transport Layer Security 1.3 encryption to the raw transaction data to produce authenticated data;
categorizing any of the plurality of transactions linked to the normalized data, the categorization using bidirectional long short-term memory networks and word embeddings;
generating a digital receipt, the digital receipt including a receipt hash;
transmitting the receipt hash for recordation on a blockchain ledger; and
transmitting the digital receipt to a banking application of an account holder.

18. The system of claim 16, the method further comprising:
collecting a set of reconciliation data from a database;
applying one or more transformations to each reconciliation data including iteratively multiplying by a fixed number with each iteration to create a modified set of reconciliation data;
creating a first training set comprising the collected set of reconciliation data, the modified set of reconciliation data, and a set of reconciliation data;
first training a neural network in a first stage using the first training set;
creating a second training set for a second stage of training comprising the first training set and reconciliation data that are incorrectly detected as reconciliation data after the first stage of training; and
second training the neural network in a second stage using the second training set.

19. A non-transitory computer-readable storage medium having embodied thereon instructions which, when executed by a processor, perform the steps of a method, the method comprising:
receiving raw transaction data from a transaction terminal;
extracting line-item text using optical character recognition and natural language processing to extract and structure the authenticated data into normalized data;
executing anomaly detection and fraud analysis against the normalized data by an artificial intelligence detection engine, the artificial intelligence detection engine comprising:
an unsupervised learning component comprising one or more machine learning models supported by at least one neural network and trained on user transaction history, the unsupervised learning component employing a clustering algorithm to group a plurality of transactions with similar characteristics, and further employing isolation forests which isolate anomalous transactions by distinguishing the anomalous transactions from normal data distributions; and
a supervised learning component comprising one or more machine learning models trained on historical fraud data and further trained on regulatory compliance data to identify fraud patterns, the supervised learning component employing at least one random forest algorithm to the normalized data;
the executing of the anomaly detection and fraud analysis further comprising:
generating and dynamically updating an adaptive threshold for high risk of fraud, the adaptive threshold being determined by the supervised learning component;
calculating a risk score for any of the plurality of transactions by the unsupervised learning component;
blocking any of the plurality of transactions upon determination that the risk score exceeds the adaptive threshold; and
enabling a multi-factor authentication requirement upon determination that the risk score exceeds the adaptive threshold.

20. The non-transitory computer-readable storage medium of claim 19, the method further comprising:
collecting a set of reconciliation data from a database;
applying one or more transformations to each reconciliation data including iteratively multiplying by a fixed number with each iteration to create a modified set of reconciliation data;
creating a first training set comprising the collected set of reconciliation data, the modified set of reconciliation data, and a set of reconciliation data;
first training a neural network in a first stage using the first training set;
creating a second training set for a second stage of training comprising the first training set and reconciliation data that are incorrectly detected as reconciliation data after the first stage of training; and
second training the neural network in a second stage using the second training set.
